(19) United States
(12) Patent Application Publication
(10) Pub. No.: US 2022/0126863 A1
(43) Pub. Date: Apr. 28, 2022

(54) AUTONOMOUS VEHICLE SYSTEM

(71) Applicant: Intel Corporation, Santa Clara, CA (US)

(72) Inventors: Hassnaa Moustafa, Portland, OR (US); Soila P. Kavulya, Hillsboro, OR (US); Igor Tatourian, Fountain Hills, AZ (US); Rita H. Wouhaybi, Portland, OR (US); Ignacio J. Alvarez, Portland, OR (US); Fatema S. Adenwala, Hillsboro, OR (US); Cagri C. Tanriover, Bethany, OR (US); Maria S. Elli, Hillsboro, OR (US); David J. Zage, Livermore, CA (US); Jithin Sankar Sankaran Kutty, Fremont, CA (US); Christopher E. Lopez-Araiza, San Jose, CA (US); Magdiel F. Galán-Oliveras, Gilbert, AZ (US); Li Chen, Hillsboro, OR (US)

(73) Assignee: Intel Corporation, Santa Clara, CA (US)

(21) Appl. No.: 17/434,716

(22) PCT Filed: Mar. 27, 2020
(86) PCT No.: PCT/US2020/025501

§ 371 Date: Aug. 27, 2021

Related U.S. Application Data
(60) Provisional application No. 62/826,955, filed on Mar. 29, 2019.

(51) Int. Cl. B60W 60/00; B60W 40/04; B60W 50/00; H04W 4/46; H04L 9/32; G06N 20/00

(52) U.S. Cl. CPC B60W 60/0011; B60W 60/00274; B60W 40/04; B60W 50/0097; B60W 2556/65; H04L 9/3213; G06N 20/00; B60W 2554/4046; H04W 4/46

(57) ABSTRACT

An apparatus comprising at least one interface to receive a signal identifying a second vehicle in proximity of a first vehicle; and processing circuitry to obtain a behavioral model associated with the second vehicle, wherein the behavioral model defines driving behavior of the second vehicle; use the behavioral model to predict actions of the second vehicle; and determine a path plan for the first vehicle based on the predicted actions of the second vehicle.

### CROSS-REFERENCE TO RELATED APPLICATION

This application claims the benefit of and priority from U.S. Provisional Patent Application No. 62/826,955 entitled “Autonomous Vehicle System” and filed Mar. 29, 2019, the entire disclosure of which is incorporated herein by reference.

### TECHNICAL FIELD

This disclosure relates in general to the field of computer systems and, more particularly, to computing systems enabling autonomous vehicles.

### BACKGROUND

Some vehicles are configured to operate in an autonomous mode in which the vehicle navigates through an environment with little or no input from a driver. Such a vehicle typically includes one or more sensors that are configured to sense information about the environment. The vehicle may use the sensed information to navigate through the environment. For example, if the sensors sense that the vehicle is approaching an obstacle, the vehicle may navigate around the obstacle.

### BRIEF DESCRIPTION OF THE DRAWINGS

FIG. 1 is a simplified illustration showing an example autonomous driving environment in accordance with at least one embodiment.

FIG. 2 is a simplified block diagram illustrating an example implementation of a vehicle (and corresponding in-vehicle computing system) equipped with autonomous driving functionality in accordance with at least one embodiment.

FIG. 3 illustrates an example portion of a neural network in accordance with certain embodiments in accordance with at least one embodiment.

FIG. 4 is a simplified block diagram illustrating example levels of autonomous driving, which may be supported in various vehicles (e.g., by their corresponding in-vehicle computing systems in accordance with at least one embodiment.

FIG. 5 is a simplified block diagram illustrating an example autonomous driving flow which may be implemented in some autonomous driving systems in accordance with at least one embodiment.

FIG. 6 depicts an example “sense, plan, act” model for controlling autonomous vehicles in accordance with at least one embodiment.

FIG. 7 illustrates a simplified social norm understanding model 700 in accordance with at least one embodiment.

FIG. 8 depicts diagrams illustrating aspects of coordination between vehicles in an environment where at least a portion of the vehicles are semi- or full-autonomous in accordance with at least one embodiment.

FIG. 9 is a block diagram illustrating example information exchange between two vehicles in accordance with at least one embodiment.

FIG. 10 is a simplified block diagram illustrating an example road intersection in accordance with at least one embodiment.

FIG. 11 depicts diagrams illustrating determination of localized behavioral model consensus in accordance with at least one embodiment.

FIG. 12 illustrates an example “Pittsburgh Left” scenario in accordance with at least one embodiment.

FIG. 13 illustrates an example “road rage” scenario by a human-driven vehicle in accordance with at least one embodiment.

FIG. 14 is a simplified block diagram showing an irregular/anomalous behavior tracking model for an autonomous vehicle in accordance with at least one embodiment.

FIG. 15 illustrates a contextual graph that tracks how often a driving pattern occurs in a given context in accordance with at least one embodiment.

FIG. 16 is a flow diagram of an example process of tracking irregular behaviors observed by vehicles in accordance with at least one embodiment.

FIG. 17 is a flow diagram of an example process of identifying contextual behavior patterns in accordance with at least one embodiment.

FIG. 18 illustrates a fault and intrusion detection system for highly automated and autonomous vehicles in accordance with at least one embodiment.

FIG. 19 illustrates an example of a manipulated graphic in accordance with at least one embodiment.

FIG. 20 is a block diagram of a simplified centralized vehicle control architecture for a vehicle according to at least one embodiment.

FIG. 21 is a simplified block diagram of an autonomous sensing and control pipeline in accordance with at least one embodiment.

FIG. 22 is a simplified block diagram illustrating an example x-by-wire architecture of a highly automated or autonomous vehicle in accordance with at least one embodiment.

FIG. 23 is a simplified block diagram illustrating an example safety reset architecture of a highly automated or autonomous vehicle according to at least one embodiment.

FIG. 24 is a simplified block diagram illustrating an example of a general safety architecture of a highly automated or autonomous vehicle according to at least one embodiment.

FIG. 25 is a simplified block diagram illustrating an example operational flow of a fault and intrusion detection system for highly automated and autonomous vehicles according to at least one embodiment.

FIG. 26 is a simplified flowchart that illustrates a high level possible flow of operations associated with a fault and intrusion detection system in accordance with at least one embodiment.

FIG. 27 is a simplified flowchart that illustrates a high level possible flow of operations associated with a fault and intrusion detection system in accordance with at least one embodiment.

FIG. 28A is a simplified flowchart that illustrates a high level possible flow 2800 of operations associated with a fault and intrusion detection system in accordance with at least one embodiment.

FIG. 28B is a simplified flowchart that illustrates a high level possible flow 2850 of additional operations associated with a comparator operation in accordance with at least one embodiment.

FIG. 29 illustrates an example of sensor arrays commonly found on autonomous vehicles in accordance with at least one embodiment.

FIG. 30 illustrates an example of a Dynamic Autonomy Level Detection (“DALD”) System that adapts autonomous vehicle functionalities based on the sensing and processing capabilities available to the vehicle in accordance with at least one embodiment.

FIG. 31 illustrates example positions of two vehicles in accordance with at least one embodiment.

FIG. 32 illustrates an Ackerman model for a vehicle in accordance with at least one embodiment.

FIG. 33 illustrates an example of a vehicle with an attachment in accordance with at least one embodiment.

FIG. 34 illustrates an example of the use of a simple method of tracing the new dimensions of the vehicle incorporating dimensions added by an extension coupled to the vehicle in accordance with at least one embodiment.

FIG. 35 illustrates an example of a vehicle model occlusion compensation flow in accordance with at least one embodiment.

FIGS. 36-37 are block diagrams of exemplary computer architectures that may be used in accordance with at least one embodiment.

### DESCRIPTION OF EXAMPLE EMBODIMENTS

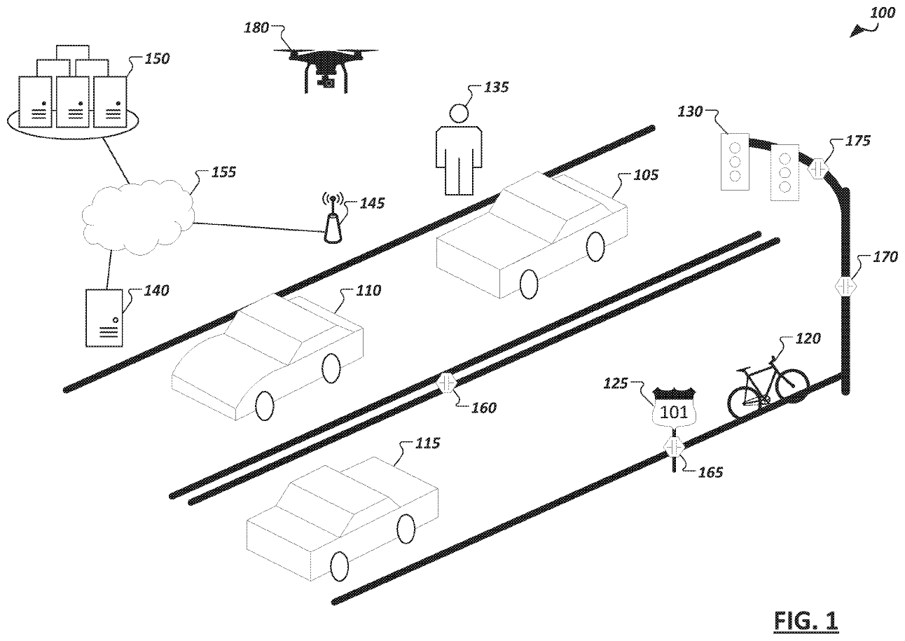

FIG. 1 is a simplified illustration 100 showing an example autonomous driving environment. Vehicles (e.g., 105, 110, 115, etc.) may be provided with varying levels of autonomous driving capabilities facilitated through in-vehicle computing systems with logic implemented in hardware, firmware, and/or software to enable respective autonomous driving stacks. Such autonomous driving stacks may allow vehicles to self-control or provide driver assistance to detect roadways, navigate from one point to another, detect other vehicles and road actors (e.g., pedestrians (e.g., 135), bicyclists, etc.), detect obstacles and hazards (e.g., 120), and road conditions (e.g., traffic, road conditions, weather conditions, etc.), and adjust control and guidance of the vehicle accordingly. Within the present disclosure, a “vehicle” may be a manned vehicle designed to carry one or more human passengers (e.g., cars, trucks, vans, buses, motorcycles, trains, aerial transport vehicles, ambulance, etc.), an unmanned vehicle to drive with or without human passengers (e.g., freight vehicles (e.g., trucks, rail-based vehicles, etc.)), vehicles for transporting non-human passengers (e.g., livestock transports, etc.), and/or drones (e.g., land-based or aerial drones or robots, which are to move within a driving environment (e.g., to collect information concerning the driving environment, provide assistance with the automation of other vehicles, perform road maintenance tasks, provide industrial tasks, provide public safety and emergency response tasks, etc.)). In some implementations, a vehicle may be a system configured to operate alternatively in multiple different modes (e.g., passenger vehicle, unmanned vehicle, or drone vehicle), among other examples. A vehicle may “drive” within an environment to move the vehicle along the ground (e.g., paved or unpaved road, path, or landscape), through water, or through the air. In this sense, a “road” or “roadway”, depending on the implementation, may embody an outdoor or indoor ground-based path, a water channel, or a defined aerial boundary. Accordingly, it should be appreciated that the following disclosure and related embodiments may apply equally to various contexts and vehicle implementation examples.

In some implementations, vehicles (e.g., 105, 110, 115) within the environment may be “connected” in that the in-vehicle computing systems include communication modules to support wireless communication using one or more technologies (e.g., IEEE 802.11 communications (e.g., WiFi), cellular data networks (e.g., 3rd Generation Partnership Project (3GPP) networks, Global System for Mobile Communication (GSM), general packet radio service, code division multiple access (CDMA), etc.), 4G, 5G, 6G, Bluetooth, millimeter wave (mmWave), ZigBee, Z-Wave, etc.), allowing the in-vehicle computing systems to connect to and communicate with other computing systems, such as the in-vehicle computing systems of other vehicles, roadside units, cloud-based computing systems, or other supporting infrastructure. For instance, in some implementations, vehicles (e.g., 105, 110, 115) may communicate with computing systems providing sensors, data, and services in support of the vehicles' own autonomous driving capabilities. For instance, as shown in the illustrative example of FIG. 1, supporting drones 180 (e.g., ground-based and/or aerial), roadside computing devices (e.g., 140), various external (to the vehicle, or “extraneous”) sensor devices (e.g., 160, 165, 170, 175, etc.), and other devices may be provided as autonomous driving infrastructure separate from the computing systems, sensors, and logic implemented on the vehicles (e.g., 105, 110, 115) to support and improve autonomous driving results provided through the vehicles, among other examples. Vehicles may also communicate with other connected vehicles over wireless communication channels to share data and coordinate movement within an autonomous driving environment, among other example communications.

As illustrated in the example of FIG. 1, autonomous driving infrastructure may incorporate a variety of different systems. Such systems may vary depending on the location, with more developed roadways (e.g., roadways controlled by specific municipalities or toll authorities, roadways in urban areas, sections of roadways known to be problematic for autonomous vehicles, etc.) having a greater number or more advanced supporting infrastructure devices than other sections of roadway, etc. For instance, supplemental sensor devices (e.g., 160, 165, 170, 175) may be provided, which include sensors for observing portions of roadways and vehicles moving within the environment and generating corresponding data describing or embodying the observations of the sensors. As examples, sensor devices may be embedded within the roadway itself (e.g., sensor 160), on roadside or overhead signage (e.g., sensor 165 on sign 125), sensors (e.g., 170, 175) attached to electronic roadside equipment or fixtures (e.g., traffic lights (e.g., 130), electronic road signs, electronic billboards, etc.), dedicated road side units (e.g., 140), among other examples. Sensor devices may also include communication capabilities to communicate their collected sensor data directly to nearby connected vehicles or to fog- or cloud-based computing systems (e.g., 140, 150). Vehicles may obtain sensor data collected by external sensor devices (e.g., 160, 165, 170, 175, 180), or data embodying observations or recommendations generated by other systems (e.g., 140, 150) based on sensor data from these sensor devices (e.g., 160, 165, 170, 175, 180), and use this data in sensor fusion, inference, path planning, and other tasks performed by the in-vehicle autonomous driving system. In some cases, such extraneous sensors and sensor data may, in actuality, be within the vehicle, such as in the form of an after-market sensor attached to the vehicle, a personal computing device (e.g., smartphone, wearable, etc.) carried or worn by passengers of the vehicle, etc. Other road actors, including pedestrians, bicycles, drones, unmanned aerial vehicles, robots, electronic scooters, etc., may also be provided with or carry sensors to generate sensor data describing an autonomous driving environment, which may be used and consumed by autonomous vehicles, cloud- or fog-based support systems (e.g., 140, 150), other sensor devices (e.g., 160, 165, 170, 175, 180), among other examples.

As autonomous vehicle systems may possess varying levels of functionality and sophistication, support infrastructure may be called upon to supplement not only the sensing capabilities of some vehicles, but also the computer and machine learning functionality enabling autonomous driving functionality of some vehicles. For instance, compute resources and autonomous driving logic used to facilitate machine learning model training and use of such machine learning models may be provided on the in-vehicle computing systems entirely or partially on both the in-vehicle systems and some external systems (e.g., 140, 150). For instance, a connected vehicle may communicate with road-side units, edge systems, or cloud-based devices (e.g., 140) local to a particular segment of roadway, with such devices (e.g., 140) capable of providing data (e.g., sensor data aggregated from local sensors (e.g., 160, 165, 170, 175, 180) or data reported from sensors of other vehicles), performing computations (as a service) on data provided by a vehicle to supplement the capabilities native to the vehicle, and/or push information to passing or approaching vehicles (e.g., based on sensor data collected at the device 140 or from nearby sensor devices, etc.). A connected vehicle (e.g., 105, 110, 115) may also or instead communicate with cloud-based computing systems (e.g., 150), which may provide similar memory, sensing, and computational resources to enhance those available at the vehicle. For instance, a cloud-based system (e.g., 150) may collect sensor data from a variety of devices in one or more locations and utilize this data to build and/or train machine-learning models which may be used at the cloud-based system (to provide results to various vehicles (e.g., 105, 110, 115) in communication with the cloud-based system 150, or to push to vehicles for use by their in-vehicle systems, among other example implementations. Access points (e.g., 145), such as cell-phone towers, road-side units, network access points mounted to various roadway infrastructure, access points provided by neighboring vehicles or buildings, and other access points, may be provided within an environment and used to facilitate communication over one or more local or wide area networks (e.g., 155) between cloud-based systems (e.g., 150) and various vehicles (e.g., 105, 110, 115). Through such infrastructure and computing systems, it should be appreciated that the examples, features, and solutions discussed herein may be performed entirely by one or more of such in-vehicle computing systems, fog-based or edge computing devices, or cloud-based computing systems, or by combinations of the foregoing through communication and cooperation between the systems.

In general, “servers,” “clients,” “computing devices,” “network elements,” “hosts,” “platforms”, “sensor devices,” “edge device,” “autonomous driving systems”, “autonomous vehicles”, “fog-based system”, “cloud-based system”, and “systems” generally, etc. discussed herein can include electronic computing devices operable to receive, transmit, process, store, or manage data and information associated with an autonomous driving environment. As used in this document, the term “computer,” “processor,” “processor device,” or “processing device” is intended to encompass any suitable processing apparatus, including central processing units (CPUs), graphical processing units (GPUs), application specific integrated circuits (ASICs), field programmable gate arrays (FPGAs), digital signal processors (DSPs), tensor processors and other matrix arithmetic processors, among other examples. For example, elements shown as single devices within the environment may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Any of the flows, methods, processes (or portions thereof) or functionality of any of the various components described below or illustrated in the figures may be performed by any suitable computing logic, such as one or more modules, engines, blocks, units, models, systems, or other suitable computing logic. Reference herein to a “module”, “engine”, “block”, “unit”, “model”, “system” or “logic” may refer to hardware, firmware, software and/or combinations of each to perform one or more functions. As an example, a module, engine, block, unit, model, system, or logic may include one or more hardware components, such as a micro-controller or processor, associated with a non-transitory medium to store code adapted to be executed by the micro-controller or processor. Therefore, reference to a module, engine, block, unit, model, system, or logic, in one embodiment, may refers to hardware, which is specifically configured to recognize and/or execute the code to be held on a non-transitory medium. Furthermore, in another embodiment, use of module, engine, block, unit, model, system, or logic refers to the non-transitory medium including the code, which is specifically adapted to be executed by the microcontroller or processor to perform predetermined operations. And as can be inferred, in yet another embodiment, a module, engine, block, unit, model, system, or logic may refer to the combination of the hardware and the non-transitory medium. In various embodiments, a module, engine, block, unit, model, system, or logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. A module, engine, block, unit, model, system, or logic may include one or more gates or other circuit components, which may be implemented by, e.g., transistors. In some embodiments, a module, engine, block, unit, model, system, or logic may be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Furthermore, logic boundaries that are illustrated as separate commonly vary and potentially overlap. For example, a first and second module (or multiple engines, blocks, units, models, systems, or logics) may share hardware, software, firmware, or a combination thereof, while potentially retaining some independent hardware, software, or firmware.

The flows, methods, and processes described below and in the accompanying figures are merely representative of functions that may be performed in particular embodiments. In other embodiments, additional functions may be performed in the flows, methods, and processes. Various embodiments of the present disclosure contemplate any suitable signaling mechanisms for accomplishing the functions described herein. Some of the functions illustrated herein may be repeated, combined, modified, or deleted within the flows, methods, and processes where appropriate. Additionally, functions may be performed in any suitable order within the flows, methods, and processes without departing from the scope of particular embodiments.

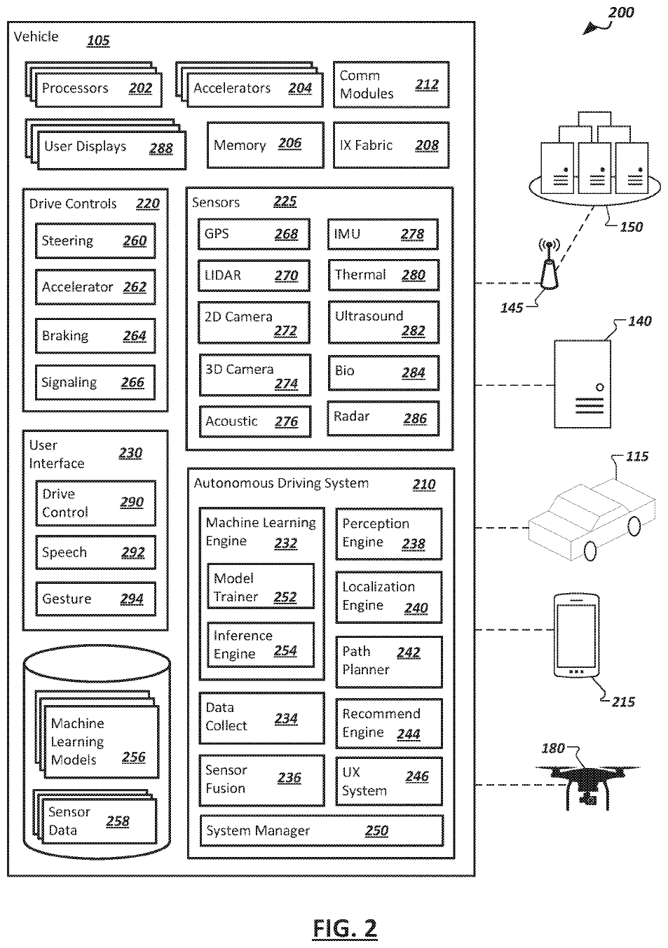

With reference now to FIG. 2, a simplified block diagram 200 is shown illustrating an example implementation of a vehicle (and corresponding in-vehicle computing system) 105 equipped with autonomous driving functionality. In one example, a vehicle 105 may be equipped with one or more processors 202, such as central processing units (CPUs), graphical processing units (GPUs), application specific integrated circuits (ASICs), field programmable gate arrays (FPGAs), digital signal processors (DSPs), tensor processors and other matrix arithmetic processors, among other examples. Such processors 202 may be coupled to or have integrated hardware accelerator devices (e.g., 204), which may be provided with hardware to accelerate certain processing and memory access functions, such as functions relating to machine learning inference or training (including any of the machine learning inference or training described below), processing of particular sensor data (e.g., camera image data, LIDAR point clouds, etc.), performing certain arithmetic functions pertaining to autonomous driving (e.g., matrix arithmetic, convolutional arithmetic, etc.), among other examples. One or more memory elements (e.g., 206) may be provided to store machine-executable instructions implementing all or a portion of any one of the modules or sub-modules of an autonomous driving stack implemented on the vehicle, as well as storing machine learning models (e.g., 256), sensor data (e.g., 258), and other data received, generated, or used in connection with autonomous driving functionality to be performed by the vehicle (or used in connection with the examples and solutions discussed herein). Various communication modules (e.g., 212) may also be provided, implemented in hardware circuitry and/or software to implement communication capabilities used by the vehicle's system to communicate with other extraneous computing systems over one or more network channels employing one or more network communication technologies. These various processors 202, accelerators 204, memory devices 206, and network communication modules 212, may be interconnected on the vehicle system through one or more interconnect fabrics or links (e.g., 208), such as fabrics utilizing technologies such as a Peripheral Component Interconnect Express (PCIe), Ethernet, OpenCAPI™, Gen-Z™, UPI, Universal Serial Bus, (USB), Cache Coherent Interconnect for Accelerators (CCIX™), Advanced Micro Device™'s (AMD™) Infinity™, Common Communication Interface (CCI), or Qualcomm™'s Centriq™ interconnect, among others.

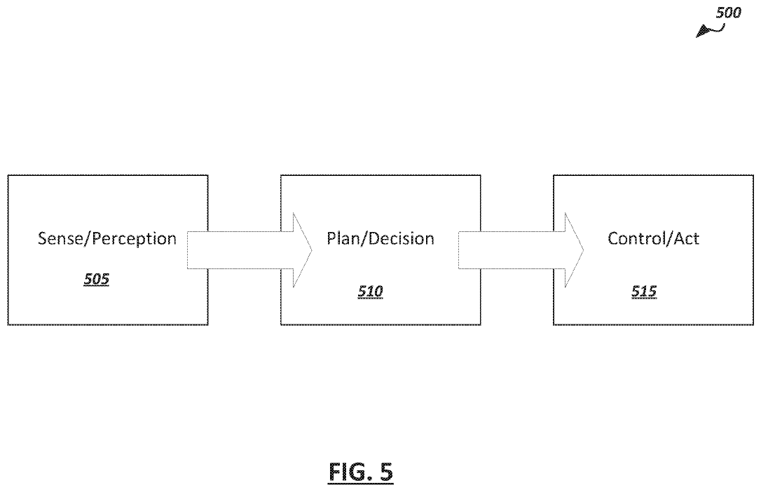

Continuing with the example of FIG. 2, an example vehicle (and corresponding in-vehicle computing system) 105 may include an in-vehicle processing system 210, driving controls (e.g., 220), sensors (e.g., 225), and user/passenger interface(s) (e.g., 230), among other example modules implemented functionality of the autonomous vehicle in hardware and/or software. For instance, an in-vehicle processing system 210, in some implementations, may implement all or a portion of an autonomous driving stack and process flow (e.g., as shown and discussed in the example of FIG. 5). The autonomous driving stack may be implemented in hardware, firmware, or software. A machine learning engine 232 may be provided to utilize various machine learning models (e.g., 256) provided at the vehicle 105 in connection with one or more autonomous functions and features provided and implemented at or for the vehicle, such as discussed in the examples herein. Such machine learning models 256 may include artificial neural network models, convolutional neural networks, decision tree-based models, support vector machines (SVMs), Bayesian models, deep learning models, and other example models. In some implementations, an example machine learning engine 232 may include one or more model trainer engines 252 to participate in training (e.g., initial training, continuous training, etc.) of one or more of the machine learning models 256. One or more inference engines 254 may also be provided to utilize the trained machine learning models 256 to derive various inferences, predictions, classifications, and other results. In some embodiments, the machine learning model training or inference described herein may be performed off-vehicle, such as by computing system 140 or 150.

The machine learning engine(s) 232 provided at the vehicle may be utilized to support and provide results for use by other logical components and modules of the in-vehicle processing system 210 implementing an autonomous driving stack and other autonomous-driving-related features. For instance, a data collection module 234 may be provided with logic to determine sources from which data is to be collected (e.g., for inputs in the training or use of various machine learning models 256 used by the vehicle). For instance, the particular source (e.g., internal sensors (e.g., 225) or extraneous sources (e.g., 115, 140, 150, 180, 215, etc.)) may be selected, as well as the frequency and fidelity at which the data may be sampled is selected. In some cases, such selections and configurations may be made at least partially autonomously by the data collection module 234 using one or more corresponding machine learning models (e.g., to collect data as appropriate given a particular detected scenario).

A sensor fusion module 236 may also be used to govern the use and processing of the various sensor inputs utilized by the machine learning engine 232 and other modules (e.g., 238, 240, 242, 244, 246, etc.) of the in-vehicle processing system. One or more sensor fusion modules (e.g., 236) may be provided, which may derive an output from multiple sensor data sources (e.g., on the vehicle or extraneous to the vehicle). The sources may be homogenous or heterogeneous types of sources (e.g., multiple inputs from multiple instances of a common type of sensor, or from instances of multiple different types of sensors). An example sensor fusion module 236 may apply direct fusion, indirect fusion, among other example sensor fusion techniques. The output of the sensor fusion may, in some cases by fed as an input (along with potentially additional inputs) to another module of the in-vehicle processing system and/or one or more machine learning models in connection with providing autonomous driving functionality or other functionality, such as described in the example solutions discussed herein.

A perception engine 238 may be provided in some examples, which may take as inputs various sensor data (e.g., 258) including data, in some instances, from extraneous sources and/or sensor fusion module 236 to perform object recognition and/or tracking of detected objects, among other example functions corresponding to autonomous perception of the environment encountered (or to be encountered) by the vehicle 105. Perception engine 238 may perform object recognition from sensor data inputs using deep learning, such as through one or more convolutional neural networks and other machine learning models 256. Object tracking may also be performed to autonomously estimate, from sensor data inputs, whether an object is moving and, if so, along what trajectory. For instance, after a given object is recognized, a perception engine 238 may detect how the given object moves in relation to the vehicle. Such functionality may be used, for instance, to detect objects such as other vehicles, pedestrians, wildlife, cyclists, etc. moving within an environment, which may affect the path of the vehicle on a roadway, among other example uses.

A localization engine 240 may also be included within an in-vehicle processing system 210 in some implementation. In some cases, localization engine 240 may be implemented as a sub-component of a perception engine 238. The localization engine 240 may also make use of one or more machine learning models 256 and sensor fusion (e.g., of LIDAR and GPS data, etc.) to determine a high confidence location of the vehicle and the space it occupies within a given physical space (or “environment”).

A vehicle 105 may further include a path planner 242, which may make use of the results of various other modules, such as data collection 234, sensor fusion 236, perception engine 238, and localization engine (e.g., 240) among others (e.g., recommendation engine 244) to determine a path plan and/or action plan for the vehicle, which may be used by drive controls (e.g., 220) to control the driving of the vehicle 105 within an environment. For instance, a path planner 242 may utilize these inputs and one or more machine learning models to determine probabilities of various events within a driving environment to determine effective real-time plans to act within the environment.

In some implementations, the vehicle 105 may include one or more recommendation engines 244 to generate various recommendations from sensor data generated by the vehicle's 105 own sensors (e.g., 225) as well as sensor data from extraneous sensors (e.g., on sensor devices 115, 180, 215, etc.). Some recommendations may be determined by the recommendation engine 244, which may be provided as inputs to other components of the vehicle's autonomous driving stack to influence determinations that are made by these components. For instance, a recommendation may be determined, which, when considered by a path planner 242, causes the path planner 242 to deviate from decisions or plans it would ordinarily otherwise determine, but for the recommendation. Recommendations may also be generated by recommendation engines (e.g., 244) based on considerations of passenger comfort and experience. In some cases, interior features within the vehicle may be manipulated predictively and autonomously based on these recommendations (which are determined from sensor data (e.g., 258) captured by the vehicle's sensors and/or extraneous sensors, etc.

As introduced above, some vehicle implementations may include user/passenger experience engines (e.g., 246), which may utilize sensor data and outputs of other modules within the vehicle's autonomous driving stack to control a control unit of the vehicle in order to change driving maneuvers and effect changes to the vehicle's cabin environment to enhance the experience of passengers within the vehicle based on the observations captured by the sensor data (e.g., 258). In some instances, aspects of user interfaces (e.g., 230) provided on the vehicle to enable users to interact with the vehicle and its autonomous driving system may be enhanced. In some cases, informational presentations may be generated and provided through user displays (e.g., audio, visual, and/or tactile presentations) to help affect and improve passenger experiences within a vehicle (e.g., 105) among other example uses.

In some cases, a system manager 250 may also be provided, which monitors information collected by various sensors on the vehicle to detect issues relating to the performance of a vehicle's autonomous driving system. For instance, computational errors, sensor outages and issues, availability and quality of communication channels (e.g., provided through communication modules 212), vehicle system checks (e.g., issues relating to the motor, transmission, battery, cooling system, electrical system, tires, etc.), or other operational events may be detected by the system manager 250. Such issues may be identified in system report data generated by the system manager 250, which may be utilized, in some cases as inputs to machine learning models 256 and related autonomous driving modules (e.g., 232, 234, 236, 238, 240, 242, 244, 246, etc.) to enable vehicle system health and issues to also be considered along with other information collected in sensor data 258 in the autonomous driving functionality of the vehicle 105.

In some implementations, an autonomous driving stack of a vehicle 105 may be coupled with drive controls 220 to affect how the vehicle is driven, including steering controls (e.g., 260), accelerator/throttle controls (e.g., 262), braking controls (e.g., 264), signaling controls (e.g., 266), among other examples. In some cases, a vehicle may also be controlled wholly or partially based on user inputs. For instance, user interfaces (e.g., 230), may include driving controls (e.g., a physical or virtual steering wheel, accelerator, brakes, clutch, etc.) to allow a human driver to take control from the autonomous driving system (e.g., in a handover or following a driver assist action). Other sensors may be utilized to accept user/passenger inputs, such as speech detection 292, gesture detection cameras 294, and other examples. User interfaces (e.g., 230) may capture the desires and intentions of the passenger-users and the autonomous driving stack of the vehicle 105 may consider these as additional inputs in controlling the driving of the vehicle (e.g., drive controls 220). In some implementations, drive controls may be governed by external computing systems, such as in cases where a passenger utilizes an external device (e.g., a smartphone or tablet) to provide driving direction or control, or in cases of a remote valet service, where an external driver or system takes over control of the vehicle (e.g., based on an emergency event), among other example implementations.

As discussed above, the autonomous driving stack of a vehicle may utilize a variety of sensor data (e.g., 258) generated by various sensors provided on and external to the vehicle. As an example, a vehicle 105 may possess an array of sensors 225 to collect various information relating to the exterior of the vehicle and the surrounding environment, vehicle system status, conditions within the vehicle, and other information usable by the modules of the vehicle's processing system 210. For instance, such sensors 225 may include global positioning (GPS) sensors 268, light detection and ranging (LIDAR) sensors 270, two-dimensional (2D) cameras 272, three-dimensional (3D) or stereo cameras 274, acoustic sensors 276, inertial measurement unit (IMU) sensors 278, thermal sensors 280, ultrasound sensors 282, bio sensors 284 (e.g., facial recognition, voice recognition, heart rate sensors, body temperature sensors, emotion detection sensors, etc.), radar sensors 286, weather sensors (not shown), among other example sensors. Such sensors may be utilized in combination to determine various attributes and conditions of the environment in which the vehicle operates (e.g., weather, obstacles, traffic, road conditions, etc.), the passengers within the vehicle (e.g., passenger or driver awareness or alertness, passenger comfort or mood, passenger health or physiological conditions, etc.), other contents of the vehicle (e.g., packages, livestock, freight, luggage, etc.), subsystems of the vehicle, among other examples. Sensor data 258 may also (or instead) be generated by sensors that are not integrally coupled to the vehicle, including sensors on other vehicles (e.g., 115) (which may be communicated to the vehicle 105 through vehicle-to-vehicle communications or other techniques), sensors on ground-based or aerial drones 180, sensors of user devices 215 (e.g., a smartphone or wearable) carried by human users inside or outside the vehicle 105, and sensors mounted or provided with other roadside elements, such as a roadside unit (e.g., 140), road sign, traffic light, streetlight, etc. Sensor data from such extraneous sensor devices may be provided directly from the sensor devices to the vehicle or may be provided through data aggregation devices or as results generated based on these sensors by other computing systems (e.g., 140, 150), among other example implementations.

In some implementations, an autonomous vehicle system 105 may interface with and leverage information and services provided by other computing systems to enhance, enable, or otherwise support the autonomous driving functionality of the device 105. In some instances, some autonomous driving features (including some of the example solutions discussed herein) may be enabled through services, computing logic, machine learning models, data, or other resources of computing systems external to a vehicle. When such external systems are unavailable to a vehicle, it may be that these features are at least temporarily disabled. For instance, external computing systems may be provided and leveraged, which are hosted in road-side units or fog-based edge devices (e.g., 140), other (e.g., higher-level) vehicles (e.g., 115), and cloud-based systems 150 (e.g., accessible through various network access points (e.g., 145)). A roadside unit 140 or cloud-based system 150 (or other cooperating system, with which a vehicle (e.g., 105) interacts may include all or a portion of the logic illustrated as belonging to an example in-vehicle processing system (e.g., 210), along with potentially additional functionality and logic. For instance, a cloud-based computing system, road side unit 140, or other computing system may include a machine learning engine supporting either or both model training and inference engine logic. For instance, such external systems may possess higher-end computing resources and more developed or up-to-date machine learning models, allowing these services to provide superior results to what would be generated natively on a vehicle's processing system 210. For instance, an in-vehicle processing system 210 may rely on the machine learning training, machine learning inference, and/or machine learning models provided through a cloud-based service for certain tasks and handling certain scenarios. Indeed, it should be appreciated that one or more of the modules discussed and illustrated as belonging to vehicle 105 may, in some implementations, be alternatively or redundantly provided within a cloud-based, fog-based, or other computing system supporting an autonomous driving environment.

Various embodiments herein may utilize one or more machine learning models to perform functions of the autonomous vehicle stack (or other functions described herein). A machine learning model may be executed by a computing system to progressively improve performance of a specific task. In some embodiments, parameters of a machine learning model may be adjusted during a training phase based on training data. A trained machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various embodiments described herein may utilize one or more classification models. In a classification model, the outputs may be restricted to a limited set of values. The classification model may output a class for an input set of one or more input values. References herein to classification models may contemplate a model that implements, e.g., any one or more of the following techniques: linear classifiers (e.g., logistic regression or naïve Bayes classifier), support vector machines, decision trees, boosted trees, random forest, neural networks, or nearest neighbor.

Various embodiments described herein may utilize one or more regression models. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

In various embodiments, any of the machine learning models discussed herein may utilize one or more neural networks. A neural network may include a group of neural units loosely modeled after the structure of a biological brain which includes large clusters of neurons connected by synapses. In a neural network, neural units are connected to other neural units via links which may be excitatory or inhibitory in their effect on the activation state of connected neural units. A neural unit may perform a function utilizing the values of its inputs to update a membrane potential of the neural unit. A neural unit may propagate a spike signal to connected neural units when a threshold associated with the neural unit is surpassed. A neural network may be trained or otherwise adapted to perform various data processing tasks (including tasks performed by the autonomous vehicle stack), such as computer vision tasks, speech recognition tasks, or other suitable computing tasks.

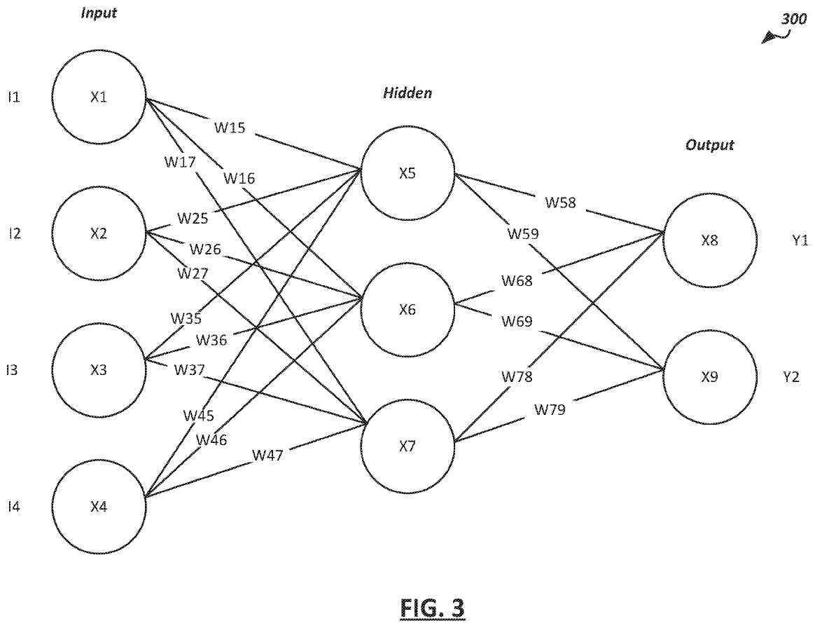

FIG. 3 illustrates an example portion of a neural network 300 in accordance with certain embodiments. The neural network 300 includes neural units X1-X9. Neural units X1-X4 are input neural units that respectively receive primary inputs I1-I4 (which may be held constant while the neural network 300 processes an output). Any suitable primary inputs may be used. As one example, when neural network 300 performs image processing, a primary input value may be the value of a pixel from an image (and the value of the primary input may stay constant while the image is processed). As another example, when neural network 300 performs speech processing the primary input value applied to a particular input neural unit may change over time based on changes to the input speech.

While a specific topology and connectivity scheme is shown in FIG. 3, the teachings of the present disclosure may be used in neural networks having any suitable topology and/or connectivity. For example, a neural network may be a feedforward neural network, a recurrent network, or other neural network with any suitable connectivity between neural units. As another example, although the neural network is depicted as having an input layer, a hidden layer, and an output layer, a neural network may have any suitable layers arranged in any suitable fashion In the embodiment depicted, each link between two neural units has a synapse weight indicating the strength of the relationship between the two neural units. The synapse weights are depicted as WXY, where X indicates the pre-synaptic neural unit and Y indicates the post-synaptic neural unit. Links between the neural units may be excitatory or inhibitory in their effect on the activation state of connected neural units. For example, a spike that propagates from X1 to X5 may increase or decrease the membrane potential of X5 depending on the value of W15. In various embodiments, the connections may be directed or undirected.

In various embodiments, during each time-step of a neural network, a neural unit may receive any suitable inputs, such as a bias value or one or more input spikes from one or more of the neural units that are connected via respective synapses to the neural unit (this set of neural units are referred to as fan-in neural units of the neural unit). The bias value applied to a neural unit may be a function of a primary input applied to an input neural unit and/or some other value applied to a neural unit (e.g., a constant value that may be adjusted during training or other operation of the neural network). In various embodiments, each neural unit may be associated with its own bias value or a bias value could be applied to multiple neural units.

The neural unit may perform a function utilizing the values of its inputs and its current membrane potential. For example, the inputs may be added to the current membrane potential of the neural unit to generate an updated membrane potential. As another example, a non-linear function, such as a sigmoid transfer function, may be applied to the inputs and the current membrane potential. Any other suitable function may be used. The neural unit then updates its membrane potential based on the output of the function.

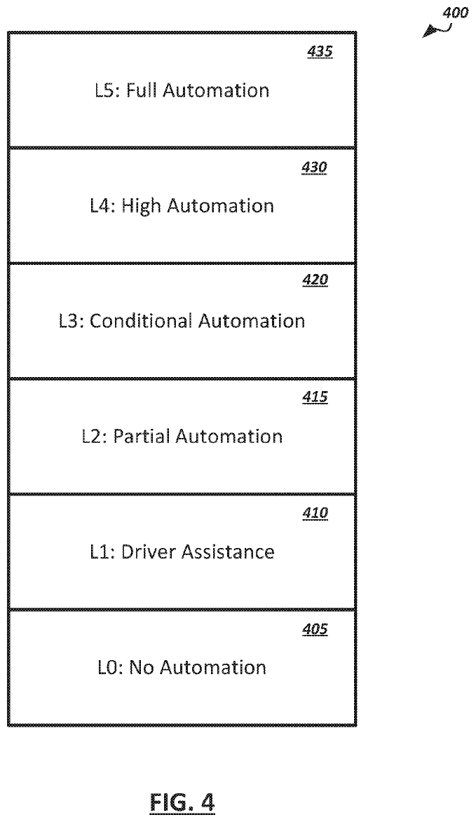

Turning to FIG. 4, a simplified block diagram 400 is shown illustrating example levels of autonomous driving, which may be supported in various vehicles (e.g., by their corresponding in-vehicle computing systems. For instance, a range of levels may be defined (e.g., L0-L5 (405-435)), with level 5 (L5) corresponding to vehicles with the highest level of autonomous driving functionality (e.g., full automation), and level 0 (L0) corresponding the lowest level of autonomous driving functionality (e.g., no automation). For instance, an L5 vehicle (e.g., 435) may possess a fully-autonomous computing system capable of providing autonomous driving performance in every driving scenario equal to or better than would be provided by a human driver, including in extreme road conditions and weather. An L4 vehicle (e.g., 430) may also be considered fully-autonomous and capable of autonomously performing safety-critical driving functions and effectively monitoring roadway conditions throughout an entire trip from a starting location to a destination. L4 vehicles may differ from L5 vehicles, in that an L4's autonomous capabilities are defined within the limits of the vehicle's “operational design domain,” which may not include all driving scenarios. L3 vehicles (e.g., 420) provide autonomous driving functionality to completely shift safety-critical functions to the vehicle in a set of specific traffic and environment conditions, but which still expect the engagement and availability of human drivers to handle driving in all other scenarios. Accordingly, L3 vehicles may provide handover protocols to orchestrate the transfer of control from a human driver to the autonomous driving stack and back. L2 vehicles (e.g., 415) provide driver assistance functionality, which allow the driver to occasionally disengage from physically operating the vehicle, such that both the hands and feet of the driver may disengage periodically from the physical controls of the vehicle. L1 vehicles (e.g., 410) provide driver assistance of one or more specific functions (e.g., steering, braking, etc.), but still require constant driver control of most functions of the vehicle. L0 vehicles may be considered not autonomous—the human driver controls all of the driving functionality of the vehicle (although such vehicles may nonetheless participate passively within autonomous driving environments, such as by providing sensor data to higher level vehicles, using sensor data to enhance GPS and infotainment services within the vehicle, etc.). In some implementations, a single vehicle may support operation at multiple autonomous driving levels. For instance, a driver may control and select which supported level of autonomy is used during a given trip (e.g., L4 or a lower level). In other cases, a vehicle may autonomously toggle between levels, for instance, based on conditions affecting the roadway or the vehicle's autonomous driving system. For example, in response to detecting that one or more sensors have been compromised, an L5 or L4 vehicle may shift to a lower mode (e.g., L2 or lower) to involve a human passenger in light of the sensor issue, among other examples.

FIG. 5 is a simplified block diagram 500 illustrating an example autonomous driving flow which may be implemented in some autonomous driving systems. For instance, an autonomous driving flow implemented in an autonomous (or semi-autonomous) vehicle may include a sensing and perception stage 505, a planning and decision stage 510, and a control and action phase 515. During a sensing and perception stage 505 data is generated by various sensors and collected for use by the autonomous driving system. Data collection, in some instances, may include data filtering and receiving sensor from external sources. This stage may also include sensor fusion operations and object recognition and other perception tasks, such as localization, performed using one or more machine learning models. A planning and decision stage 510 may utilize the sensor data and results of various perception operations to make probabilistic predictions of the roadway(s) ahead and determine a real time path plan based on these predictions. A planning and decision stage 510 may additionally include making decisions relating to the path plan in reaction to the detection of obstacles and other events to decide on whether and what action to take to safely navigate the determined path in light of these events. Based on the path plan and decisions of the planning and decision stage 510, a control and action stage 515 may convert these determinations into actions, through actuators to manipulate driving controls including steering, acceleration, and braking, as well as secondary controls, such as turn signals, sensor cleaners, windshield wipers, headlights, etc.

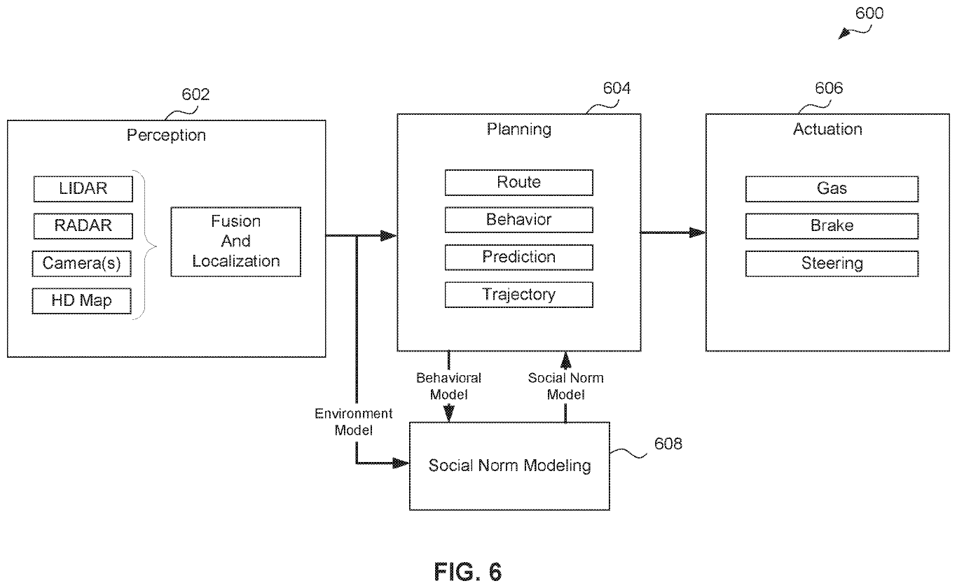

In some implementations, an autonomous driving stack may utilize a “sense, plan, act” model. For instance, FIG. 6 shows an example “sense, plan, act” model 600 for controlling autonomous vehicles in accordance with at least one embodiment. The model 600 may also be referred to as an autonomous vehicle control pipeline in some instances. In the example shown, the sensing/perception system 602 includes either a singular type or a multi-modal combination of sensors (e.g., LIDAR, radar, camera(s), HD map as shown, or other types of sensors) that allow a digital construction (via sensor fusion) of the environment, including moving and non-moving agents and their current position in relation to the sensing element. This allows an autonomous vehicle to construct an internal representation of its surroundings and place itself within that representation (which may be referred to as an environment model). The environment model may include, in some cases, three types of components: static information about the environment (which may be correlated with an HD map), dynamic information about the environment (e.g., moving objects on the road, which may be represented by current position information and velocity vectors), and Ego localization information representing where the autonomous vehicle fits within the model.

The environment model may then be fed into a planning system 604 of an in-vehicle autonomous driving system, which takes the actively updated environment information and constructs a plan of action in response (which may include, e.g., route information, behavior information, prediction information, and trajectory information) to the predicted behavior of these environment conditions. The plan is then provided to an actuation system 606, which can make the car act on said plan (e.g., by actuating the gas, brake, and steering systems of the autonomous vehicle).

In one or more aspects, a social norm modeling system 608 exists between the sense and planning systems, and functions as parallel input into the planning system. The proposed social norm modeling system would serve as a to provide adaptive semantic behavioral understanding on the vehicle's environment with the goal to adapt the vehicle's behavior to the social norm observed in a particular location. For instance, in the example shown, the social norm modeling system 608 receives the environment model generated by the perception system 602 along with a behavioral model used by the planning system 604, and uses such information as inputs to determine a social norm model, which may be provided back to the planning system 604 for consideration.

The social norm modeling system 608 may be capable of taking in sensory information from the sensing components of the vehicle and formulating location-based behavioral models of social driving norms. This information may be useful to addressing timid autonomous vehicle behavior as it may be utilized to quantify and interpret human driver behavior in a way that makes autonomous vehicles less risk-averse to what human drivers would consider normal road negotiation. For example, current models may take a calculated approach and thus measure the risk of collision when a certain action is taken; however, this approach alone can render an autonomous vehicle helpless when negotiating onto a highway in environments where aggressive driving is the social norm.

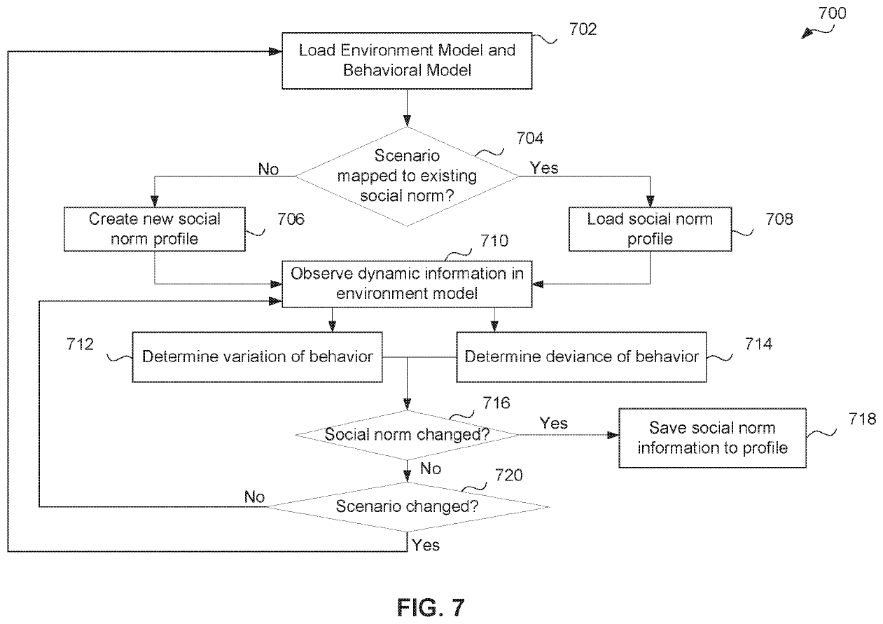

FIG. 7 illustrates a simplified social norm understanding model 700 in accordance with at least one embodiment. The social norm understanding model may be implemented by a social norm modeling system of an autonomous vehicle control pipeline, such as the social norm modeling system 608 of the autonomous vehicle control pipeline 600.

In the example shown, the social norm modeling system first loads an environment model and a behavioral model for the autonomous vehicle at 702. The environment model may be an environment model passed to the social norm modeling system from a perception system of an autonomous vehicle control pipeline (e.g., as shown in FIG. 6). The behavioral policy may be received from a planning phase of an autonomous vehicle control pipeline (e.g., as shown in FIG. 6). In some cases, a default behavioral policy used by the planning phase may be sent. In other cases, the behavioral policy may be based on the environment model passed to the planning system by the perception system.

At 704, the social norm modeling system determines whether the scenario depicted by the environment model is mapped to an existing social norm profile. If so, the existing social norm profile is loaded for reference. If not, then a new social norm profile is created. The newly created social norm profile may include default constraints or other information to describe a social norm. Each social norm profile may be associated with a particular scenario/environment (e.g., number of cars around the autonomous vehicle, time of day, speed of surrounding vehicles, weather conditions, etc.), and may include constraints (described further below) or other information to describe the social norm with respect to a behavioral policy. Each social norm profile may also be associated with a particular geographical location. For instance, the same scenario may be presented in different geographical locations, but each scenario may have a different corresponding social norm profile because the observed behaviors may be quite different in the different locations.

Next, at 710, the social norm modeling system observes dynamic information in the environment model. The dynamic information may include behavior information about dynamic obstacles (e.g., other vehicles or people on the road). The social norm modeling system then, in parallel: (1) determines or estimates a variation in the observed behavior displayed by the dynamic obstacles at 712, and (2) determines or estimates a deviation of the observed behavior displayed by the dynamic obstacles from the behavior of the autonomous vehicle itself at 714. For instance, the model may determine at 712 whether the observed behavior of the other vehicles is within the current parameters of the behavioral model loaded at 702, and may determine at 714 whether the deviation between behavior of the vehicles is within current parameters of the behavioral model.

Based on the determined variation and deviation, the social norm understanding model may determine whether the observed social norm has changed from the social norm profile at 716. If so, the new information (e.g., constraints as described below) may be saved to the social norm profile. If not, the model may determine whether the scenario has changed at 720. If not, the model continues to observe the dynamic information and make determinations on the variance and deviation of observed behavior as described above. If the scenario changes, the model performs the process from the beginning, starting at 702.

In some embodiments, the social norm understanding model 700 may be responsible for generating social norms as observation-based constraints for the ego-vehicle behavioral policy. The generation of these constraints may be derived from temporal tracking behavior in the scenario of surrounding vehicles. In particular, two processes may be executed in parallel:
Estimation of a variation of behavior, which analyzes a Euclidean (or other distance metric, e.g., mahalanobis) distance to the current behavior policy/model from the observations of every surrounding vehicle; and
Estimation of a deviation, which analyzes the responses of surrounding vehicles to the observed driving policies determining negative feedback (transgressions) that act as limits for the behavior.

The result of these two parallel processes may be used to determine the behavior boundary limits that form a social norm. This social norm (e.g., the boundary limits) may then be returned to the planning module to act as constraints fitting the particular driving scenario. Depending on the variation of behavior and the deviation observed in the parallel processes, the resulting social norm might apply tighter or loosened constraints to the behavioral planner enabling a more naturalistic driving behavior. In some cases, social norm construction may depend on scenario characteristics such as road geometry and signaling, as well as on the observed surrounding vehicles. Different social norms might emerge from the combination of road environments and number of vehicle participants interacting with the ego-vehicle. In some instances, the model may allow for changes in social norm that occur with time.

In one example implementation, a scenario might be composed of a roadmap geometry that specifies lanes as part of an HD map and vehicles placed in these lanes with states characterized by Xᵢ=[xᵢ, yᵢ, ϵᵢ, ϑᵢ], where (xᵢ, yᵢ) indicate a position, θᵢ indicates a direction, and ϑᵢ indicates a velocity for each vehicle i. Thus, a number m of vehicle states might be provided as a set (X₁, . . . Xₘ). Trajectories for each of the vehicles might be calculated at time intervals using the following cost function:

$${J}_{i} = {\sum }_{t = 1}^{N - 1} ( {‖ {X}_{i , t} ‖}^{2} + {‖ Δ {u}_{i , t} ‖}^{2} )$$

Where Δuᵢ is the observed difference of vehicle control with respect to the behavioral model. The application of the cost function over a defined observation window N generates trajectory tryᵢ. Constraints to this trajectory planning can be retrieved from static obstacles as y_{i,k}min<y_{i,k}<y_{i,k}max, dynamic obstacles (safety constraints) (x_{i,k},)ϵSᵢ (x, y) or feasibility of a particular output u_{i,k}. Interaction between each of the vehicles can be observed as Σᵢ₌₁^{m}Jᵢ and from the observed interactions changes in the constraints can be derived (e.g., by minimizing the cost function Jᵢ). The derived constraints may be considered to be a “social norm” for the scenario, and may, in some embodiments, be passed to the planning system to be applied directly to the ego cost function for trajectory planning. Other implementations might use other cost functions to derive constraints. In some cases, for example, implementations may include using neural networks for learning the social norms, or partially-observable Markov decision process.

When understanding of the driving culture/social norm is known (e.g., for aggressive driving), planning systems can be adapted to alter their negotiation tactics in order to be more/less aggressive and accepting of risk since risk reduction comes from knowledge of the risk being expected by other agents on the road. Further, by monitoring social norms, the issue with autonomous driving systems being designed for particular geographic contexts may be resolved, as behavioral models can be designs for multiple geographic locations and improved as time passes. This approach also sets the foundation for the creation and distribution of social driving norms. As autonomous vehicles become the majority of the population on the road, this adaptive semantic behavioral understanding system can allow for shared behavioral models which can dictate road negotiation for all road actors.

Operations in the example processes shown in FIGS. 6, 7 may be performed by various aspects or components of the in-vehicle computing system of an example autonomous vehicle. The example processes may include additional or different operations, and the operations may be performed in the order shown or in another order. In some cases, one or more of the operations shown in FIGS. 6, 7 are implemented as processes that include multiple operations, sub-processes, or other types of routines. In some cases, operations can be combined, performed in another order, performed in parallel, iterated, or otherwise repeated or performed another manner.

Vehicle-to-vehicle communications (V2V) may be utilized by autonomous vehicles to realize risk-reduction. For instance, such communications may be used to broadcast events such as crashes, position of obstacles in the road, etc. Other use cases may make use of remote sensing for collaborative tasks such as mapping or maneuver collaboration. On the second type of collaborative tasks, most of the concepts are restricted to very specific traffic situations or applications such as Cooperative Adaptive Cruise Control (C-ACC) used to coordinate platooning. C-ACC, for instance, employs longitudinal coordination to maintain a minimal time gap to the preceding vehicle and obtain traffic flow and fuel efficiency improvements. Other coordinated maneuvers may be supported in some systems, such as lane-changing and merging through a combination of longitudinal and lateral coordination in order to establish secure gaps in vehicle corridors and adjacent lanes. However, longitudinal and lateral coordinated control may not be enough at intersections where coordination of multiple vehicles and the application of right-of-way rules is needed to achieve cooperation. Existing solutions are useful for specific driving scenarios, but lack mechanisms for interoperability. Furthermore, most such solutions assume that each vehicle is connected and automated and that they are controlled by the same strategy. In this sense, machine learning models used in some autonomous driving systems assume a generic vehicle behavior and tailor the autonomous driving decisions based on these assumptions. Standard approaches to autonomous driving systems may also apply models that assume an ideal (e.g., that other cars are autonomous, that human drivers are law abiding, etc.), but such solutions are not applicable, however, in mixed traffic scenarios where human drivers and their behaviors cannot be controlled and may or may not comply with rules or traffic cooperation objectives.

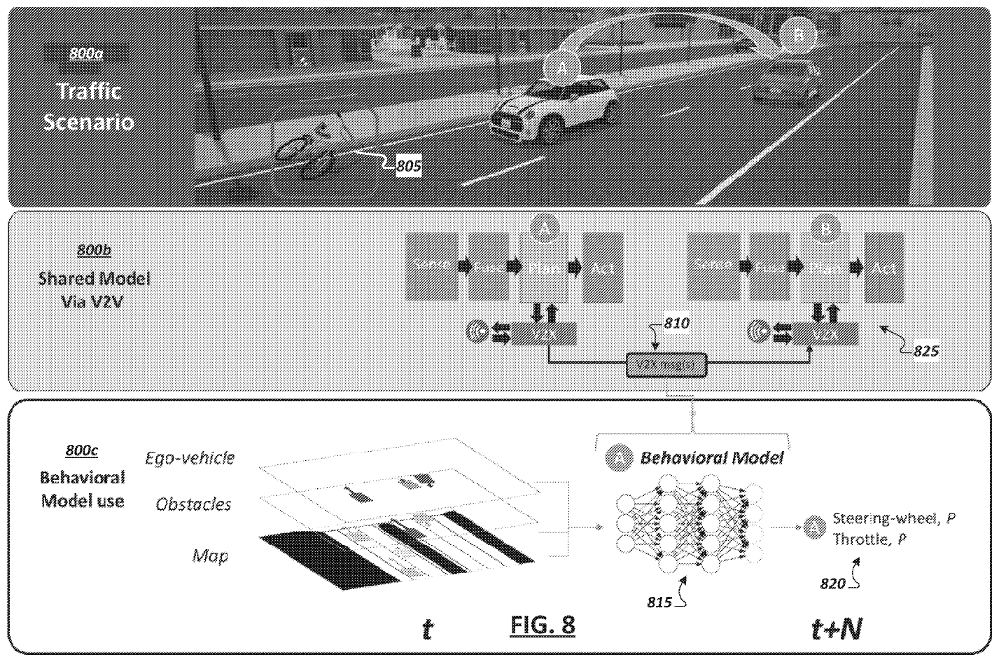

In some implementations, an in-vehicle autonomous driving system of a particular vehicle may be configured to perform maneuver coordination in fully automated or mixed traffic scenarios and make use of shared behavioral models communicated via V2X communication technologies (including Vehicle to Vehicle (V2V) or Infrastructure to Vehicle (I2V), etc.) in support of the autonomous driving decision-making and path planning functionality of the particular vehicle. For instance, as shown in FIG. 8, diagrams 800a-c are shown illustrating aspects of coordination between vehicles in an environment where at least a portion of the vehicles are semi- or full-autonomous. For instance, behavioral models can be constructed using driving rules in the case of automated vehicles or via data learning processes deriving naturalistic driving behaviors. For instance, as discussed above, behavioral models can be provided that are capable of continuous development and improvement through adaptions based on observations from the environment serving as the basis for modifying learned constraints defined in the model. In the case of human-driven vehicles, where models might not exist, approximate behavioral models can be constructed over time using artificial neural networks. Such neural network models may continually learn and be refined based on the inputs provided to the model. For instance, example input parameters to such models may include road environment information (e.g., map data), position and velocity vectors of surrounding vehicles, ego vehicle initial position and velocity vector, driver identification information (e.g., demographics of human drivers), among other examples. Accordingly, when a vehicle shares its behavioral model with other vehicles, the version of the behavioral model may be one that has been refined and further tuned based on observations and further learning by the vehicle during on-road operation.

As shown in FIG. 8, diagram 800a shows two vehicles A and B in a driving environment. V2V communication may be enabled to allow one or both of the vehicles to share observations and sensor data with the other. For instance, vehicle A may detect an obstacle (e.g., 805) impacting a section of a roadway and may further detect the presence of another vehicle (e.g., vehicle B) in or entering the same section of the roadway. In response, vehicle A may communicate information concerning the obstacle 805 (e.g., its coordinates, a type of obstacle or hazard (e.g., an object, an accident, a weather event, a sign or traffic light outage, etc.)), a computer-vision-based classification determined for the obstacle (e.g., that the obstacle is a bicycle), among other information. Additionally, as introduced above, the vehicles A and B may also utilize V2V or V2X communications to share behavioral models with the other vehicles. These models may be utilized by a receiving vehicle to determine probabilities that neighboring vehicles will take certain actions in certain situations. These determined probabilities may then be used as inputs to the vehicle's own machine learning or other (e.g., logic based such as rule based) models and autonomous driving logic to affect the decision-making and path-planning when in the presence of these neighboring vehicles.

FIG. 8 illustrates a flow for exchanging and using behavioral models within autonomous driving environments. For instance, as illustrated in diagram 800a, two vehicles may identify the presence of each other within a section of a roadway and send information identifying, to the other vehicle, the sending vehicle's current position, pose, and speed, etc. To the extent behavioral models have not already been shared or obtained from the other vehicle, one or more behavioral models may be exchanged between the vehicles or with infrastructure intermediaries. As shown in diagram 800c, behavioral models take as inputs mapping and other geographic data (e.g., identifying which potential paths are drivable), detected obstacles within these paths, and the state of the vehicle (e.g., its position, orientation, speed, acceleration, braking, etc.). Outputs generated by behavioral models can indicate a probability that the corresponding vehicle will take particular action (e.g., steer, brake, accelerate, etc.). Behavioral models can be generic or scenario specific (e.g., lane keeping, lane changing, ramp merging, or intersections models, etc.). For instance, the behavioral model may be a “universal” model in the sense that it is to classify, for any particular driving scenario, the probabilities of the corresponding vehicle's actions in the scenario. In other cases, multiple scenario- or location-specific behavioral models may be developed for a single vehicle (or vehicle make/model) and the collection of models may be exchanged (e.g., all at once as a package, situationally based on the location(s) or scenario(s) in which the vehicle encounters other vehicles, etc.). In such instances, a vehicle may first detect the scenario it is planning around (e.g., based on determinations made in the vehicle's own path planning phase) and use the results to identify a specific one of the other vehicle's shared models to identify the behavioral model that best “fits” the present scenario and use this behavioral model, among other example implementations.

Continuing with the example of FIG. 8, upon receiving the behavioral model for vehicle A, vehicle B may detect that vehicle A is in its vicinity and further detect current inputs for the behavioral model, such as from vehicle B's own sensor array, outside data sources (e.g., roadside units), or data shared V2V by vehicle A (e.g., through a beacon signal) describing the environment, obstacles, vehicle A's speed, etc. These inputs (e.g., 810) may be provided as inputs to the shared behavioral model (e.g., 815) to derive a probability value P (e.g., 820). This probability value 820 may indicate the probability that vehicle A will perform a particular action (given the current environment and observed status of vehicle A), such as steering in a certain direction, accelerating, braking, maintaining speed, etc. This probability value 820 may then be utilized by the autonomous driving stack (e.g., 825) of vehicle B in planning its own path and making decisions relative to the presence of vehicle A. Accordingly, through the use of the shared behavioral model, vehicle B may alter the manner in which it determines actions to take within the driving environment from a default approach or programming that the autonomous driving stack 825 uses when driving in the presence of vehicles for which a behavioral model is not available, among other example implementations.

Accordingly, in some implementations, to enable one vehicle to anticipate and plan (using its own machine learning capabilities) the actions and maneuvers of other vehicles, and in particular vehicles with different driving autonomy levels, the vehicle may obtain or otherwise access behavioral models for these other vehicles. Based on these neighboring vehicles' models, a vehicle sharing the road with these vehicles may predict how these vehicles will respond based on conditions observed in the environment, which affect each of the vehicles. By providing a vehicle with surrounding vehicles' behavioral models, the vehicle may be able to estimate future scenarios through projection of environmental conditions. In this manner, vehicles equipped with these additional behavioral models may plan a risk-optimized decision based on current observations and model-based predictions that present a lower uncertainty. Such a solution not only increases safety within the autonomous driving environment but may be computationally more efficient as the vehicle using these other models does not need to compute individual behavioral models based on probabilistic projections for the surrounding vehicles, but merely check if the projections are credible and modify its behavior accordingly.

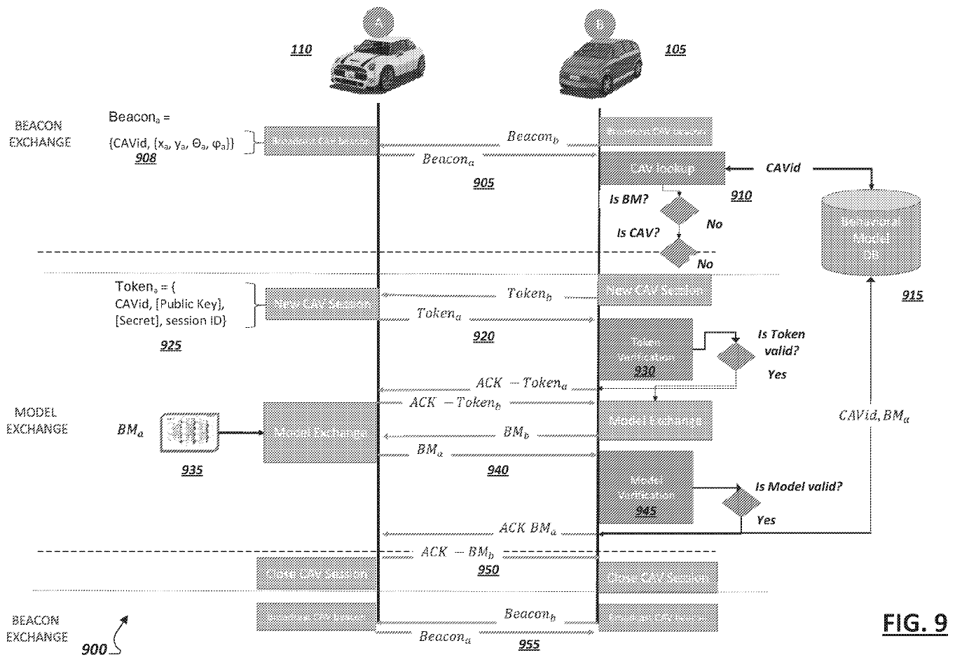

Turning to FIG. 9, a block diagram 900 is shown illustrating example information exchange between two vehicles 105, 110. In one example, connected vehicles may have multiple different modes for information exchange, including beacon exchange and model exchange. In one example, beacon exchange involves the broadcast of a beacon 908 to signal the corresponding vehicle's identity (e.g., a connected autonomous vehicle identifier (CAVid)) together with a state vector representing the same vehicle's position, orientation, and heading). Model exchange may involve broadcasting to other vehicles (and roadside systems) the behavioral model of the broadcasting vehicle.

Given that a behavioral model may be acted upon by another vehicle to predict future vehicle behaviors and take corresponding action, in some cases, behavioral models may be accepted and used only when received from trusted vehicles. Accordingly, exchanges of models between vehicle may include a trust protocol to enable the devices to establish initial trustworthiness of behavioral models received from that vehicle. In some implementations, this trustworthiness value can change over time if the output behavior differs significantly from the observed vehicle behavior. Should the trustworthiness value fall below a certain threshold the model can be deemed not-suitable. As illustrated in FIG. 9, in some implementations, when two vehicles 105, 110 encounter one another within an environment, the two vehicles (e.g., 105, 110) identify the other through the respective CAVids broadcast using beacon exchange. A vehicle (e.g., 105) may determine, from the CAVid (e.g., at 910), whether the other vehicle (e.g., 110) is a known vehicle (or its behavioral model is a known model), such that the vehicle 105 can identify and access the corresponding behavioral model (e.g., in a local cache or stored in a trusted (e.g., cloud- or fog-based) database (e.g., 915)). Accordingly, in some implementations, a lookup may be performed, upon encountering another vehicle, to determine whether necessary behavioral models are in the database 915 corresponding to an advertised CAVid included in the beacon signal. When it is determined that the vehicle 105 does not possess the behavioral model for the identified vehicle 110, the vehicles may begin a model exchange by establishing a session through exchange of tokens (at 920). In one example, each token (e.g., 925) may include the CAVid, public key, and a secret value, as well as a session ID. Each vehicle (e.g., 105, 110) may receive the token of the other and perform a verification 930 of the token to make sure the token is valid. Upon verification of the token signature an acknowledgement may be shared with the other vehicle, indicating that the vehicle trusts the other and would like to progress with the model exchange. In some implementations, model exchange may involve communication of a behavioral model (e.g., 935) divided and communicated over multiple packets until the model exchange 940 is completed (e.g., which may be indicated by an acknowledgement) in the last package. The session ID of the session may be used, when necessary, to enable data to be recovered should there be a loss of connectivity between the two vehicles. V2V or V2X communications may be utilized in the communications between the two vehicles. In some instances, the communication channel may be a low latency, high-throughput, such as a 5G wireless channel.

Upon receiving another vehicle's behavioral model, the vehicle may conduct a model verification 945 for the model. Model verification 945 may include checking the model for standards conformity and compatibility with the autonomous driving stack or machine learning engine of the receiving vehicle. In some instances, past inputs and recorded outputs of the receiving vehicle's behavioral model may be cached at the receiving vehicle and the receiving vehicle may verify the validity of the received behavioral model by applying these cached inputs to the received behavioral model and comparing the output with the cached output (e.g., validating the received behavioral model if the output is comparable). In other implementations, verification of the behavioral model 945 may be performed by observing the performance of the corresponding vehicle (e.g., 110) and determining whether the observed performance corresponds to an expected performance determined through the behavioral model (e.g., by providing inputs corresponding to the present environment to the model and identifying if the output conforms with the observed behavior of the vehicle). In the example of FIG. 9, upon verification of a received behavioral model an acknowledgement (e.g., 950) may be sent to the source vehicle and the session can be closed. From there on vehicles can continue to exchange beacons (at 955) to identify their continued proximity as well as share other information (e.g., sensor data, outputs of their models, etc.).

While the example of FIG. 9 illustrates an instance where an unfamiliar vehicle is encountered and new behavioral models are shared, if two vehicles (e.g., 105, 110) have already shared behavioral models with each other in the past, the look-up in a cache or behavioral model database 915 will yield a positive result and an acknowledgement message of model verification can be shared between the two vehicles. In some cases, behavioral models may be updated or expire, in which case vehicles may identify the update to another known vehicle (or vehicle model) and a model update exchange may be performed (e.g., in manner similar to a full model exchange in a new session), among other examples. In some cases, a vehicle (e.g., 105) may unilaterally determine that a previously-stored behavioral model for a particular other vehicle (e.g., 110) is out-of-date, incorrect, or defective based on detecting (in a subsequent encounter with the particular vehicle) that observed behavior of the particular vehicle does not conform with predicted behavior determined when applying the earlier-stored version of the behavioral model. Such a determination may cause the vehicle (e.g., 105) to request an updated version of the behavioral model (e.g., and trigger a model exchange similar to that illustrated in FIG. 9).

Through the exchange and collection of verified, accurate, and trusted behavioral models, a vehicle may utilize beacon exchange in the future to identify vehicles, which use a trusted, accurate behavioral model in navigating an environment and may thereby generate future predictions of the surrounding vehicle's behavior in an efficient way. In some instances, behavioral models and CAVids may be on a per-vehicle basis. In other examples, each instance of a particular autonomous vehicle model (e.g., make, model, and year) may be assumed to use the same behavioral model and thus a vehicle may use the verification of a single behavioral model associated with this car model in encounters with any instance of this car model, among other examples.

Behavioral models may be based on the machine learning models used to enable autonomous driving in the corresponding vehicle. In some cases, behavioral models may be instead based on rule engines or heuristics (and thus may be rule-based). In some cases, the behavioral models to be shared and exchanged with other vehicles may be different from the machine learning models actually used by the vehicle. For instance, as discussed above, behavioral models may be smaller, simpler “chunks” of an overall model, and may correspond to specific environments, scenarios, road segments, etc. As examples, scenario-specific behavioral models may include neural network models to show the probability of various actions of a corresponding vehicle in the context of the specific scenario (e.g., maneuvering an intersection, maneuvering a roundabout, handling takeover or pullover events, highway driving, driving in inclement weather, driving through elevation changes of various grades, lane changes, etc.). Accordingly, multiple behavioral models may be provided for a single vehicle and stored in memory of a particular vehicle using these models. Further, the use of these multiple models individually may enable faster and more efficient (and accurate) predictions by the particular vehicle compared to the use of a universal behavioral model modeling all potential behaviors of a particular vehicle, among other example implementations.

The exchange and collection of behavioral models may be extended, in some instances, to cover human-driven vehicles, including lower-level autonomous vehicles. In some instances, behavioral models for individual drivers, groups of drivers (drivers in a particular neighborhood or location, drivers of particular demographics, etc.), mixed models (dependent on whether the vehicle is operating in an autonomous mode or human driver mode), and other examples may be generated. For instance, a vehicle may include (as an OEM component or aftermarket component) a monitor to observe a human driver's performance and build a behavioral model for this driver or a group of drivers (e.g., by sharing the monitoring data with a cloud-based aggregator application). In other instances, roadside sensors and/or crowd-sourced sensor data may be utilized, which describes observed driving of individual human drivers or groups of drivers and a behavioral model may be built based on this information. Behavioral models for human drivers may be stored on an associated vehicle and shared with other vehicles in accordance with other exchanges of behavioral models, such as described in the examples above. In other instances, such as where the human driven car is not connected or does not support model exchanges, other systems may be utilized to share and promulgate behavioral models for human drivers, such as road-side units, peer-to-peer (e.g., V2V) distribution by other vehicles, among other examples.

As more road actors become self-driving, and city infrastructure becomes modernized, conflicts may develop between the various autonomous driving stacks and machine-learning-based behavioral models relied upon by these actors. Indeed, as different car and autonomous system providers compete with independent solutions, it may be desirous to facilitate coordination and consensus building between the various models utilized by these many vehicles and other actors. Government legislation and regulation and industry standardization may be developed in order to assist in facilitating safety and compatibility between various technologies. However, with multiple key players developing their own solutions, the question of improving overall safety on the road remains unanswered. Standards of safety are still in their adolescence, as there exists no clear way for policy makers and the public to validate the decisions made by these vehicles. Further, as autonomous vehicles improve their models and corresponding decision making, outdated models and solutions (e.g., included in vehicles during the infancy of autonomous driving) may pose a growing hazard on the road. This creates a problem with behavioral consensus, since older or malfunctioning autonomous vehicle road actors may utilize conflicting models and may not enjoy the benefits of improved functionality provided through newer, evolved models.

Given the young and developing autonomous vehicle industry and the infancy of 5G networks and infrastructure, V2X communications and solutions are similarly limited. For instance, current V2X solutions offered today are predominantly in the localization and mapping domain. As autonomous vehicles and supporting infrastructure become more mainstream, the opportunity to expand and develop new solutions that leverage cooperation and intercommunication between connected vehicles and their environment emerges. For instance, in some implementations, a consensus and supporting protocols may be implemented, such as to enable the building of consensus behavioral models, which may be shared and utilized to propagate “best” models to vehicles, such that machine learning models of vehicles continually evolve to adopt the safest, most efficient, and passenger friendly innovations and “knowledge.” For instance, high speed wireless networking technology (e.g., 5G networks) and improved street infrastructure may be utilized to aid such consensus systems.

In one example, a Byzantine Consensus algorithm may be defined and implemented among actors in an autonomous driving system to implement fault tolerant consensus. Such a consensus may be dependent on the majority of contributors (e.g., contributors of shared behavioral model) contributing accurate information to the consensus system. Accuracy of contributions may be problematic in an autonomous vehicle context since the total amount of road actors in a given intersection at a given time may potentially be low thus increasing the probability of a bad consensus (e.g., through model sharing between the few actors). In some implementations, compute nodes may be provided to coincide with segments of roadways and road-interchanges (e.g., intersections, roundabouts, etc.), such as in roadside units (e.g., 140), mounted on street lamps, nearby buildings, traffic signals, etc., among other example locations. In some cases, the compute nodes may be integrated with or connected to supplemental sensor devices, which may be capable of observing traffic corresponding to the road segment. Such road-side computing devices (referred to herein collectively as “road-side units” or “RSUs” for convenience) may be designated and configured to act as central point for collection of model contributions, distribution of models between vehicles, validation of the models across the incoming connected autonomous vehicles, and determining consensus from these models (and, where enabled, based on observations of the sensors of the RSU) at the corresponding road segment locations.

In some implementations, a road-side unit implementing a consensus node for a particular section of roadway may accept model-based behavior information from each vehicle's unique sensory and perception stack, and over time refine what the ideal behavioral model is for that road segment. In doing so, this central point can validate the accuracy of models in comparison to peers on the road at that time as well as peers who have previously negotiated that same section of road in the past. In this manner, the consensus node may consider models in a historical manner. This central node can then serve as a leader in a byzantine consensus communication for standardizing road safety amongst varying actors despite the varying amounts and distribution of accurate consensus contributors.

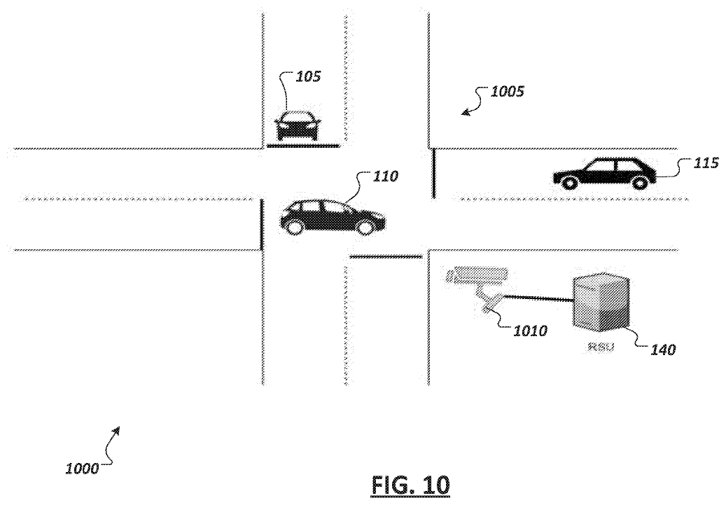

Turning to FIG. 10, a simplified block diagram 1000 is shown illustrating an example road intersection 1005. One or more road-side units (e.g., 140) may be provided to function as a consensus node for the road segment 1005. In this example, the consensus node device (e.g., 140) may include one or more sensors, such as camera 1010. In some implementations, the consensus node can be implemented as two or more distinct, collocated computing devices, which communicate and interoperate as a single device when performing consensus services for the corresponding road segment 1005, among other example implementations. Trustworthiness of the road-side unit(s) (e.g., 140) implementing the consensus node may be foundational, and the RSU 140 may be affiliated with a trusted actor, such as a government agency. In some implementations, an RSU 140 may be configured with hardware, firmware, and/or software to perform attestation transactions to attest its identity and trustworthiness to other computing systems associated with other nearby road actors (e.g., vehicles 105, 110, 115, etc.), among other example features. An example RSU may include compute and memory resources with hardware- and/or software-based logic to communicate wirelessly with other road actor systems, observe and capture behavioral model exchanges between vehicles (such as discussed above in the example of FIGS. 8 and 9), receive behavioral models directly from other road actors, determine (from the model inputs it receives) a consensus model (e.g., based on a byzantine consensus scheme or algorithm), and distribute the consensus model to road actors (e.g., 105, 110, 115) for their use in updating (or replacing) their internal models to optimize the road actor's navigation of the corresponding road segment (e.g., 1005).

It should be appreciated that an RSU implementing a consensus node may do so without supplemental sensor devices. However, in some implementations, an RSE sensor system (e.g., 1010) may provide useful inputs, which may be utilized by the RSE in building a consensus behavioral model. For instance, an RSU may utilize one or more sensors (e.g., 1010) to observe non-autonomous-vehicle road actors (e.g., non-autonomous vehicles, electric scooters and other small motorized transportation, cyclists, pedestrians, animal life, etc.) in order to create localized models (e.g., for a road segment (e.g., 1005)) and include these observations in the consensus model. For instance, it may be assumed that non-autonomous vehicles may be incapable of communicating a behavioral model, and a sensor system of the RSU may build behavioral models for non-autonomous vehicle, human drivers, and other road actors based on observations of its sensors (e.g., 1010). For instance, a sensor system and logic of an example RSU (e.g., 140) may enable recognition of particular non-autonomous vehicles or even recognition of particular human drivers and corresponding behavioral models may be developed based on the presence (and the frequency of these actors' presence) within the road environment. Consensus models may be built for this road segment 1005 to incorporate knowledge of how best to path plan and make decisions when such non-autonomous actors are detected by an autonomous vehicle (e.g., 105) applying the consensus model. In still other examples, non-autonomous vehicles may nonetheless be equipped with sensors (e.g., OEM or after-market), which may record actions of the vehicle or its driver and the environment conditions corresponding to these recorded actions (e.g., to enable detection of driving reactions to these conditions) and communicate this information to road side units to assist in contributing data, which may be used and integrated within consensus models generated by each of these RSUs for their respective locales or road segments. OEM and after-market systems may also be provided to enable some autonomous driving features in non-autonomous vehicles and/or to provide driver assistance, and such systems may be equipped with functionality to communicate with RSUs and obtain consensus models for use in augmenting the services and information provided through such driver assistance systems, among other example implementations.

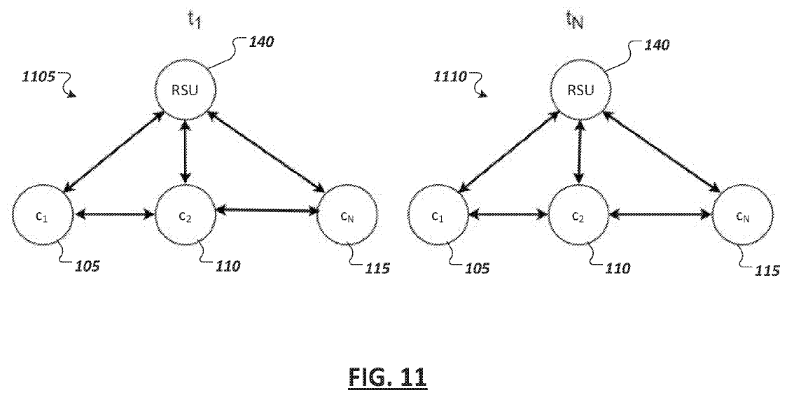

Consensus contributors can be either autonomous vehicle or non-autonomous vehicle road actors. For instance, when vehicles (e.g., 105, 110, 115) are within range of each other and a road-side unit 140 governing the road segment (e.g., 1005), the vehicles may intercommunicate to each share their respective behavioral models and participate in a consensus negotiation. The RSU 140 may intervene within the negotiation to identify outdated, maliciously incorrect, or faulty models based on the consensus model developed by the RSU 140 over time. The consensus model is analogous to a statement of work, that guards against a minority of actors in a negotiation from dramatically worsening the quality of and overriding the cumulative knowledge embodied in the consensus model. Turning to FIG. 11, diagrams 1105, 1110 are shown illustrating that over time (t) localized behavioral model consensus may be collected and determined for a given road segment in light of a corresponding RSU's (e.g., 140) involvement in each consensus negotiation for the road segment. This historical consensus approach allows for improved road safety as autonomous vehicles of different makes and manufacturers, with varying autonomous driving systems can benefit from each other both in the present and in the past. Such a consensus-based system applies a holistic and time-tested approach to road safety through behavioral model sharing. Each road actor (e.g., 105, 110, 115), whether autonomous vehicle or non-autonomous vehicle is expected to observe the environment and make a decision as to how they should act independently. All consensus contributors (e.g., 105, 110, 115, 140, etc.) will also make an attempt at predicting the actions of other road actors through their respective sensory systems. Autonomous vehicles (e.g., 105, 110, 115) will then share their behavioral models with the RSU (e.g., 140), and each other as seen in the illustrations in diagrams 1105, 1110.

Through collaborative sharing of models within a consensus building scheme (e.g., based on a byzantine consensus model), autonomous vehicles may then utilize their own perception of the environment through the consensus behavioral model(s) and determine the other road actors' exact actions which allows them, as well as their peers, to validate whether their initial predictions of each other were accurate. This information and validation is also visible to the RSU, which is also involved in this consensus negotiation. With knowledge of riskier behavioral models which would result in collisions, voting can begin where distribution of a behavioral model that does not result in collision or misunderstanding of the environment including other road actors is provided. Hashes or seeds based off the selected model can be used to simplify comparison and avoid the re-running of local behavioral model predictions during the process. In some implementations, as the consensus node, RSU contribution to the consensus may be weighted based off of previous successful consensus negotiations to which it was involved in, and this should be taken into account by the other road actors. Validation of consensus can then be checked based on the actions of road actors.

It is anticipated that autonomous vehicles will continue to share the road with human-driven vehicles (HVs) that may exhibit irregular behavior that does not conform to the documented driving practices. Human drivers may exhibit aggressive behaviors (e.g., tailgating or weaving through traffic) or timid behaviors (e.g., driving at speeds significantly slower than the posted speed limit, which can also cause accidents). Irregular human driving patterns might also arise from driving conventions in specific regions in some instances. For example, a maneuver sometimes referred to as the “Pittsburgh Left” observed in Western Pennsylvania violates the standard rules of precedence for vehicles at an intersection by allowing the first left-turning vehicle to take precedence over vehicles going straight through an intersection (e.g., after a stoplight switches to green for both directions). As another example, drivers in certain regions of the country might also drive more or less aggressively than drivers in other regions of the country.

The autonomous driving stack implemented through the in-vehicle computing system of an example autonomous vehicle may be enhanced to learn and detect irregular behavior exhibited by HVs, and respond safely to them. In some aspects, for example, an autonomous vehicle system can observe, and track the frequency of, irregular behaviors (e.g., those shown in the Table below) and learn to predict that an individual HV is likely to exhibit irregular behavior in the near future, or that a certain type of irregular behavior is more likely to occur in a given region of the country.

| Frequency of Irregular | |
|---|---|
| Behavior | Examples |
| One-off incident by | Human driver attempts to lane change when |
| single driver | autonomous vehicle is in blind spot. |
| Repeated incidents by | Drunk drivers, fatigued drivers, or road rage |
| same driver | drivers who repeatedly exhibit unsafe driving |
| | behavior. |
| Common location- | Drivers in certain city tend to drive aggressively |
| specific behavior | and tend to cut-in when there are small lateral |
| | gaps between vehicles. |

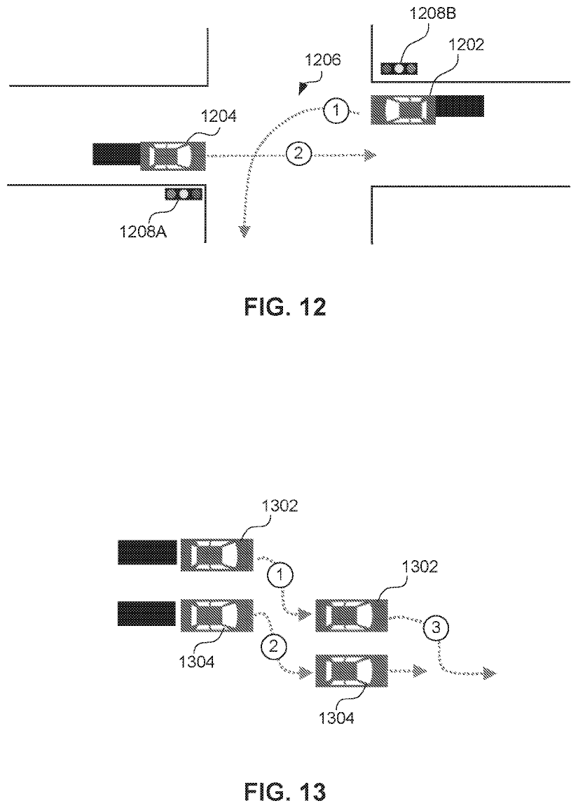

In some embodiments, irregular driving patterns can be modeled as a sequence of driving actions that deviates from the normal behavior expected by the autonomous vehicle. FIGS. 12 and 13 illustrate two examples of irregular driving patterns, and how an autonomous vehicle may learn to adapt its behavior in response to observing such behaviors.

FIG. 12 illustrates an example “Pittsburgh Left” scenario as described above. In the example shown, an HV 1202 and autonomous vehicle 1204 are both stopped at intersection 1206, when the lights 1208 turn green. In a typical scenario, the autonomous vehicle would have precedence to continue through the intersection before the HV. However, in the Pittsburgh Left scenario shown, the HV turns left first instead of yielding to the autonomous vehicle which is going straight through the intersection. Through observing this behavior multiple times in a geographical region, the autonomous vehicle may learn to anticipate behavior such as this (where the first left turning vehicle assumes precedence) so it enters intersection more cautiously when it is in the geographical region.

FIG. 13 illustrates an example “road rage” scenario by an HV. In the example shown, the driver of the HV 1302 may be angry at the autonomous vehicle and may accordingly cut in front of the autonomous vehicle 1304 and may slow down abruptly. In response, the autonomous vehicle may slow down and change lanes to avoid the HV. The HV may then accelerate further and cut in front of the autonomous vehicle again, and may then abruptly slow down again. Because the HV has seen this maneuver from the HV multiple times, the autonomous vehicle may detect that the HV is an angry driver that is repeatedly cutting in-front of the autonomous vehicle. The autonomous vehicle can accordingly take a corrective action, such as, for example, handing off control back to its human driver the next time it encounters the particular HV.

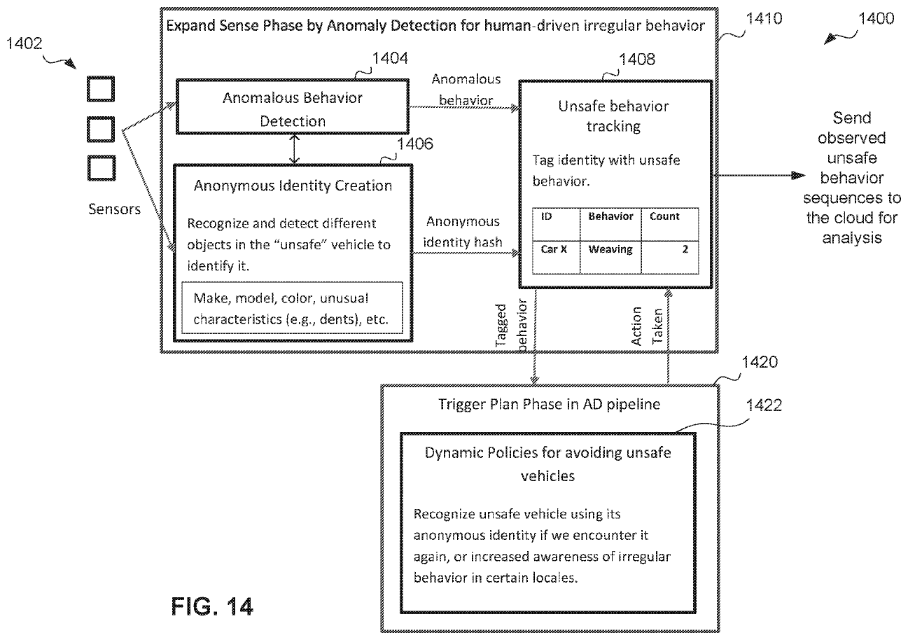

FIG. 14 is a simplified block diagram showing an irregular/anomalous behavior tracking model 1400 for an autonomous vehicle in accordance with at least one embodiment. In the example shown, the sensing phase 1410 of the autonomous vehicle software stack receives sensor data from the sensors 1402 of the autonomous vehicle and uses the sensor data to detect/identify anomalous behavior observed by a particular HV (e.g., in an anomalous behavior detection software module 1404 as shown). In response to the anomalous behavior detection, or parallel with the detection, an anonymous identity for the HV is created (e.g., in an anonymous identity creation software module 1406 as shown). The observed behavior and the associated identity of the HV are then used to track a frequency of the observed behaviors by the HV and other HVs around the autonomous vehicle (e.g., in an unsafe behavior tracking software module 1408 as shown). In some cases, the tracked behavior may be used by a planning phase 1420 of the autonomous vehicle software stack to trigger dynamic behavior policies for the autonomous vehicle in response to seeing patterns of anomalous behaviors in the HVs. Aspects of the model 1400 are described further below.

In some embodiments, the autonomous vehicle may detect anomalous or irregular behavior by a given HV by tracking sequences of driving actions that, for example:
Violate the autonomous vehicle's safety model (e.g., drivers who are not maintaining a safe lateral distance according to a Responsibility-Sensitive Safety rule set).
Drivers whose driving behavior differs significantly from other drivers in the vicinity (e.g., drivers who are driving significantly slower or faster than other drivers, or drivers weaving through traffic). Studies have shown that drivers whose speed differs significantly from the surrounding traffic can increase the likelihood of accidents.
Drivers whose actions cause other drivers to react adversely to them (e.g., a driver who is avoided by multiple drivers, or a driver who is honked at by multiple drivers).

In addition to tracking sequences of driving actions, in some embodiments, the autonomous vehicle can also use audio and visual contextual information to categorize types of drivers (e.g., a distracted driver vs. a safe driver observing safe distances from other cars), driver attributes (e.g., paying attention to the road vs. looking down at a phone), or vehicle attributes (e.g., missing mirrors, broken windshields, or other characteristics that would may the vehicle un-roadworthy) that may be more likely to result in unsafe behavior in the near future. For example, video from external-facing cameras on the autonomous vehicle may be used to train computer vision models to detect vehicle or driver attributes that increase the risk of accidents, such as a human driver on their cell phone, or limited visibility due to snow-covered windows. The computer vision models may be augmented, in certain instances, with acoustic models that may recognize aggressive behavior such as aggressive honking, yelling, or unsafe situations such as screeching brakes. The Table below lists certain examples of audio and visual contextual information that may indicate an increased likelihood of future unsafe behavior.

| Type of unsafe | |
|---|---|
| behavior | Audio-visual Context |
| Angry driver | Aggressive flashing headlights |
| | Raised fists |
| | Aggressive honking |
| | Driver yelling |
| | Angry driver (e.g., angry facial expression, |
| | raised fists) |
| Distracted driver | Driver on cell-phone |
| | Driver repeatedly taking their eyes of road |
| | Driver taking hands off wheel |
| Obscured vision | Vehicle with limited visibility due to |
| | snow-covered windows |
| | Missing side-view or rear-view mirrors |
| | Non-functional headlights |
| Braking issues | Excessive brake noises |
| | Balding tires |

In some embodiments, the autonomous vehicle may track the frequency of observed irregular behaviors by particular vehicles (e.g., HVs) to determine whether it is a single driver exhibiting the same behavior in a given window of time (which may indicate one unsafe driver), or whether there are multiple drivers in a given locale exhibiting the same behavior (which may indicate a social norm for the locale).

To preserve the privacy of the human drivers, the autonomous vehicle may create an anonymous identity for the unsafe HV and may tag this identity with the unsafe behavior to track recurrence by the HV or other HVs. The anonymous identity may be created without relying on license plate recognition, which might not always be available or reliable. The anonymous signature may be created, in some embodiments, by extracting representative features from the deep learning model used for recognizing cars. For example, certain layers of the deep learning network of the autonomous vehicle may capture features about the car such as its shape and color. These features may also be augmented with additional attributes that we recognize about the car such as its make, model, or unusual features like dents, scrapes, broken windshield, missing side view mirrors, etc. A cryptographic hash may then be applied on the combined features and the hash may be used as an identifier for the HV during the current trip of the autonomous vehicle. In some cases, this signature may not be completely unique to the vehicle (e.g., if there are similar looking vehicles around the autonomous vehicle); however, it may be sufficient for the autonomous vehicle to identify the unsafe vehicle for the duration of a trip. License plate recognition may be used in certain cases, such as where the autonomous vehicle needs to alert authorities about a dangerous vehicle.

The autonomous vehicle can determine that the unsafe behavior is escalating, for example, by monitoring whether the duration between unsafe events decreases, or whether the severity of the unsafe action is increasing. This information can then be fed into the plan phase of the AD pipeline to trigger a dynamic policy such as avoiding the unsafe vehicle if the autonomous vehicle encounters it again or alerting authorities if the unsafe behavior is endangering other motorists on the road. The autonomous vehicle may also define a retention policy for tracking the unsafe behavior for a given vehicle. For example, a retention policy may call for an autonomous vehicle to only maintain information about an unsafe driver for the duration of the trip, for a set number of trips, for a set duration of time, etc.

In some embodiments, the autonomous vehicle may transmit data about the anomalous behavior that it detects to the cloud, on a per-vehicle basis. This data may be used to learn patterns of human-driven irregular behavior, and determine whether such behaviors are more likely to occur in a given context. For example, it may be learned that drivers in a given city are likely to cut into traffic when the lateral gap between vehicles is greater than a certain distance, that drivers at certain intersections are more prone to rolling stops, or that drivers on their cell-phones are more likely to depart from their lanes. The data transmitted from the autonomous vehicle to the cloud may include, for example:
trajectories of the unsafe vehicle, the vehicles adjacent to it, and the autonomous vehicle
driver and vehicle attributes for unsafe vehicle, e.g., driver on cellphone, obscured vision due to snow-covered windows
geographic location, weather conditions, traffic sign and traffic light data
type of unsafe action—can be tagged as either a known action such as abrupt stop that violated the autonomous vehicle's safety model, or an unknown anomalous behavior flagged by the system

In some embodiments, learning the context-based patterns of human-driven irregular behavior may involve clustering the temporal sequences of driving actions associated with unsafe behavior using techniques such as Longest Common Subsequences (LCS). Clustering may reduce the dimensionality of vehicle trajectory data and may identify a representative sequence for driving actions for each unsafe behavior. The Table below provides examples of certain temporal sequences that may be clustered.

| ID | Sequence |
|---|---|
| 1 | Traffic light turns red -> Autonomous Vehicle (AV) arrives at |
| | intersection -> Human-driven Vehicle (HV) arrives at intersection |
| | -> Light turns green -> HV turns left instead of yielding to AV |
| | which is going straight. |
| 2 | Traffic light turns red -> HV arrives at intersection -> AV arrives |
| | at intersection -> Light turns green -> HV turns left instead of |
| | yielding to AV which is going straight. |

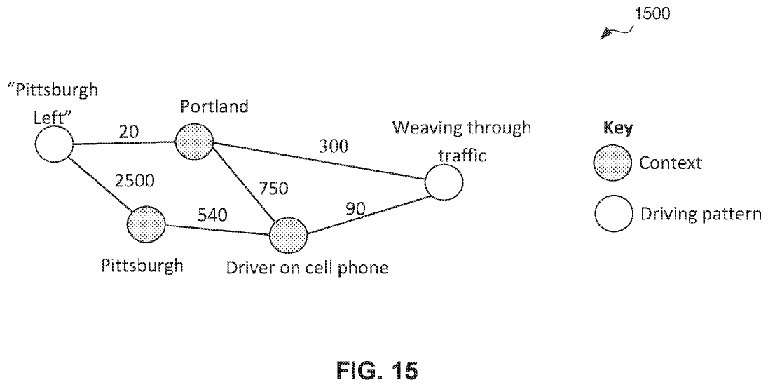

Further, in some embodiments, driving patterns that are more likely to occur in a given context may be learned. For example, based on the tracked sequences, it may be learned whether a certain irregular driving pattern is more common in a given city when it snows, or whether certain driving actions are more likely to occur with angry drivers. This information may be used to model the conditional probability distributions of driving patterns for a given context. These context-based models allow the autonomous vehicle to anticipate the likely sequence of actions that an unsafe vehicle may take in a given scenario. For example, a contextual graph that tracks how often a driving pattern occurs in a given context is shown in FIG. 15. As shown, the contextual graph may track the identified sequences (“driving patterns” nodes in FIG. 15) along with context information (“context” nodes in FIG. 15) and the associated frequency of observation of the sequences and context (the weights of the edges in FIG. 15) to identify whether there are particular behavior patterns that occur more often in certain contexts than others (e.g., patterns that occur overwhelmingly in certain geographical contexts, time contexts, etc.). The identified patterns can also be used to train reinforcement learning models which identify the actions that the autonomous vehicle should take to avoid the unsafe behavior. For example, the learned contextual behavior patterns may be used to modify a behavioral model of an autonomous vehicle, such as, for example, dynamically when the autonomous vehicle enters or observes the particular context associated with the contextual behavior pattern.

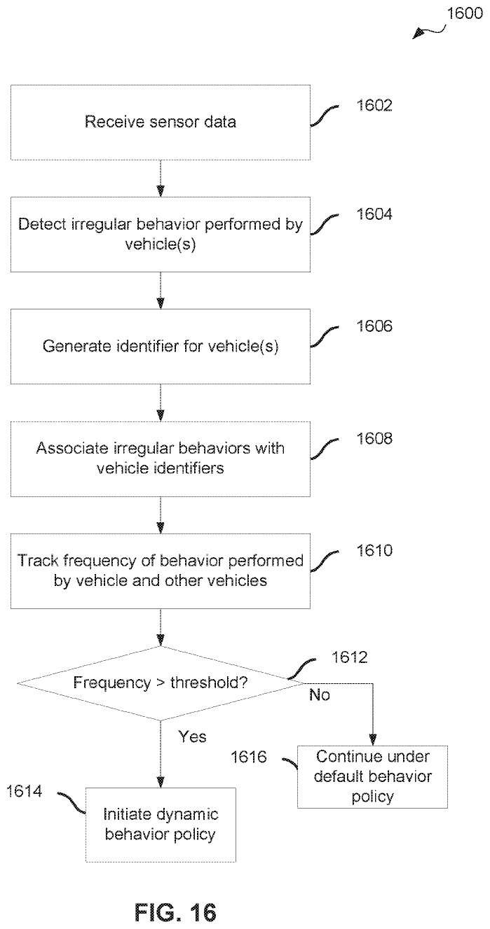

FIG. 16 is a flow diagram of an example process 1600 of tracking irregular behaviors observed by vehicles in accordance with at least one embodiment. Operations in the example process 1600 may be performed by one or more components of an autonomous vehicle or a cloud-based learning module. The example process 1600 may include additional or different operations, and the operations may be performed in the order shown or in another order. In some cases, one or more of the operations shown in FIG. 1600 are implemented as processes that include multiple operations, sub-processes, or other types of routines. In some cases, operations can be combined, performed in another order, performed in parallel, iterated, or otherwise repeated or performed another manner.

At 1602, sensor data is received from a plurality of sensors coupled to the autonomous vehicle, including cameras, LIDAR, or other sensors used by the autonomous vehicle to identify vehicles and surroundings.

At 1604, irregular or anomalous behaviors are detected as being performed by one or more vehicles. In some cases, detection may be done by comparing an observed behavior performed by the particular vehicle with a safety model of the autonomous vehicle; and determining, based on the comparison, that the observed behavior violates the safety model of the autonomous vehicle. In some cases, detection may be done by comparing an observed behavior performed by the particular vehicle with observed behaviors performed by other vehicles; and determining, based on the comparison, that the observed behavior performed by the particular vehicle deviates from the observed behaviors performed by the other vehicles. In some cases, detection may be done by comparing an observed behavior performed by the particular vehicle with observed behaviors performed by other vehicles; and determining, based on the comparison, that the observed behavior performed by the particular vehicle deviates from the observed behaviors performed by the other vehicles. Detection may be done in another manner. Detection may be based on audio and visual contextual information in the sensor data.

At 1606, an identifier is generated for each vehicle for which an irregular behavior was observed. The identifier may be generated by obtaining values for respective features of the particular vehicle; and applying a cryptographic has on a combination of the values to obtain the identifier. The values may be obtained by extracting representative features from a deep learning model used by the autonomous vehicle to recognize other vehicles. The identifier may be generated in another manner.

At 1608, the irregular behaviors detected at 1604 are associated with the identifiers generated at 1606 for the vehicles that performed the respective irregular behaviors.

At 1610, the frequency of occurrence of the irregular behaviors is tracked for the identified vehicles.

At 1612, it is determined whether an observed irregular behavior has been observed as being performed by a particular vehicle more than a threshold number of times. If so, at 1614, a dynamic behavior policy is initiated (e.g., to further avoid the vehicle). If not, the autonomous vehicle continues operating under the default behavior policy.

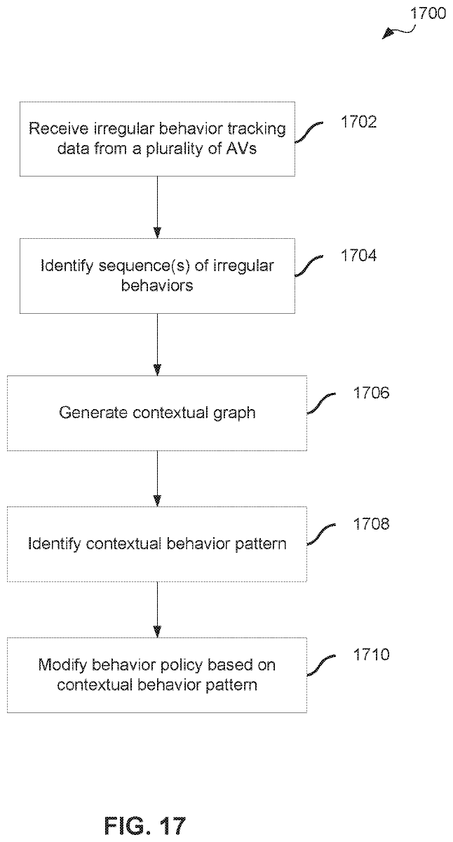

FIG. 17 is a flow diagram of an example process 1700 of identifying contextual behavior patterns in accordance with at least one embodiment. Operations in the example process 1700 may be performed by a learning module of an autonomous vehicle or a cloud-based learning module. The example process 1700 may include additional or different operations, and the operations may be performed in the order shown or in another order. In some cases, one or more of the operations shown in FIG. 17 are implemented as processes that include multiple operations, sub-processes, or other types of routines. In some cases, operations can be combined, performed in another order, performed in parallel, iterated, or otherwise repeated or performed another manner.

At 1702, irregular behavior tracking data is received from a plurality of autonomous vehicles. The irregular behavior tracking data may include entries that include a vehicle identifier, an associated irregular behavior observed as being performed by a vehicle associated with the vehicle identifier, and contextual data indicating a context in which the irregular behavior was detected by the autonomous vehicles. In some cases, the contextual data may include one or more of trajectory information for the vehicles performing the irregular behaviors, vehicle attributes for the vehicles performing the irregular behaviors, driver attributes for the vehicles performing the irregular behaviors, a geographic location of the vehicles performing the irregular behaviors, weather conditions around the vehicles performing the irregular behaviors, and traffic information indicating traffic conditions around the vehicles performing the irregular behaviors.

At 1704, one or more sequences of irregular behaviors are identified. This may be done by clustering the behaviors, such as by using Longest Common Subsequences (LCS) techniques.

At 1706, a contextual graph is generated based on the sequences identified at 1704 and the data received at 1702. The contextual graph may include a first set of nodes indicating identified sequences and a second set of nodes indicating contextual data, wherein edges of the contextual graph indicate a frequency of associations between the nodes.

At 1708, a contextual behavior pattern is identified using the contextual graph, and at 1710, a behavior policy for one or more autonomous vehicles is modified based on the identified contextual behavior pattern. For example, behavior policies may be modified for one or more autonomous vehicles based on detecting that the one or more autonomous vehicles are within a particular context associated with the identified contextual behavior pattern.

As discussed herein, principles and features of modern computer vision (CV) and artificial intelligence (AI) may be utilized in in-vehicle computing systems to implement example autonomous driving stacks used for highly automated and autonomous vehicles. However, CV and AI models and logic may sometimes be prone to misclassifications and manipulation. A typical Intrusion Detection System (IDS) is slow and complex and can generate a significant amount of noise and false positives. A single bit flip in a deep neural network (DNN) algorithm can cause misclassification of an image entirely. Accordingly, improved autonomous driving systems may be implemented to more accurately identify faults and attacks on highly automated and autonomous vehicles.

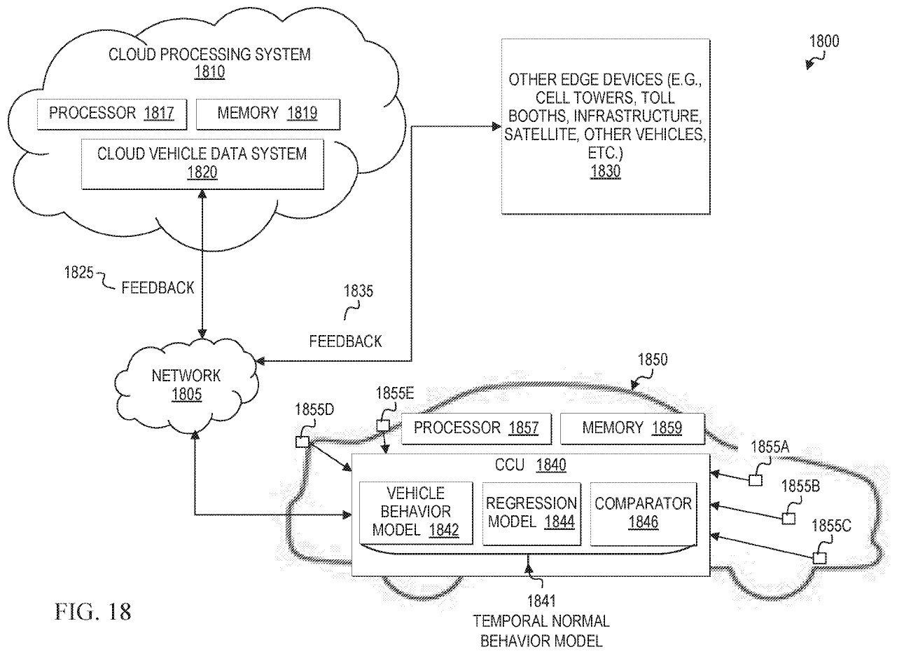

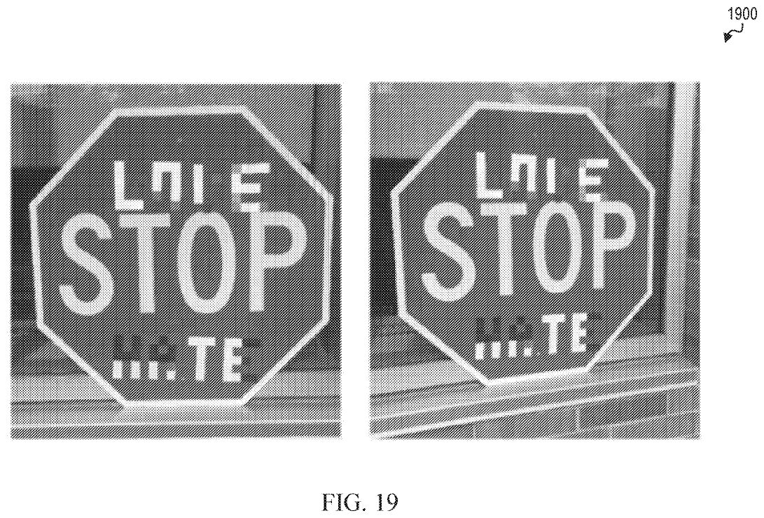

The following disclosure provides various possible embodiments, or examples, for implementing a fault and intrusion detection system 1800 for highly automated and autonomous vehicles as shown in FIG. 18. In one or more embodiments, vehicle motion prediction events and control commands, which are both a higher level of abstraction, are monitored. Based on the current state of vehicle motion parameters and road parameters, a vehicle remains within a certain motion envelope. A temporal normal behavior model 1841 is constructed to maintain adherence to the motion envelope. In at least one embodiment, at least two algorithms are used to build the temporal normal behavior model. The algorithms include a vehicle behavior model 1842 (e.g., based on a Hidden Markov Model (HMM)) for learning normal vehicle behavior and a regression model 1844 to find the deviation from the vehicle behavior model. In particular, the regression model is used to determine whether the vehicle behavior model correctly detects a fault, where the fault could be a vehicle system error or a malicious attack on the vehicle system.

For purposes of illustrating the several embodiments of a fault and intrusion detection system for highly automated and autonomous vehicles, it is important to first understand possible activities related to highly automated and autonomous vehicles. Accordingly, the following foundational information may be viewed as a basis from which the present disclosure may be properly explained.

Modern computer vision (CV) and artificial intelligence (AI) used for autonomous vehicles is prone to misclassifications and manipulation. For example, an attacker can generate stickers that can trick a vehicle into believing a sign really means something else. FIG. 19 illustrates such a manipulation, as seen in the “love/hate” graphics 1900 in which “LOVE” is printed above “STOP” on a stop sign, and “HATE” is printed below “STOP” on the stop sign. Although the graffiti-marked sign is obvious to English-speaking drivers as being a stop sign, this graffiti can make at least some computer vision algorithms believe the stop sign is actually a speed limit or yield notice. In addition, a single bit-flip error in a deep neural network (DNN) algorithm that classifies images can cause misclassification of an image. For example, instead of a huge truck, just a single bit-flip could cause the classifier to see a small animal or a bird.

Current (rule-based) intrusion detection systems (IDS) generate too much noise and too many false positives due to the non-deterministic nature of automotive networks, rendering them inadequate to cover the full range of abnormal behavior. Error correction code (ECC) algorithms have limitations and are generally not helpful in artificial intelligence. Generative adversarial networks (GANs) have value but depend heavily on the selection of adversarial data in a training set. Current machine learning-based intrusion detection systems are not adequate for use in automotive systems due to high complexity and the many internal networks and external connections that are monitored.

Fault and intrusion detection system 1800, as shown in FIG. 18, resolves many of the aforementioned issues (and more). System 1800 includes temporal normal behavior model 1841 with two algorithms: vehicle behavior model 1842 for learning normal behavior of a vehicle and regression model 1844 for predicting the likelihood of a behavior of the vehicle for time interval t. The vehicle behavior model can be a probabilistic model for normal vehicle behavior. The vehicle behavior model learns a baseline low-rank stationary model and then models the deviation of the temporal model from the stationary one. As the event set is generally static over time, the vehicle behavior model can be updated through occasional parameter re-weighting given previous and new, vetted training samples that have passed the fault and intrusion detection system and been retained. A regression algorithm compares the likelihood of a change of motion based on new received control events computed from the vehicle behavior model to the model (e.g., motion envelope) predicted by the regression algorithm.

Fault and intrusion detection system 1800 offers several potential advantages. For example, system 1800 monitors vehicle motion prediction events and control commands, which are a higher level of abstraction than those monitored by typical intrusion detection systems. Embodiments herein allow for detection at a higher level where malicious attacks and intent can be detected, rather than low level changes that may not be caught by a typical intrusion detection system. Accordingly, system 1800 enables detection of sophisticated and complex attacks and system failures.

Turning to FIG. 18, fault and intrusion detection system 1800 includes a cloud processing system 1810, a vehicle 1850, other edge devices 1830, and one or more networks (e.g., network 1805) that facilitate communication between vehicle 1850 and cloud processing system 1810 and between vehicle 1850 and other edge devices 1830. Cloud processing system 1810 includes a cloud vehicle data system 1820. Vehicle 1850 includes a CCU 1840 and numerous sensors, such as sensors 1855A-1855E. Elements of FIG. 18 also contain appropriate hardware components including, but not necessarily limited to processors (e.g., 1817, 1857) and memory (e.g., 1819, 1859), which may be realized in numerous different embodiments.

In vehicle 1850, CCU 1840 may receive near-continuous data feeds from sensors 1855A-1855E. Sensors may include any type of sensor described herein, including steering, throttle, and brake sensors. Numerous other types of sensors (e.g., image capturing devices, tire pressure sensor, road condition sensor, etc.) may also provide data to CCU 1840. CCU 1840 includes temporal normal behavior model 1841, which comprises vehicle behavior model 1842, regression model 1844, and a comparator 1846.

Vehicle behavior model 1842 may train on raw data of sensors, such as a steering sensor data, throttle sensor data, and brake sensor data, to learn vehicle behavior at a low-level. Events occurring in the vehicle are generally static over time, so the vehicle behavior model can be updated through occasional parameter re-weighting given previous and new, vetted training samples that have passed the fault and intrusion detection system and that have been retained.

In at least one example, vehicle behavior model 1842 is a probabilistic model. A probabilistic model is a statistical model that is used to define relationships between variables. In at least some embodiments, these variables include steering sensor data, throttle sensor data, and brake sensor data. In a probabilistic model, there can be error in the prediction of one variable from the other variables. Other factors can account for the variability in the data, and the probabilistic model includes one or more probability distributions to account for these other factors. In at least one embodiment, the probabilistic model may be a Hidden Markov Model (HMM). In HMM, the system being modeled is assumed to be a Markov process with unobserved (e.g., hidden) states.

In at least one embodiment, the vehicle behavior model is in the pipeline to the physical vehicle actuation. Actuation events (also referred to herein as ‘control events’) may be marked as actuation events by a previous software layer. Vector structures may be used by vehicle behavior model 1842 for different types of input data (e.g., vector for weather, vector for speed, vector for direction, etc.). For each parameter in a vector structure, vehicle behavior model 1842 assigns a probability. Vehicle behavior model 1842 can run continuously on the data going to the vehicle's actuators. Accordingly, every command (e.g., to change the motion of the vehicle) can go through the vehicle behavior model and a behavioral state of what the vehicle is doing can be maintained.

Typically, control events are initiated by driver commands (e.g., turning a steering wheel, applying the brakes, applying the throttle) or from sensors of an autonomous car that indicate the next action of the vehicle. Control events may also come from a feedback loop from the sensors and actuators themselves. Generally, a control event is indicative of a change in motion by the vehicle. Vehicle behavior model 1842 can determine whether the change in motion is potentially anomalous or is an expected behavior. In particular, an output of vehicle behavior model can be a classification of the change in motion. In one example, a classification can indicate a likelihood that the change in motion is a fault (e.g., malicious attack or failure in the vehicle computer system).

Regression model 1844 predicts the likelihood of a change in motion of the vehicle, which is indicated by a control event, occurring at a given time interval t. A regression algorithm is a statistical method for examining the relationship between two or more variables. Generally, regression algorithms examine the influence of one or more independent variables on a dependent variable.

Inputs for regression model 1844 can include higher level events such as inputs from motion sensors other than the motion sensor associated with the control event. For example, when a control even is associated with a braking sensor, input for the regression model may also include input from the throttle sensor and the steering sensor. Input may be received from other relevant vehicle sensors such as, for example, gyroscopes indicating the inertia of the vehicle. Regression model 1844 may also receive inputs from other models in the vehicle such as an image classifier, which may classify an image captured by an image capturing device (e.g., camera) associated with the vehicle. In addition, regression model 1944 may include inputs from remote sources including, but not necessarily limited to, other edge devices such as cell towers, toll booths, infrastructure devices, satellite, other vehicles, radio station (e.g., for weather forecast, traffic conditions, etc.), etc. Inputs from other edge devices may include environmental data that provides additional information (e.g., environmental conditions, weather forecast, road conditions, time of day, location of vehicle, traffic conditions, etc.) that can be examined by the regression model to determine how the additional information influences the control event.

In at least one embodiment, regression model 1844 runs in the background and, based on examining the inputs from sensors, other models, remote sources such as other edge devices, etc., creates a memory of what the vehicle has been doing and predicts what the vehicle should do under normal (no-fault) conditions. A motion envelope can be created to apply limits to the vehicle behavior model. A motion envelope is a calculated prediction based on the inputs of the path of the vehicle and a destination of the vehicle during a given time interval t assuming that nothing goes wrong. Regression model 1844 can determine whether a control event indicates a change in motion for the vehicle that is outside a motion envelope. For example, if a control event is a hard braking event, the vehicle behavior model may determine that the braking event is outside a normal threshold for braking and indicates a high probability of fault in the vehicle system. The regression model, however, may examine input from a roadside infrastructure device indicating heavy traffic (e.g., due to an accident). Thus, regression model may determine that the hard braking event is likely to occur within a predicted motion envelope that is calculated based, at least in part, on the particular traffic conditions during time interval t.

Fault and intrusion detection system 1800 is agonistic to the type of the regression algorithm used. For example, an expectation maximization (EM) algorithm can be used, which is an iterative method to find the maximum likelihood of parameters in a statistical model, such as HMM, which depends on hidden variables. In at least one embodiment, the regression algorithm (e.g., linear or lasso) can be selected to be more or less tolerant of deviations depending on the desired motion envelope sizes. For example, one motion envelope may be constrained (or small) for vehicles to be used by civilians, whereas another motion envelope may be more relaxed for vehicles for military use.

Comparator 1846 can be used to apply limits to the vehicle behavior model 1842. The comparator can compare the output classification of vehicle behavior model 1842 and the output prediction of regression model 1844 and determine whether a change in motion indicated by a control event is a fault or an acceptable change in motion that can occur within a predicted motion envelope. The output classification of vehicle behavior model can be an indication of the likelihood that the change in motion indicated by the control event is a fault (e.g., malicious attack or failure in the vehicle computer system). The output prediction of the regression model 1844 can be a likelihood that the change in motion would occur in the given time interval t, based on input data from sensors, edge devices, other models in the vehicle, etc. The comparator can use the regression model to apply limits to the output classification of a control event by the vehicle behavior model.

In one example of the comparator function, if the vehicle behavior model indicates a braking event is potentially anomalous, but the regression model indicates that, for the particular environmental conditions received as input (e.g., high rate of speed from sensor, stoplight ahead from road maps, rain from weather forecast), the braking event that is expected is within an acceptable threshold (e.g., within a motion envelope). Because the braking event is within an acceptable threshold based on a motion envelope, the comparator can determine that the vehicle behavior model's assessment that the braking event is potentially anomalous can be overridden and a control signal may be sent to allow the braking action to continue. In another illustrative example, regression model 1844 knows that a vehicle has been doing 35 mph on a town street and expects a stop sign at a cross street because it has access to the map. The regression model also knows that the weather forecast is icy. In contrast, vehicle behavior model 1842 receives a control event (e.g., command to an actuator) to accelerate because its image classifier incorrectly determined that an upcoming stop sign means higher speed or because a hacker manipulated control data and sent the wrong command to the accelerator. In this scenario, although an output classification from the vehicle behavior model does not indicate that the control event is potentially anomalous, the comparator can generate an error or control signal based on the regression model output prediction that the control event is unlikely to happen given the motion envelope, for the given time interval t, which indicates that the vehicle should brake as it approaches the stop sign.

Any one of multiple suitable comparators may be used to implement the likelihood comparison feature of the temporal normal behavior model 1841. In at least one embodiment, the comparator may be selected based on the particular vehicle behavior model and regression model being used.

Comparator 1846 may be triggered to send feedback to the vehicle behavior model 1842 to modify its model. Feedback for the vehicle behavior model enables retraining. In one example, the system generates a memory of committed mistakes based on the feedback and is retrained to identify similar scenarios, for example, based on location and time. Other variables may also be used in the retraining.

Cloud vehicle data system 1820 may train and update regression models (e.g., 1844) for multiple vehicles. In one example, cloud vehicle data system 1820 may receive feedback 1825 from regression models (e.g., 1844) in operational vehicles (e.g., 1850). Feedback 1825 can be sent to cloud vehicle data system 1820 for aggregation and re-computation to update regression models in multiple vehicles to optimize behavior. In at least some examples, one or more edge devices 1830 may perform aggregation and possibly some training/update operations. In these examples, feedback 1835 may be received from regression models (e.g., 1844) to enable these aggregations, training, and/or update operations.

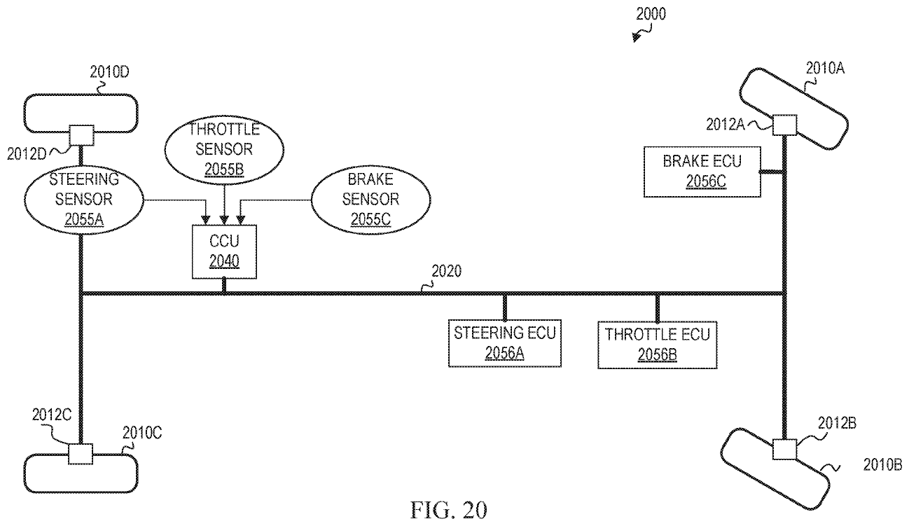

Turning to FIG. 20, a block diagram of a simplified centralized vehicle control architecture 2000 for a vehicle according to at least one embodiment is illustrated. In the vehicle control architecture, a bus 2020 (e.g., controller area network (CAN), FlexRay bus, etc.) connects tires 2010A, 2010B, 2010C, and 2010D and their respective actuators 2012A, 2012B, 2012C, and 2012D to various engine control units (ECUs) including a steering ECU 2056A, a throttle ECU 2056B, and a brake ECU 2056C. The bus also connects a connectivity control unit (CCU) 2040 to the ECUs. CCU 2040 is communicably connected to sensors such as a steering sensor 2055A, a throttle sensor 2055B, and a brake sensor 2055C. CCU 2040 can receive instructions from an autonomous ECU or driver, in addition to feedback from one or more of the steering, throttle, and brake sensors and/or actuators, sending commands to the appropriate ECUs. Vehicle behavior learning to produce vehicle behavior model often uses raw data that may be generated as discussed above. For example, wheels being currently angled a certain type of angle, brake pressure being a particular percentage, acceleration rate, etc.

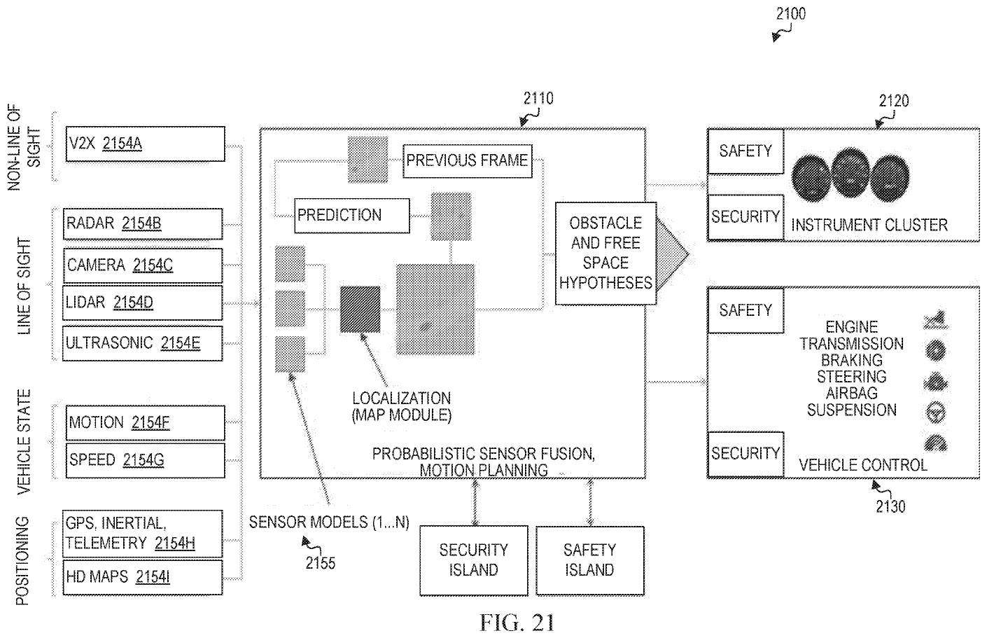

FIG. 21 is a simplified block diagram of an autonomous sensing and control pipeline 2100. Control of a vehicle goes to an engine control unit (ECU), which is responsible for actuation. FIG. 21 illustrates an autonomous processing pipeline from sensors through sensor fusion and planning ECU, and through vehicle control ECUs. FIG. 21 shows a variety of sensor inputs including non-line of sight, line of sight, vehicle state, and positioning. In particular, such inputs may be provided by V2X 2154A, a radar 2154B, a camera 2154C, a LIDAR 2154D, an ultrasonic device 2154E, motion of the vehicle 2154F, speed of the vehicle 2154G, GPS, inertial, and telemetry 2154H, and/or High definition (HD) maps 2154I. These inputs are fed into a central unit (e.g., central processing unit) via sensor models 2155. Sensor models 2155 provide input to perform probabilistic sensor fusion and motion planning 2110. Generally, sensor fusion involves evaluating all of the input data to understand the vehicle state, motion, and environment. A continuous loop may be used to predict the next operation of the vehicle, to display related information in an instrument cluster 2120 of the vehicle, and to send appropriate signals to vehicle control actuators 2130.

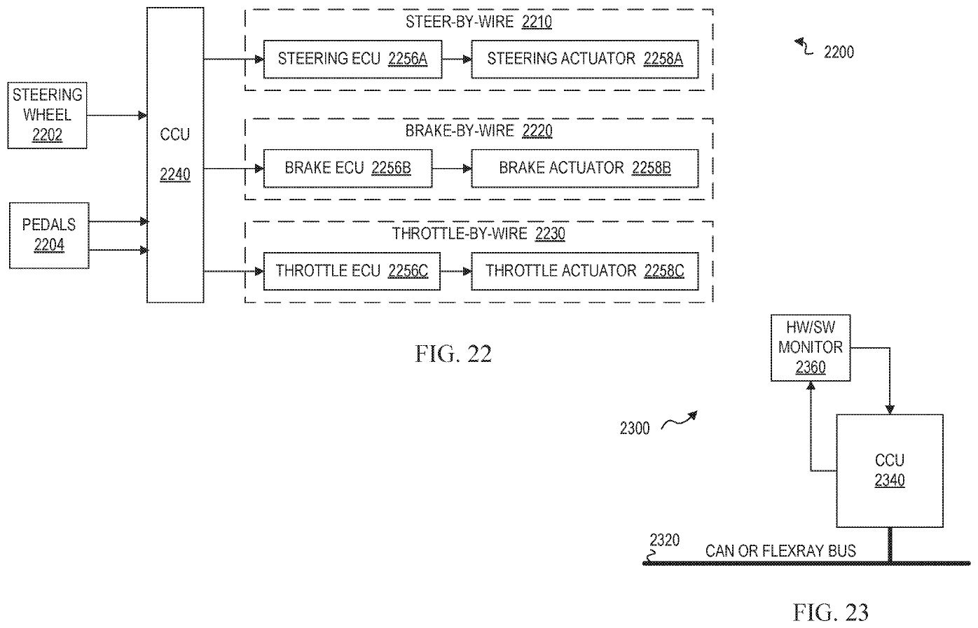

FIG. 22 is a simplified block diagram illustrating an example x-by-wire architecture 2200 of a highly automated or autonomous vehicle. A CCU 2240 may receive input (e.g., control signals) from a steering wheel 2202 and pedals 2204 of the vehicle. In an autonomous vehicle, however, the steering wheel and/or pedals may not be present. Instead, an autonomous driving (AD) ECU may replace these mechanisms and make all driving decisions.

Wired networks (e.g., CAN, FlexRay) connect CCU 2240 to a steering ECU 2256A and its steering actuator 2258A, to a brake ECU 2256B and its brake actuator 2258B, and to a throttle ECU 2256C and its throttle actuator 2258C. Wired networks are designated by steer-by-wire 2210, brake-by-wire 2220, and throttle-by-wire 2230. In an autonomous or highly autonomous vehicle, a CCU, such as CCU 2240, is a closed system with a secure boot, attestation, and software components required to be digitally signed. It may be possible, however, that an attacker could control inputs into sensors (e.g., images, radar spoofing, etc.), manipulate network traffic up to the CCU, and/or compromise other ECUs in a vehicle (other than the CCU). Networks between CCU 2240 and actuators 2258A-2258C cannot be compromised due to additional hardware checks on allowed traffic and connections. In particular, no ECU other than CCU 2240 is allowed on the wired networks. Enforcement can be cryptographic by binding these devices and/or by using other physical enforcement using traffic transceivers and receivers (Tx/Rx).

FIG. 23 is a simplified block diagram illustrating an example safety reset architecture 2300 of a highly automated or autonomous vehicle according to at least one embodiment. Architecture 2300 includes a CCU 2340 connected to a bus 2320 (e.g., CAN, FlexRay) and a hardware/software monitor 2360. HW/SW monitor 2360 monitors CCU 2340 for errors and resets the CCU if a change in motion as indicated by a control event is determined to be outside the motion envelope calculated by regression model. In at least one embodiment, HW/SW monitor 2360 may receive input from a comparator, which makes the determination of whether to send an error signal. In at least some embodiments, if an error signal is sent and a self-reset on the CCU does not effectively correct the vehicle behavior to be within a predicted motion envelope, then the CCU 2340 may safely stop the vehicle.

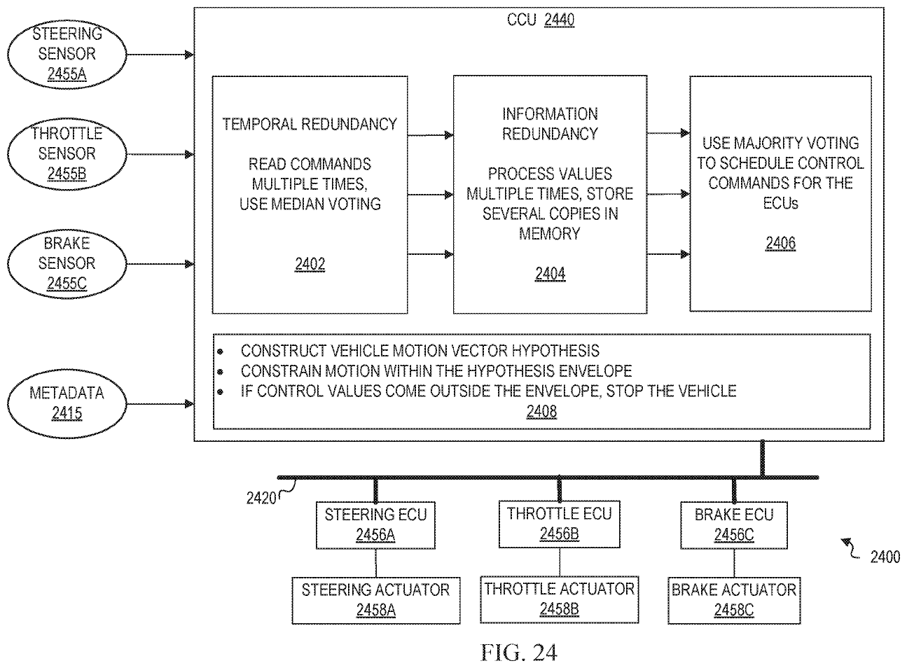

FIG. 24 is a simplified block diagram illustrating an example of a general safety architecture 2400 of a highly automated or autonomous vehicle according to at least one embodiment. Safety architecture 2400 includes a CCU 2440 connected to a steering ECU 2456A and its steering actuator 2458A, a throttle ECU 2456B and its throttle actuator 2458B, and a brake ECU 2456C and its brake actuator 2458C via a bus 2420 (e.g., CAN, FlexRay). CCU 2440 is also communicably connected to a steering sensor 2455A, a throttle sensor 2455B, and a brake sensor 2455C. CCU 2440 can also be communicably connected to other entities for receiving environment metadata 2415. Such other entities can include, but are not necessarily limited to, other sensors, edge devices, other vehicles, etc.

Several communications that involve safety may occur. First, throttle, steer, and brake commands and sensory feedback are received at the CCU from the actuators and/or sensors. In addition, environment metadata 2415 may be passed from an autonomous driver assistance system (ADAS) or an autonomous driver ECU (AD ECU). This metadata may include, for example, type of street and road, weather conditions, and traffic information. It can be used to create a constraining motion envelope and to predict motion for the next several minutes. For example, if a car is moving on a suburban street, the speed limit may be constrained to 25 or 35 miles an hour. If a command from AD ECU is received that is contrary to the speed limit, the CCU can identify it as a fault (e.g., malicious attack or non-malicious error).

Other redundancy schemes can also be used to see if the system can recover. Temporal redundancy 2402 can be used to read commands multiple times and use median voting. Information redundancy 2404 can be used to process values multiple times and store several copies in memory. In addition, majority voting 2406 can be used to schedule control commands for the ECUs. If the redundancy schemes do not cause the system to recover from the error, then the CCU can safely stop the vehicle. For example, at 2408, other safety controls can include constructing a vehicle motion vector hypothesis, constraining motion within the hypothesis envelope, and stopping the vehicle if control values go outside the envelope.

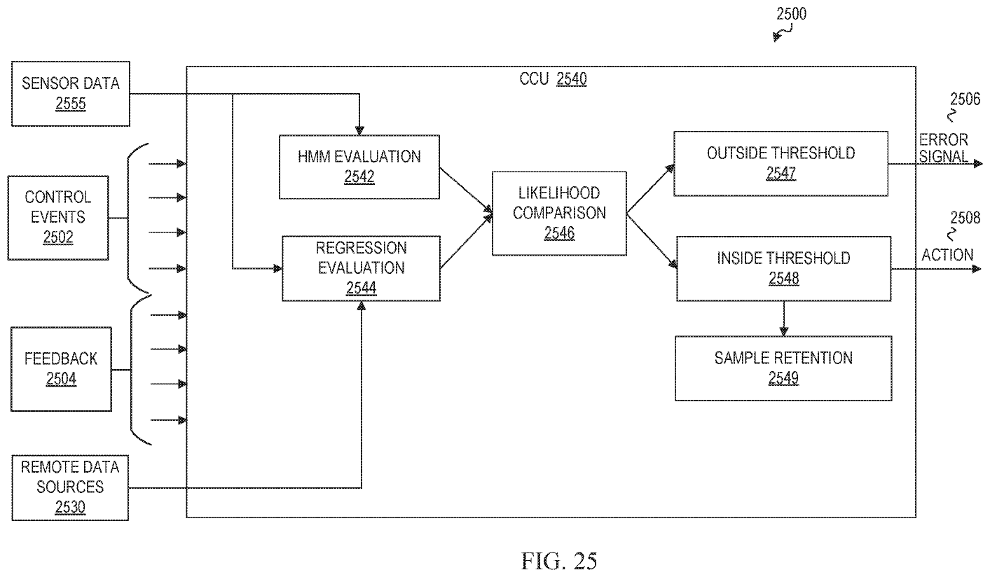

FIG. 25 is a simplified block diagram illustrating an example operational flow 2500 of a fault and intrusion detection system for highly automated and autonomous vehicles according to at least one embodiment. In FIG. 25, several operations are shown within a CCU 2540. CCU 2540 represents one example of CCU 1840 and illustrates possible operations and activities that may occur in CCU 1840. The operations correspond to algorithms of a temporal normal behavior model (e.g., 1841). An HMM evaluation 2542 corresponds to a vehicle behavior model (e.g., 1842), a regression evaluation 2544 corresponds to a regression model (e.g., 1844), and a likelihood comparison 2546 corresponds to a comparator (e.g., 1846).

Control events 2502 are received by CCU 2540 and may be used in both the HMM evaluation 2542 and the regression evaluation 2544. A control event may originate from a driver command, from sensors of an autonomous car that indicate the next action of the vehicle, or from a feedback loop from the sensors or actuators. The HMM evaluation can determine a likelihood that the change in motion indicated by the control event is a fault. HMM evaluation 2542 may also receive sensor data 2555 (e.g., throttle sensor data, steering sensor data, tire pressure sensor data, etc.) to help determine whether the change in motion is a normal behavior or indicative of a fault. The vehicle behavior model may receive feedback 2504 from a comparator (e.g., 1846), for example, where the feedback modifies the vehicle behavior model to recognize mistakes previously committed and to identify similar cases (e.g., based on location and/or time). Accordingly, HMM evaluation 2542 may perform differently based upon feedback from a comparator.

The regression evaluation 2544 predicts the likelihood of a change in motion, which is indicated by a control event, occurring at a given time interval t under normal conditions. Inputs for the regression evaluation can include sensor data 2555 and input data from remote data sources 2530 (e.g., other edge devices 1830). In addition, feedback 2504 from the cloud (e.g., from cloud vehicle data system 1820) may update the regression model that performs regression evaluation 2544, where the regression model is updated to optimize vehicle behavior and benefit from learning in other vehicles.

In one example, regression evaluation 2544 creates a motion envelope that is defined by one or more limits or thresholds for normal vehicle behavior based on examining the inputs from sensors, other models, other edge devices, etc. The regression evaluation 2544 can then determine whether the change in motion indicated by a control event is outside one or more of the motion envelope limits or thresholds.

The likelihood comparison 2546 can be performed based on the output classification of the change in motion from HMM evaluation 2542 and the output prediction from regression evaluation 2544. The output classification from the HMM evaluation can be an indication of the likelihood that a change in motion is a fault (e.g., malicious attack or failure in the vehicle computer system). The output prediction from the regression evaluation 2544 can be a likelihood that the change in motion would occur in the given time interval t, based on input data from sensors, edge devices, other models in the vehicle, etc. If the output prediction from the regression evaluation indicates that the change in motion is unlikely to occur during the given time interval t, and if the output classification from the HMM evaluation indicates the change in motion is likely to be a fault, then the prediction may be outside a motion envelope limit or threshold and the output classification may be outside a normal threshold, as indicated at 2547, and an error signal 2506 may be sent to appropriate ECUs to take corrective measures and/or to appropriate instrument displays. If the output prediction from the regression evaluation indicates that the change in motion is likely to occur during the given time interval t, and if the output classification by the HMM evaluation indicates the change in motion is not likely to be a fault (e.g., it is likely to be normal), then the prediction may be within a motion envelope limit or threshold and the output classification may be within a normal threshold, as indicated at 2548, and the action 2508 to cause the change in motion indicated by the control event is allowed to occur. In at least some implementations a signal may be sent to allow the action to occur. In other implementations, the action may occur in the absence of an error signal.

In other scenarios, the output prediction by the regression evaluation 2544 and the output classification by the HMM evaluation 2542 may be conflicting. For example, if the output prediction by the regression evaluation indicates that the change in motion is unlikely to occur during the given time interval t, and if the output classification of the HMM evaluation indicates the change in motion is unlikely to be a fault (e.g., it is likely to be normal behavior), then an error signal 2506 may be sent to appropriate ECUs to control vehicle behavior and/or sent to appropriate instrument displays. This can be due to the regression evaluation considering additional conditions and factors (e.g., from other sensor data, environmental data, etc.) that constrain the motion envelope such that the change in motion is outside one or more of the limits or thresholds of the motion envelope and is unlikely to occur under those specific conditions and factors. Consequently, even though the output classification by the HMM evaluation indicates the change in motion is normal, the regression evaluation may cause an error signal to be sent.

In another example, if the output prediction by the regression evaluation indicates that the change in motion indicated by a control event is likely to occur during the given time interval t, and if the output classification by the HMM evaluation indicates the change in motion is likely to be a fault, then a threshold may be evaluated to determine whether the output classification from the HMM evaluation indicates a likelihood of fault that exceeds a desired threshold. For example, if the HMM output classification indicates a 95% probability that the change in motion is anomalous behavior, but the regression evaluation output prediction indicates that the change in motion is likely to occur because it is within the limits or thresholds of its predicted motion envelope, then the HMM output classification may be evaluated to determine whether the probability of anomalous behavior exceeds a desired threshold. If so, then an error signal 2506 may be sent to appropriate ECUs to control or otherwise affect vehicle behavior and/or to appropriate instrument displays. If a desired threshold is not exceeded, however, then the action to cause the change in motion may be allowed due to the regression evaluation considering additional conditions and factors (e.g., from other sensor data, environmental data, etc.) that relax the motion envelope such that the change in motion is within the limits or thresholds of the motion envelope and represents expected behavior under those specific conditions and factors.

Additionally, a sample retention 2549 of the results of the likelihood comparison 2546 for particular control events (or all control events) may be saved and used for retraining the vehicle behavior model and/or the regression model and/or may be save and used for evaluation.

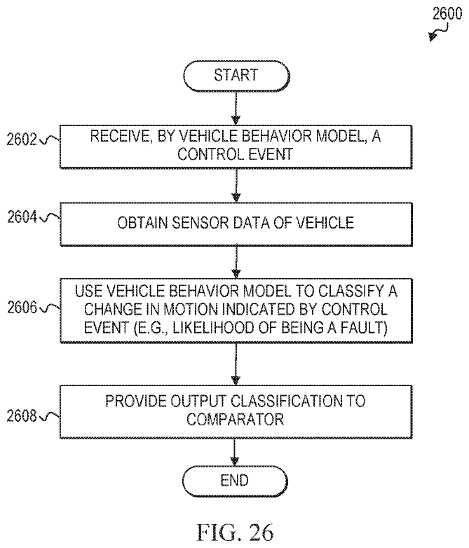

FIG. 26 is a simplified flowchart that illustrates a high level possible flow 2600 of operations associated with a fault and intrusion detection system, such as system 1800. In at least one embodiment, a set of operations corresponds to activities of FIG. 26. A CCU in a vehicle, such as CCU 1840 in vehicle 1850, may utilize at least a portion of the set of operations. Vehicle 1850 may include one or more data processors (e.g., 1857), for performing the operations. In at least one embodiment, vehicle behavior model 1842 performs one or more of the operations.

At 2602, a control event is received by vehicle behavior model 1842. At 2604, sensor data of the vehicle is obtained by the vehicle behavior model. At 2606, the vehicle behavior model is used to classify a change in motion (e.g., braking, acceleration, steering) indicated by the control event as a fault or not a fault. In at least one embodiment, the classification may be an indication of the likelihood (e.g., probability) that the change in motion is a fault. At 2608, the output classification of the change in motion is provided to the comparator.

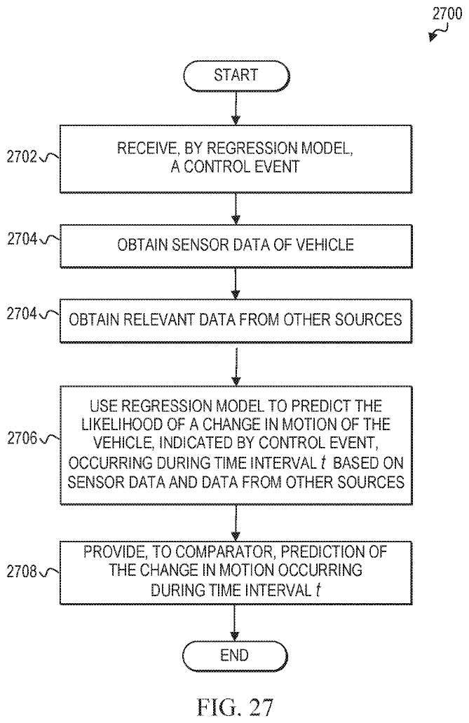

FIG. 27 is a simplified flowchart that illustrates a high level possible flow 2700 of operations associated with a fault and intrusion detection system, such as system 1800. In at least one embodiment, a set of operations corresponds to activities of FIG. 27. A CCU in a vehicle, such as CCU 1840 in vehicle 1850, may utilize at least a portion of the set of operations. Vehicle 1850 may include one or more data processors (e.g., 1857), for performing the operations. In at least one embodiment, regression model 1844 performs one or more of the operations.

At 2702, a control event is received by regression model 1844. The control event indicates a change in motion such as braking, steering, or acceleration. At 2704, sensor data of the vehicle is obtained by the regression model. At 2706, relevant data from other sources (e.g., remote sources such as edge devices 1830, local sources downloaded and updated in vehicle, etc.) is obtained by the regression model.

At 2708, the regression model is used to predict the likelihood of the change in motion indicated by the control event occurring during a given time interval t. The prediction is based, at least in part, on sensor data and data from other sources. At 2710, the output prediction of the likelihood of the change in motion occurring during time interval t is provided to the comparator.

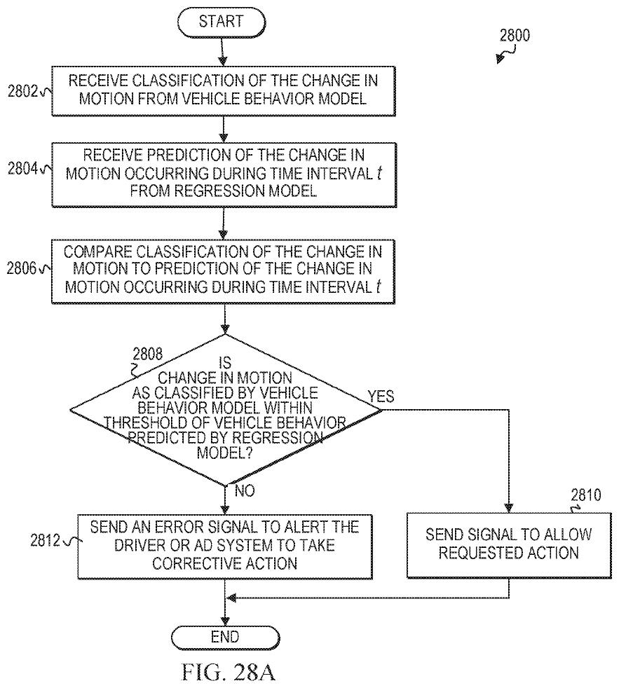

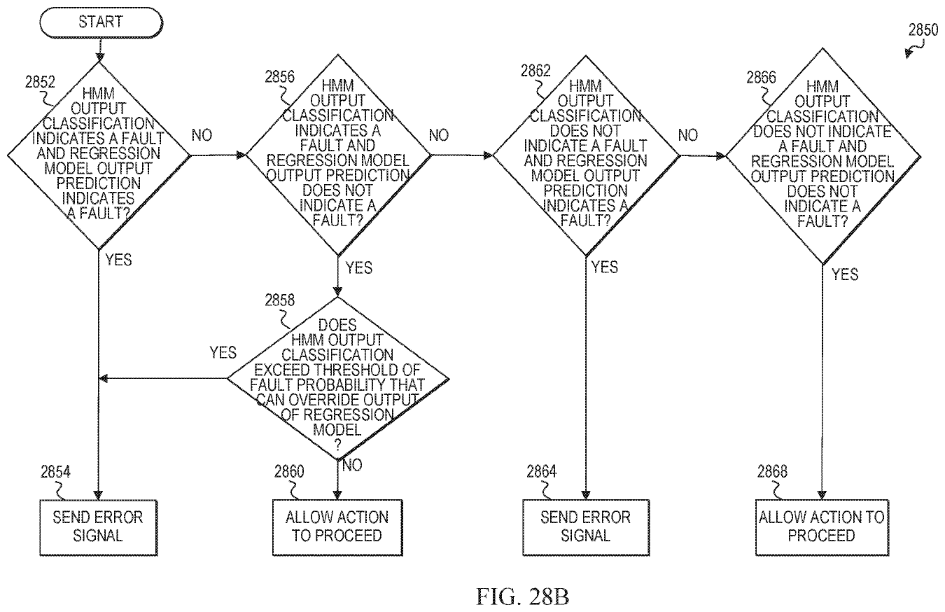

FIG. 28A is a simplified flowchart that illustrates a high level possible flow 2800 of operations associated with a fault and intrusion detection system, such as system 1800. In at least one embodiment, a set of operations corresponds to activities of FIG. 27. A CCU in a vehicle, such as CCU 1840 in vehicle 1850, may utilize at least a portion of the set of operations. Vehicle 1850 include one or more data processors (e.g., 1857), for performing the operations. In at least one embodiment, comparator 1846 performs one or more of the operations.

At 2802, a classification of a change in motion for a vehicle is received from the vehicle behavior model. The output classification provided to the comparator at 2608 of FIG. 26 corresponds to receiving the classification from the vehicle behavior model at 2802 of FIG. 28A.

At 2804, a prediction of the likelihood of the change in motion occurring during time interval t is received from the regression model. The output prediction provided to the comparator at 2710 of FIG. 27 corresponds to receiving the prediction at 2804 of FIG. 28A.

At 2806, the comparator compares the classification of the change in motion to the prediction of the likelihood of the change in motion occurring during time interval t. At 2808, a determination is made as to whether the change in motion as classified by the vehicle behavior model is within a threshold (or limit) of expected vehicle behavior predicted by the regression model. Generally, if the change in motion as classified by the vehicle behavior model is within the threshold of expected vehicle behavior predicted by the regression model, then at 2810, a signal can be sent to allow the change in motion to proceed (or the change in motion may proceed upon the absence of an error signal). Generally, if the change in motion as classified by the vehicle behavior model is not within the threshold (or limit) of vehicle behavior predicted by the regression model, then at 2812, an error signal can be sent to alert a driver to take corrective action or to alert the autonomous driving system to take corrective action. A more detailed discussion of possible comparator operations is provided in FIG. 28B.

FIG. 28B is a simplified flowchart that illustrates a high level possible flow 2850 of additional operations associated with a comparator operation as shown in FIG. 28A and more specifically, at 2808.

At 2852, a determination is made as to whether the following conditions are true: the output classification from the vehicle behavior model (e.g., HMM) indicates a fault and the output prediction by the regression model indicates a fault based on the same control event. If both conditions are true, then at 2854, an error signal (or control signal) can be sent to alert a driver to take corrective action or to alert the autonomous driving system to take corrective action.

If at least one condition in 2852 is not true, then at 2856, a determination is made as to whether the following two conditions are true: the output classification from the vehicle behavior model indicates a fault and the output prediction by the regression model does not indicate a fault based on the same control event. If both conditions are true, then at 2858, another determination is made as to whether the output classification from the vehicle behavior model exceeds a desired threshold that can override regression model output. If so, then at 2854, an error signal (or control signal) can be sent to alert a driver to take corrective action or to alert the autonomous driving system to take corrective action. If not, then at 2860, a signal can be sent to allow the vehicle behavior indicated by the control event to proceed (or the change in motion may proceed upon the absence of an error signal).

If at least one condition in 2856 is not true, then at 2862, a determination is made as to whether the following conditions are true: the output classification from the vehicle behavior model does not indicate a fault and the output prediction by the regression model does indicate a fault based on the same control event. If both conditions are true, then at 2864, an error signal (or control signal) can be sent to alert a driver to take corrective action or to alert the autonomous driving system to take corrective action.

If at least one condition in 2862 is not true, then at 2866, the following conditions should be true: the output classification from the vehicle behavior model does not indicate a fault and the output prediction by the regression model does not indicate a fault based on the same control event. If both conditions are true, then at 2868, a signal can be sent to allow the vehicle behavior indicated by the control event to proceed (or the change in motion may proceed upon the absence of an error signal).

The level of autonomy of an autonomous vehicle depends greatly on the number and type of sensors with which the autonomous vehicle is equipped. In addition, many of the different functionalities of the autonomous vehicle, such as, for example, autonomous highway driving, are achieved with a specific set of well-functioning sensors that provides the autonomous vehicle with the appropriate information that is processed by the algorithms of the vehicle's control systems.

Since sensors play such a vital role in the operation of autonomous vehicles, it is important that the health of the various sensors is known. In addition to the safety concerns of the health of the sensors (if there is a sensor failure there is a chance that the vehicle cannot keep driving autonomously), there are other benefits to knowing the health of the sensors of the vehicle. This can include, for example, increasing the confidence of the driver/passenger and improving the efficiency of the autonomous vehicle.

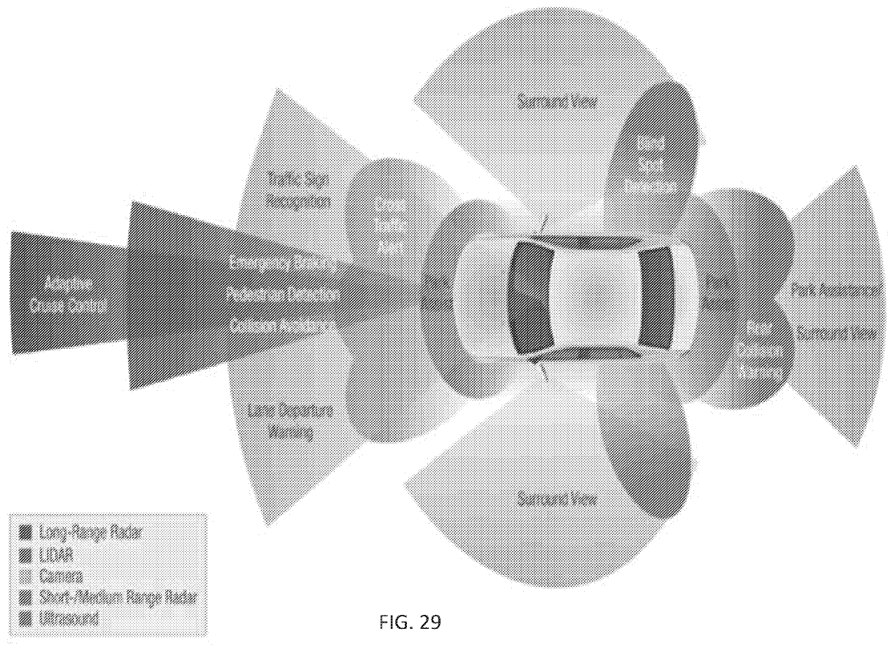

As autonomous vehicle technology improves, the number of sensors on autonomous vehicles increases. For example, to reach level 3 of automation, some car manufacturers have equipped a car with 14 or more sensors. FIG. 29 illustrates an example of sensor's arrays commonly found on autonomous vehicles. Sensors can include, for example, radars, LIDAR, cameras, and ultrasonic sensors. Having more sensors can account for redundancy and increased functionality, however, in the event of a sensor failure, the autonomous vehicle may be configured to be self-aware and be able to determine the vehicle's capabilities after the failure.

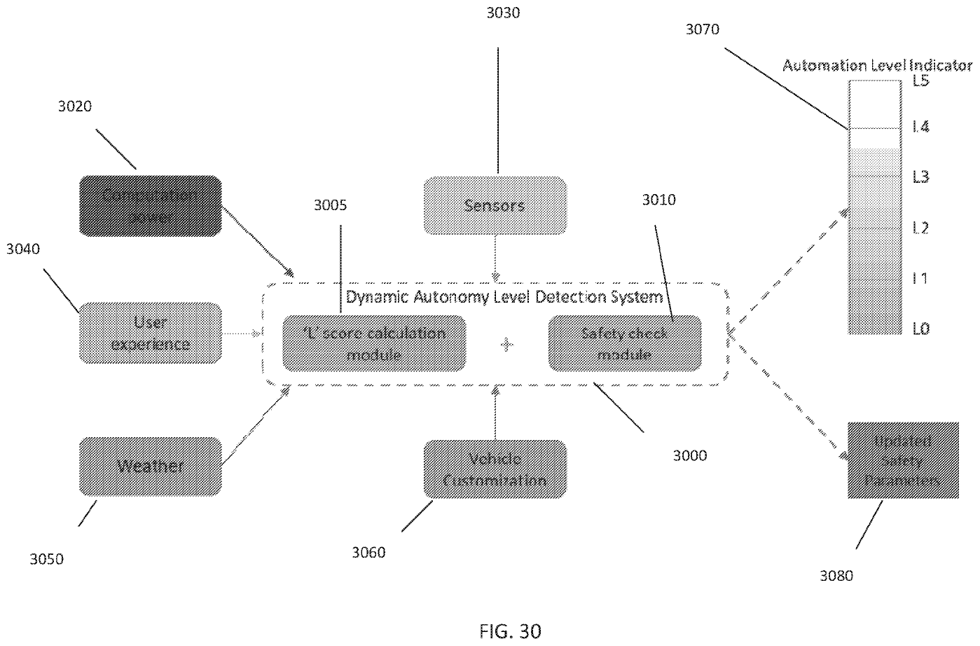

FIG. 30 illustrates an example of a Dynamic Autonomy Level Detection (“DALD”) System 3000 that adapts the autonomous vehicle functionalities based on the sensing and processing capabilities available to the vehicle. In some embodiments, system 3000 can consider the driver's desired experience (e.g., the level of autonomy the driver desires) and the current course of action of the vehicle. This DALD system leverages different inputs, such as, for example, one or more of weather conditions, sensor performance, vehicle customization, and the driver's plans to dynamically determine the maximum necessary level of autonomy the vehicle should function at for a defined route. As such, the vehicle can adapt its functionalities based on the health of the existing sensors, vehicle customization (e.g., a vehicle with trailer blocking rear sensors), weather conditions, etc.

With continued reference to FIG. 30, system 3000 comprises a score module 3005 and a safety module 3010. The score module 3005 can also be considered an “L” score calculation module. The score module estimates the level (“L”) of autonomy that the vehicle can implement based on different inputs received by system 3000. Examples of inputs received by the DALD system 3000 can include: sensor state (or health) information 3030, desired user experience 3040, weather conditions 3050, computation resources 3020, and vehicle customization state 3060. It should be noted that the list of inputs herein is merely exemplary and more or less inputs than those listed can be considered as inputs for system 3000.

As an example, the ‘L’ score can be defined as:

$${L}_{score} = {\sum }_{i = 1}^{N} {w}_{i} * {input}_{i}$$

Where inputᵢ is one of the N different inputs to the DALD system 3000 depicted in FIG. 30, and where wᵢ are the different weights associated with each inputᵢ. The weights can dynamically change as the autonomous vehicle capabilities change over time and are dependent on the autonomous vehicle's architecture, such as, for example the vehicle's sensors and algorithms. Having a wᵢ=0 means that inputᵢ was disabled. The autonomous vehicle should then adapt that L_{score} into a number that corresponds to the different levels of automation available on the car, which can be an integer from 0 to 5, if the maximum automation level available in the car is Level 5.

Note that in at least some embodiments the weights shall also satisfy the following condition to generate the L_{score} consistently when the number of contributing inputs change:

$$1 = {\sum }_{i = 1}^{N} {w}_{i}$$

Accordingly, in an embodiment, when one or more inputs have zero weights, the remaining non-zero weights are adjusted to add up to unity at all times.

Although the example of the L_{score} above illustrates a linear relationship, it is possible that the L_{score} can be defined in terms of higher order polynomials, which would utilize a more complex calculation and calibration. Therefore, the above linear relationship has been provided as an example that represents a relatively simple way of calculating the L_{score}.

With continued reference to FIG. 30, the ‘L’ score calculation module 3005 is vehicle dependent and is intended to illustrate the capabilities of the vehicle based on its current state. Examples of inputs that can affect the “L” score can include: computation power 3020 of the vehicle, the sensors 3030 of the vehicle, the user experience 3040, weather 3050, and vehicle customization 3060. This list is not exhaustive of all the factors that may be used to calculate the “L” score and not all of the factors listed have to be used in the “L” score calculation.

As stated above, the sensors 3030 are instrumental in the autonomy level of autonomous vehicles. As such, the sensors 3030 can affect the “L” score greatly. When a sensor or multiple sensors are damaged the DALD system 3000 can disable a sensor or set a smaller input weight for the impacted/affected sensor or sensors. Thus, demonstrating a lower trust level, and likely lowering the “L” score. Besides a damaged sensor, the following are examples of reasons why the weighted score of the sensor input may be lowered in the “L” score calculation: a poorly performing sensor, abnormally functioning sensor (e.g., a sensor that starts performing abnormally due to gradual deterioration), sensor drift, and an intentional disabling of the sensor if it is not needed for the current driving performance, which can save computational and battery power.

The weather 3050, which can include other environmental conditions, can also have an impact on the autonomy level of vehicles. As an example, the autonomous vehicle could lower its autonomy level if it detects a hazardous weather condition, such as, for example, snow along the route that it is not prepared to manage properly. Such environmental conditions can adversely affect the sensing capabilities of the autonomous vehicle or significantly decrease the tire traction, which may prompt an autonomy level regression.

Vehicle customization 3060 can also influence the autonomy level of the vehicle. If a person adds elements to a vehicle after sensors are calibrated, some sensors may be occluded. In some examples a sensor may need to be disabled when making vehicle modifications. In such situations, the sensors may need to be weighted less heavily because of temporary or permanent modifications. Examples of vehicle modifications can include, for example, attached trailers/others at the back of the vehicle, an attached roof rack, or even and additional payload (e.g., suitcases, furniture, etc.) It should be noted than any change to the vehicle that can affect the sensors or handling of the vehicle can be included in vehicle customization 3060.

A driver/passenger of the vehicle may want to prioritize certain aspects of the drive/route. This user experience 3040 can also affect the autonomy level of the vehicle. As an example, the driver might want to prioritize time of travel no matter how many times the autonomous vehicle could request a takeover (driving through urban areas) or the driver might want to prioritize a scenic view that will take more time. The driver may even prioritize routes where higher levels of autonomy aren't needed, like highway driving (that can be achieved with minimal set of sensors.) In some situations, the level of autonomy may be completely irrelevant, such as, for example, when the driver simply enjoys driving a car or enjoys the scenery.

Another factor in the “L” score is the computational power 3020 available. For example, if the car's battery isn't fully charged or if it is faulty, then there may not be enough power for the extra computation needed to reach higher levels of automation on an autonomous vehicle. As another example, a component relevant to the self-driving capabilities of the autonomous vehicle, such as a hard drive, is malfunctioning or has limited space for keeping data, then the autonomous vehicle should adapt its level of autonomy based on the computation capabilities it possesses.

After receiving the inputs mentioned above, the DALD system 3000 can determine which functionalities to enable along the route. As such, system 3000 provides an advanced contextual awareness to the autonomous vehicle before a journey. For example, if there is an abnormal functioning sensor, the vehicle can disable that sensor and can determine how that sensor contributed to the current autonomy level and which algorithms were dependent on that sensor information. If the car can function by disabling that sensor, thanks to sensor redundancy, then the ‘L’ score may remain the same. However, if that sensor was critical for the performance of the autonomous vehicle, such as, for example, a 360 degrees LIDAR sensor used for localization in Level 4, then the autonomous vehicle should reduce its level of autonomy to where it can maximize the automation functions without that sensor. This may mean dropping the autonomy level, such as to L3 or L2, depending on the vehicle's design. In another example, it may also be necessary to drop the autonomy level if a trailer is attached to the vehicle, thus blocking any rear sensors. As yet another example, the autonomy level may be dropped when a roof rack with snowboards are interfering with the GPS signal of the car.

With continued reference to FIG. 30, an automation level indicator 3070 can display the current “L” score for better visualization, which can increase the user's awareness and trust in the autonomous vehicle. The indicator 3070 allows the user to see how the autonomy level changes after events that may affect the vehicle's abilities. As a result, the user can be aware of how changes to the vehicle (e.g., sensor damage, customization, etc.) affect the autonomy level of the vehicle and could consider other alternatives, such as, for example, not hitching a trailer, if the user is more concerned on the safety and automation capabilities along the route. As another example, it could even impact the level of self-confidence in the user's abilities to handle situations along a route or may prompt the driver/owner to take the vehicle for service if vehicle consistently, or occasionally, is performing below capabilities/expectations.

The DALD system 3000 also comprises a safety check module 3080 that is responsible for determining which of the autonomous vehicle's parameters are important for path planning algorithms. Examples of such parameters can include the coefficient of friction in certain areas of the route, which may change due to different weather conditions; the weight of the autonomous vehicle, which can change due to vehicle customization and that affects the maximum acceleration and maximum and minimum brake of the autonomous vehicle. Being able to modify the parameters intrinsic of each route and path planning algorithm will play an important role in the safety of the autonomous vehicles. Safety modules rely on the accuracy of these parameters in order to estimate the best control parameters for the user.

In addition to the obvious safety benefits, an additional benefit of the system 3000 is that by making the autonomous vehicle self-aware and to dynamically adapt its functionalities, the power consumption of the car and the cost of maintenance of the autonomous vehicle can be reduced in the long term. Thus, the user's input may be important to system 3000. Depending on the user's desire to go on the fastest route, or the scenic one, for example, an L5 autonomous vehicle could choose to stay on L3 mode along the route (or parts of the route) after checking the sensors status and predicted weather conditions, which could avoid wearing out expensive sensors and computation resources.

As autonomous vehicles become ubiquitous, they will become a common part of family households, replacing the regular family vehicle. As they become more universal, they will be expected to perform the functions of the traditional human driven vehicles and not just the regular day-to-day commutes to work or school. This means that people will expect autonomous vehicles to provide more versatility, such as, for example, facilitating camping trips, weekend getaways to the beach or lake, or a tailgate party at a sporting event. Therefore, autonomous vehicles be expected to be able to perform temporary hauling of equipment. As examples, such equipment may include camping gear, bikes, boats, jet-skis, coolers, grills, etc. Accordingly, autonomous vehicles may include the ability to hitch a trailer, hooks, platforms, extension, or the like.

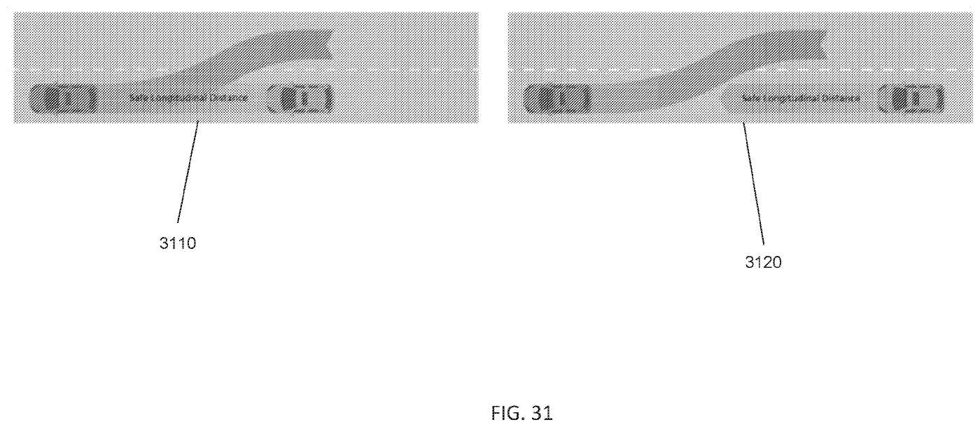

However, such attachments on an autonomous vehicle may result in sensor occlusion, and may result in a change of the vehicle behavioral model with respect to the vehicle's dimensions. This is particularly true for the pre-existing parameters that are an integral part for keeping a safe distance for which the vehicle will now need to compensate when maneuvering along roadways. As an example, and with reference to FIG. 31, if an autonomous vehicle thinks that it has enough room to pull in front of another vehicle, but it instead is much longer than its control system realizes, it could prevent the trailing car from having enough space to stop, or worse, hit the vehicle that the autonomous vehicle is passing.

As other examples, similar considerations need to be taken if vehicle owners start making vehicle customizations, such as lowering the vehicle, or incorporating oversized tires (that may protrude outside the wheel wells), spoilers, or other add-ons. These customizations may alter the modeling and calibration of vehicle parameters.

As such, it may be important to obtain the new vehicle dimensions to the extent that the dimensions of the vehicle have been extended by the modifications. This will allow the autonomous vehicle to determine how much guard-band is needed to alter the safe distance clearance models to compensate for the extensions. This distance is crucial for navigation, which allows the autonomous vehicle to avoid accidents, and applicable to systems, such as adaptive cruise control, when backing out of a parking spot, and performing similar autonomous actions.

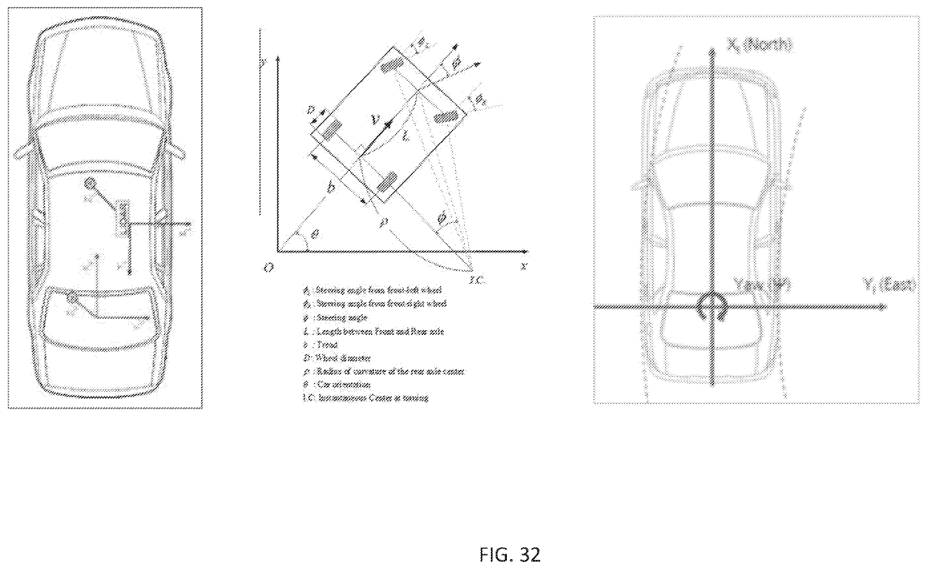

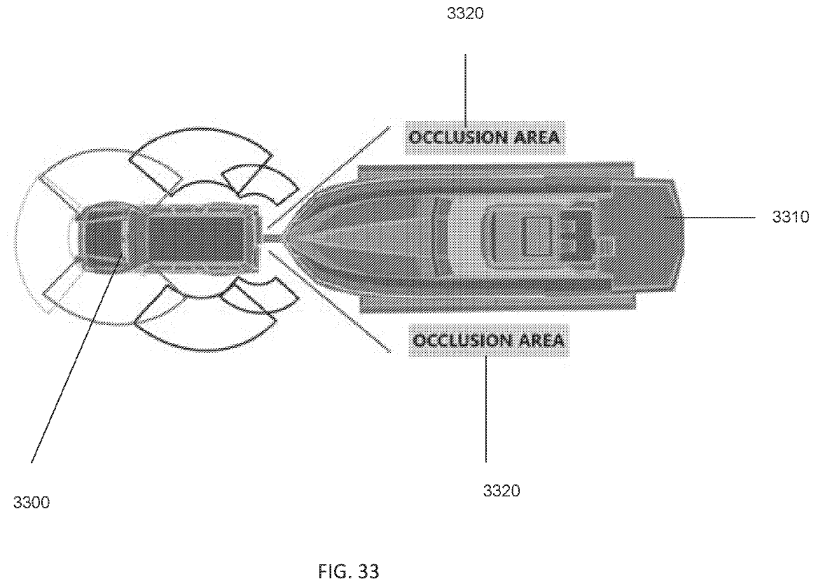

While models exist for driving safety, such as, for example, safe driving distances, the safety of an autonomous vehicle can be increased if an autonomous vehicle knows that the dimensions of the vehicle have changed. Furthermore, robotic drivers of autonomous vehicles rely on sensors and rigorous calibration for proper execution. As part of vehicle sensor calibration, a coordinate system is adopted in which a vehicle reference point is very unlikely to be moved/altered, except for perhaps, elevation. One example, the Ackerman model, as shown in FIG. 32, comprises the vehicle's rear axis center point between the two wheels. Any changes to this model may be considered and referenced with respect to such coordinates. As an example, when the extension to the vehicles dimensions are the result of a hitch being attached to the vehicle, the coordinates are offset to account for the hitch point

In addition to the disruption of the vehicle modeling system, customizations, such as the addition of a trailer hitch can disrupt both the sensors of the vehicle and the maneuverability o the vehicle. These disruptions will likely impact the level of autonomy of the vehicle. FIG. 33 illustrates an example of a vehicle 3300 with an attachment 3310 (e.g., a boat being towed by the vehicle in this example.) As shown in this example, the customization produces occluded areas 3320.

One possible solution to dealing with the new dimensions of the vehicle would be to furnish the trailer or hitch with corresponding sensors. This would, however, add to the complexity of the system and could be both time consuming and expensive. For example, a user would have to worry about compatibility of the new sensors systems with existing vehicle system; it would be expensive and time consuming to complete the rigorous steps for calibration; there may be exposure to elements (e.g., the sensors could be submerged into water if the extension is a boat, jet-ski, canoe, etc.); and there may be poles or other hardware extending beyond the trailer (e.g., a boat can be much larger than its trailer.) In addition, the use of such a trailer (for a boat, for example) would be temporary (a weekend outing), which would make this solution impractical and unlikely to be enforced/observed.

Another possible alternative would be the implementation of an array of ultrasonic sensors along the same coordinate system as the vehicle model, capable of 3D modeling, that could capture, with some approximation, the width and depth of the customization causing the occlusion of the sensors.

As yet another example, a simple and low-cost solution includes a method that captures and traces the new exterior vehicle dimension as a result of the customization (e.g., an attached trailer/hitch). The autonomous vehicle could then compensate as needed (while the trailer/hitch are attached) on a temporary basis.

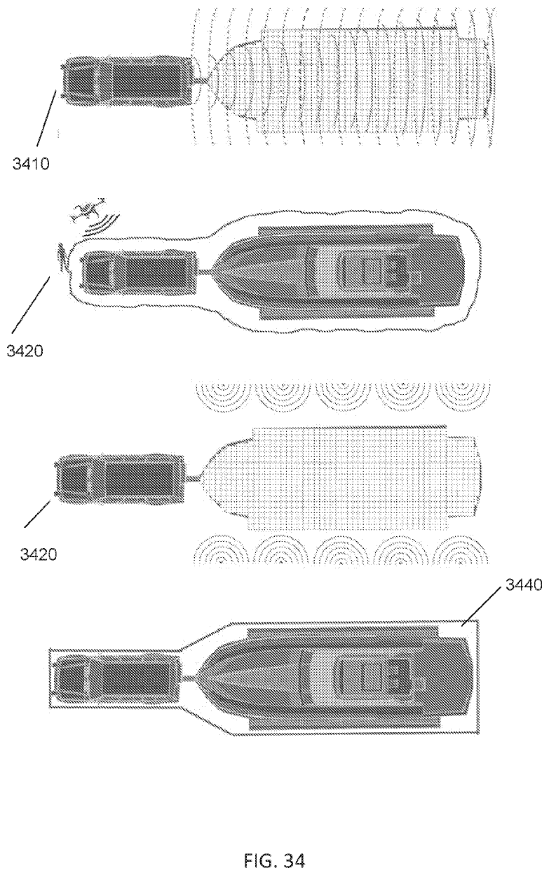

FIG. 34 illustrates an example of the use of a simple method of tracing the new dimensions of the vehicle incorporating dimensions added by an extension coupled to the vehicle. As a comparison, 3410 shows a 3D ultrasound map of the vehicle and extension, which may be sensed by an ultrasonic sensor which may or may not be attached to the vehicle. In some examples, the example of 3410 can be automated. In such examples, when the vehicle detects an occlusion or that a trailer is attached, an automatic ultrasonic scan can begin, creating the rendering of the 3D model. Another example is illustrated at 3430. In the example of 3430, the new dimensions of the vehicle are captured using LIDARs, such as, for example with the use of a LIDAR based station. 3420 illustrates an example of a user performing a manual walkthrough to facilitate tracing of the vehicle's new dimensions. After the walkthrough, the new model 3440 for the vehicle's dimensions is created. To conduct the walk through, the vehicle owner can walk along the path of the vehicle and extensions at a given length (e.g., arm length) while carrying a sensor. In some examples, this sensor can be paired with (e.g., communicatively coupled to) a smart phone. In other examples, the sensor can be paired with the vehicle. In various embodiments, as illustrated by 3420, the dimensions of the vehicle can be traced using a drone and camera, as opposed to physically walking around the vehicle. The tracing results can then be delivered to the autonomous vehicle and a polygon model representation 3440 can be approximated. This model can be incorporated into the autonomous vehicle's driving algorithms.

A system for incorporating the above options can comprise one or more of the following elements: a vehicle with an integrated hitch on the vehicle with a sensor that registers when a hitch is attached to or disconnected from an extension; an alarm that warns driver that a ‘safety-walkthrough’ is needed responsive to sensing of a hitch attachment; a sensing element/device to create the tracing; non-occluded sensors that validate/serve as cross-reference while tracing in progress; and a vehicle warning system that warns the driver of changes on its level-of-autonomy as a result of the tracing and the remaining functional sensors. In one embodiment, the sensing element/tracing device may comprise a smart phone app that calculates the new autonomous vehicle dimensions based on one or more images captured by the smartphone camera. The user may simply walk around the perimeter of the car, or a drone may be used, to scan the new dimensions. In another example, the scanning device can comprise an integrated detachable vehicle camera that performs functions similar to those described above. After the scanning, if gaps exist in the trace, or if the result is not exactly a straight-line trace (or does not exactly stop at the point of origin), the trace can still be converted into a closed polygon/loop around the vehicle based on the captured points of the trace. The vehicle can consider the original dimensions to compensate effects of a ‘pivot’ point on curvatures and the new model of the dimensions can include an offset that will guarantee the model will be outside of the vehicle limits, which can be an added safety buffer. In other embodiments, other methods of determining the new dimensions can be used, such as, for example, ultrasound and LIDAR sensors, which may or may not be attached to the vehicle.

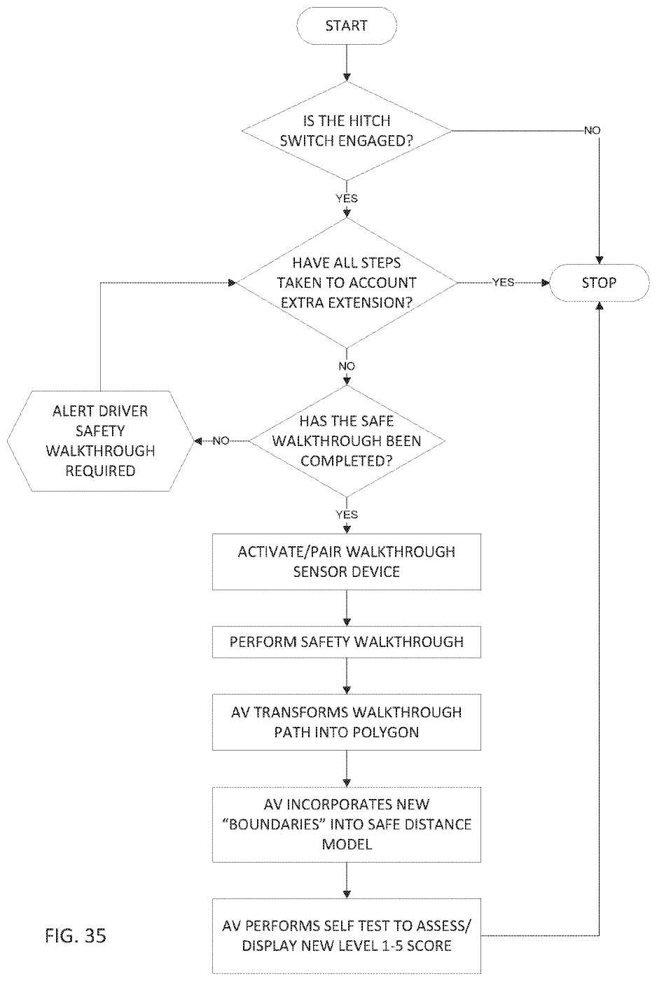

FIG. 35 illustrates an example of a vehicle model occlusion compensation flow according to an embodiment of the present disclosure. The example of FIG. 35 can also be considered a method of updating the vehicle dimensions of an autonomous vehicle.

The example of FIG. 35 comprises actions that include determining whether a hitch switch has been engaged. In some embodiments the hitch can include an automatic sensor (e.g., switch) that indicates whether the hitch has been engaged. In various embodiments, the autonomous vehicle can additionally or alternatively include a manual switch to indicate that the hitch has been engaged.

If the hitch switch has been engaged, the vehicle can perform a check to determine if all the necessary safety actions have been performed before the vehicle moves with the added dimensions. If they have, the flow ends. If not, the vehicle can determine whether a safety walkthrough that captures the new vehicle dimensions has been completed. If not, the driver can be warned that a walkthrough is necessary, and the walkthrough can begin.

To perform the walkthrough, the vehicle will first activate and/or pair with a sensing device. This can be a sensing device integrated within or paired to a smart phone or similar device, or a separate device that connects directly to the vehicle. After the device is paired/active, the owner conducts a walkthrough around the vehicle.

Next, the sensing device will transfer the data obtained during the walkthrough to the autonomous vehicle. The autonomous vehicle can then transform the data obtained by the sensing device into a polygon model. The autonomous vehicle can then use the new dimensions in its autonomous vehicle algorithms, including for example, the safe distance algorithm. Finally, the autonomous vehicle can perform a self-test to determine whether the new dimensions affect the autonomy level at which the vehicle is operated. If the level has changed, this new level can be displayed (or otherwise communicated) to the driver (or an indication that the level has not changed may be displayed or otherwise communicated to the driver).

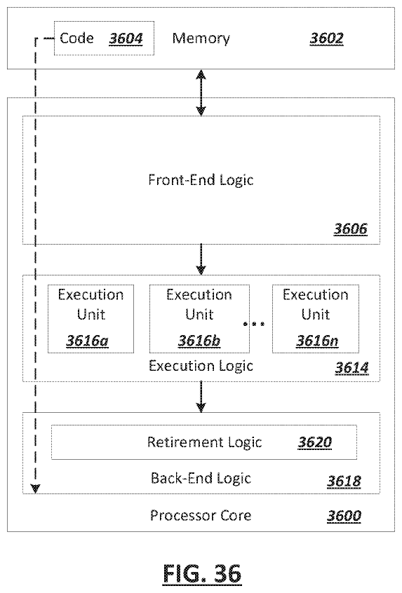

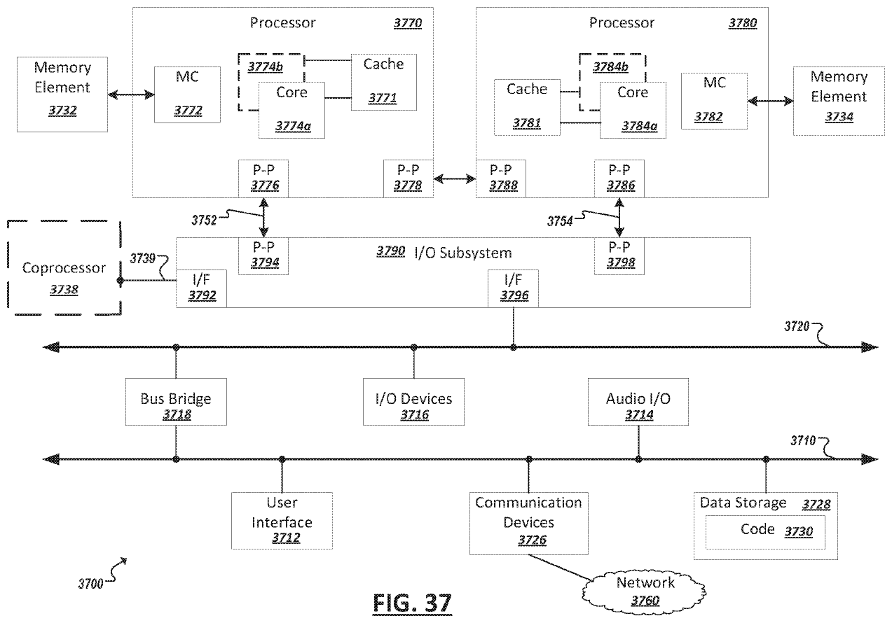

FIGS. 36-37 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 36-37.

FIG. 36 is an example illustration of a processor according to an embodiment. Processor 3600 is an example of a type of hardware device that can be used in connection with the implementations above. Processor 3600 may be any type of processor, such as a microprocessor, an embedded processor, a digital signal processor (DSP), a network processor, a multi-core processor, a single core processor, or other device to execute code. Although only one processor 3600 is illustrated in FIG. 36, a processing element may alternatively include more than one of processor 3600 illustrated in FIG. 36. Processor 3600 may be a single-threaded core or, for at least one embodiment, the processor 3600 may be multi-threaded in that it may include more than one hardware thread context (or “logical processor”) per core.

FIG. 36 also illustrates a memory 3602 coupled to processor 3600 in accordance with an embodiment. Memory 3602 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 3600 can execute any type of instructions associated with algorithms, processes, or operations detailed herein. Generally, processor 3600 can transform an element or an article (e.g., data) from one state or thing to another state or thing.

Code 3604, which may be one or more instructions to be executed by processor 3600, may be stored in memory 3602, or may be stored in software, hardware, firmware, or any suitable combination thereof, or in any other internal or external component, device, element, or object where appropriate and based on particular needs. In one example, processor 3600 can follow a program sequence of instructions indicated by code 3604. Each instruction enters a front-end logic 3606 and is processed by one or more decoders 3608. The decoder may generate, as its output, a micro operation such as a fixed width micro operation in a predefined format, or may generate other instructions, microinstructions, or control signals that reflect the original code instruction. Front-end logic 3606 also includes register renaming logic 3610 and scheduling logic 3612, which generally allocate resources and queue the operation corresponding to the instruction for execution.

Processor 3600 can also include execution logic 3614 having a set of execution units 3616a, 3616b, 3616n, etc. Some embodiments may include a number of execution units dedicated to specific functions or sets of functions. Other embodiments may include only one execution unit or one execution unit that can perform a particular function. Execution logic 3614 performs the operations specified by code instructions.

After completion of execution of the operations specified by the code instructions, back-end logic 3618 can retire the instructions of code 3604. In one embodiment, processor 3600 allows out of order execution but requires in order retirement of instructions. Retirement logic 3620 may take a variety of known forms (e.g., re-order buffers or the like). In this manner, processor 3600 is transformed during execution of code 3604, at least in terms of the output generated by the decoder, hardware registers and tables utilized by register renaming logic 3610, and any registers (not shown) modified by execution logic 3614.

Although not shown in FIG. 36, a processing element may include other elements on a chip with processor 3600. For example, a processing element may include memory control logic along with processor 3600. The processing element may include I/O control logic and/or may include I/O control logic integrated with memory control logic. The processing element may also include one or more caches. In some embodiments, non-volatile memory (such as flash memory or fuses) may also be included on the chip with processor 3600.

FIG. 37 illustrates a computing system 3700 that is arranged in a point-to-point (PtP) configuration according to an embodiment. In particular, FIG. 37 shows a system where processors, memory, and input/output devices are interconnected by a number of point-to-point interfaces. Generally, one or more of the computing systems described herein may be configured in the same or similar manner as computing system 3600.

Processors 3770 and 3780 may also each include integrated memory controller logic (MC) 3772 and 3782 to communicate with memory elements 3732 and 3734. In alternative embodiments, memory controller logic 3772 and 3782 may be discrete logic separate from processors 3770 and 3780. Memory elements 3732 and/or 3734 may store various data to be used by processors 3770 and 3780 in achieving operations and functionality outlined herein.

Processors 3770 and 3780 may be any type of processor, such as those discussed in connection with other figures herein. Processors 3770 and 3780 may exchange data via a point-to-point (PtP) interface 3750 using point-to-point interface circuits 3778 and 3788, respectively. Processors 3770 and 3780 may each exchange data with a chipset 3790 via individual point-to-point interfaces 3752 and 3754 using point-to-point interface circuits 3776, 3786, 3794, and 3798. Chipset 3790 may also exchange data with a co-processor 3738, such as a high-performance graphics circuit, machine learning accelerator, or other co-processor 3738, via an interface 3739, which could be a PtP interface circuit. In alternative embodiments, any or all of the PtP links illustrated in FIG. 37 could be implemented as a multi-drop bus rather than a PtP link.

Chipset 3790 may be in communication with a bus 3720 via an interface circuit 3796. Bus 3720 may have one or more devices that communicate over it, such as a bus bridge 3718 and I/O devices 3716. Via a bus 3710, bus bridge 3718 may be in communication with other devices such as a user interface 3712 (such as a keyboard, mouse, touchscreen, or other input devices), communication devices 3726 (such as modems, network interface devices, or other types of communication devices that may communicate through a computer network 3760), audio I/O devices 3714, and/or a data storage device 3728. Data storage device 3728 may store code 3730, which may be executed by processors 3770 and/or 3780. In alternative embodiments, any portions of the bus architectures could be implemented with one or more PtP links.

The computer system depicted in FIG. 37 is a schematic illustration of an embodiment of a computing system that may be utilized to implement various embodiments discussed herein. It will be appreciated that various components of the system depicted in FIG. 37 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more computing systems may be provided, including in-vehicle computing systems (e.g., used to implement at least a portion of an automated driving stack and enable automated driving functional of the vehicle), roadside computing systems (e.g., separate from vehicles; implemented in dedicated roadside cabinets, on traffic signs, on traffic signal or light posts, etc.), one or more computing systems implementing a cloud- or fog-based system supporting autonomous driving environments, or computing systems remote from an autonomous driving environments. These computing systems may include logic implemented using one or a combination of one or more data processing apparatus (e.g., central processing units, graphics processing units, tensor processing units, ASICs, FPGAs, etc.), accelerator hardware, other hardware circuitry, firmware, and/or software to perform or implement one or a combination of the following examples (or portions thereof). For example, in various embodiments, the operations of the example methods below may be performed using any suitable logic, such as a computing system of a vehicle (e.g., 105) or component thereof (e.g., processors 202, accelerators 204, communication modules 212, user displays 288, memory 206, IX fabric 208, drive controls 220, sensors 225, user interface 230, in-vehicle processing system 210, machine learning models 256, other component, or subcomponents of any of these), a roadside computing device 140, a fog- or cloud-based computing system 150, a drone 180, and access point 145, a sensor (e.g., 165), memory 3602, processor core 3600, system 3700, other suitable computing system or device, subcomponents of any of these, or other suitable logic. In various embodiments, one or more particular operations of an example method below may be performed by a particular component or system while one or more other operations of the example method may be performed by another component or system. In other embodiments, the operations of an example method may each be performed by the same component or system.

Example 1 includes an apparatus comprising at least one interface to receive a signal identifying a second vehicle in proximity of a first vehicle; and processing circuitry to obtain a behavioral model associated with the second vehicle, wherein the behavioral model defines driving behavior of the second vehicle; use the behavioral model to predict actions of the second vehicle; and determine a path plan for the first vehicle based on the predicted actions of the second vehicle.

Example 2 includes the apparatus of Example 1, the processing circuitry to determine trustworthiness of the behavioral model associated with the second vehicle prior to using the behavioral model to predict actions of the second vehicle.

Example 3 includes the apparatus of Example 2, wherein determining trustworthiness of the behavioral model comprises verifying a format of the behavioral model.

Example 4 includes the apparatus of any one of Examples 1-3, wherein determining trustworthiness of the behavioral model comprises verifying accuracy of the behavioral model.

Example 5 includes the apparatus of Example 4, wherein verifying accuracy of the behavioral model comprises storing inputs provided to at least one machine learning model and corresponding outputs of the at least one machine learning model; and providing the inputs to the behavioral model and comparing outputs of the behavioral model to the outputs of the at least one machine learning model.

Example 6 includes the apparatus of Example 4, wherein verifying accuracy of the behavioral model comprises determining expected behavior of the second vehicle according to the behavioral model based on inputs corresponding to observed conditions; observing behavior of the second vehicle corresponding to the observed conditions; and comparing the observed behavior with the expected behavior.

Example 7 includes the apparatus of any one of Examples 1-6, wherein the behavior model corresponds to at least one machine learning model used by the second vehicle to determine autonomous driving behavior of the second vehicle.

Example 8 includes the apparatus of any one of Examples 1-7, wherein the processing circuitry is to communicate with the second vehicle to obtain the behavioral model, wherein communicating with the second vehicle comprises establishing a secure communication session between the first vehicle and the second vehicle, and receiving the behavioral model via communications within the secure communication session.

Example 9 includes the apparatus of Example 8, wherein establishing the secure communication session comprises exchanging tokens between the first and second vehicles, and each token comprises a respective identifier of a corresponding vehicle, a respective public key, and a shared secret value.

Example 10 includes the apparatus of any one of Examples 1-9, wherein the signal comprises a beacon to indicate an identity and position of the second vehicle.

Example 11 includes the apparatus of any one of Examples 1-10, further comprising a transmitter to broadcast a signal to other vehicles in the proximity of the first vehicle to identify the first vehicle to the other vehicles.

Example 12 includes the apparatus of any one of Examples 1-11, wherein the processing circuitry is to initiate communication of a second behavioral model to the second vehicle in an exchange of behavior models including the behavioral model, the second behavioral model defining driving behavior of the first vehicle.

Example 13 includes the apparatus of any one of Examples 1-12, wherein the one or more processors are to determine whether the behavioral model associated with the second vehicle is in a model database of the first vehicle, wherein the behavioral model associated with the second vehicle is obtained based on a determination that the behavioral model associated with the second vehicle is not yet in the model database.

Example 14 includes the apparatus of any one of Examples 1-13, wherein the second vehicle is capable of operating in a human driving mode and the behavior model associated with the second vehicle models characteristics of at least one human driver of the second vehicle during operation of the second vehicle in the human driving mode.

Example 15 includes the apparatus of any one of Examples 1-14, wherein the behavioral model associated with the second vehicle comprises one of a set of behavioral models for the second vehicle, and the set of behavioral models comprises a plurality of scenario-specific behavioral models.

Example 16 includes the apparatus of Example 15, the one or more processors to determine a particular scenario based at least in part on sensor data generated by the first vehicle; determine that a particular behavioral model in the set of behavioral models corresponds to the particular scenario; and use the particular behavioral model to predict actions of the second vehicle based on determining that the particular behavioral model corresponds to the particular scenario.

Example 17 includes a vehicle comprising a plurality of sensors to generate sensor data; a control system to physically control movement of the vehicle; at least one interface to receive a signal identifying a second vehicle in proximity of the vehicle; and processing circuitry to obtain a behavioral model associated with the second vehicle, wherein the behavioral model defines driving behavior of the second vehicle; use the behavioral model to predict actions of the second vehicle; determine a path plan for the vehicle based on the predicted actions of the second vehicle and the sensor data; and communicate with the control system to move the vehicle in accordance with the path plan.

Example 18 includes the vehicle of Example 17, the processing circuitry to determine trustworthiness of the behavioral model associated with the second vehicle prior to using the behavioral model to predict actions of the second vehicle.

Example 19 includes the vehicle of Example 18, wherein determining trustworthiness of the behavioral model comprises verifying a format of the behavioral model.

Example 20 includes the vehicle of any one of Examples 17-19, wherein determining trustworthiness of the behavioral model comprises verifying accuracy of the model.

Example 21 includes the vehicle of Example 20, wherein verifying accuracy of the behavioral model comprises storing inputs provided to at least one machine learning model and corresponding outputs of the at least one machine learning model; and providing the inputs to the behavioral model and comparing outputs of the behavioral model to the outputs of the at least one machine learning model.

Example 22 includes the vehicle of Example 20, wherein verifying accuracy of the behavioral model comprises providing inputs to the behavioral model corresponding to observed conditions; determining expected behavior of the second vehicle from the behavioral model based on the inputs; observing behavior of the second vehicle corresponding to the observed conditions; and comparing the observed behavior with the expected behavior.

Example 23 includes the vehicle of any one of Examples 17-22, wherein the behavior model corresponds to at least one machine learning model used by the second vehicle to determine autonomous driving behavior of the second vehicle.

Example 24 includes the vehicle of any one of Examples 17-23, the processing circuitry to communicate with the second vehicle to obtain the behavioral model, wherein communicating with the second vehicle comprises establishing a secure communication session between the vehicle and the second vehicle, and receiving the behavioral model via communications within the secure communication session.

Example 25 includes the vehicle of Example 24, wherein establishing the secure communication session comprises exchanging tokens between the first and second vehicles, and each token comprises a respective identifier of the corresponding vehicle, a respective public key, and a shared secret value.

Example 26 includes the vehicle of any one of Examples 17-25, wherein the signal comprises a beacon to indicate an identity and position of the second vehicle.

Example 27 includes the vehicle of any one of Examples 17-26, further comprising a transmitter to broadcast a signal to other vehicles in the proximity of the vehicle to identify the vehicle to the other vehicles.

Example 28 includes the vehicle of any one of Examples 17-27, the processing circuitry to communicate a second behavioral model to the second vehicle in an exchange of behavior models including the behavioral model, the second behavioral model defining driving behavior of the vehicle.

Example 29 includes the vehicle of any one of Examples 17-28, the processing circuitry to determine whether the behavioral model associated with the second vehicle is in a model database of the vehicle, wherein the behavioral model associated with the second vehicle is obtained based on a determination that the behavioral model associated with the second vehicle is not yet in the model database.

Example 30 includes the vehicle of any one of Examples 17-29, wherein the second vehicle is capable of operating in a human driving mode and the behavior model associated with the second vehicle models characteristics of at least one human driver in the second vehicle during operation of the second vehicle in the human driving mode.

Example 31 includes the vehicle of any one of Examples 17-30, wherein the behavioral model associated with the second vehicle comprises one of a set of behavioral models for the second vehicle, and the set of behavioral models comprises a plurality of scenario-specific behavioral models.

Example 32 includes the vehicle of Example 31, the processing circuitry to determine a particular scenario based at least in part on sensor data generated by the vehicle; determine that a particular behavioral model in the set of behavioral models corresponds to the particular scenario; and use the particular behavioral model to predict actions of the second vehicle based on determining that the particular behavioral model corresponds to the particular scenario.

Example 33 includes a system comprising means to receive a signal identifying a second vehicle in proximity of a first vehicle; means to obtain a behavioral model associated with the second vehicle, wherein the behavioral model defines driving behavior of the second vehicle; means to use the behavioral model to predict actions of the second vehicle; and means to determine a path plan for the first vehicle based on the predicted actions of the second vehicle.

Example 34 includes the system of Example 33, further comprising means to determine trustworthiness of the behavioral model associated with the second vehicle prior to using the behavioral model to predict actions of the second vehicle.

Example 35 includes the system of Example 33, wherein determining trustworthiness of the behavioral model comprises verifying accuracy of the model.

Example 36 includes a computer-readable medium to store instructions, wherein the instructions, when executed by a machine, cause the machine to receive a signal identifying a second vehicle in proximity of a first vehicle; obtain a behavioral model associated with the second vehicle, wherein the behavioral model defines driving behavior of the second vehicle; use the behavioral model to predict actions of the second vehicle; and determine a path plan for the first vehicle based on the predicted actions of the second vehicle.

Example 37 includes an apparatus comprising memory and processing circuitry coupled to the memory to perform one or more of Examples 17-32.

Example 38 includes a system comprising means for performing one or more of Examples 17-32.

Example 39 includes a product comprising one or more tangible computer-readable non-transitory storage media comprising computer-executable instructions operable to, when executed by at least one computer processor, enable the at least one computer processor to implement operations of the Examples 17-32.

Example 40 includes a method comprising receiving an environment model generated based on sensor data from a plurality of sensors coupled to an autonomous vehicle; determining, based on information in the environment model, a variation in one or more behaviors of vehicles other than the autonomous vehicle; determining, based on information in the environment model, a deviation between one or more behaviors of the vehicles other than the autonomous vehicle and the same one or more behaviors performed by the autonomous vehicle; determining, based on the determined variation and deviation, one or more constraints to a behavioral model for the autonomous vehicle; and applying the one or more constraints to the behavioral model to control operation of the autonomous vehicle.

Example 41 includes the method of Example 40, further comprising constructing a scenario based on the environment model and geographic location information for the autonomous vehicle; and associating the constraints with the scenario in a social norm profile for the behavioral model of the autonomous vehicle.

Example 42 includes the method of Example 41, wherein the scenario is based on one or more of a number of vehicles near the autonomous vehicle, a speed for each of the one or more vehicles near the autonomous vehicle, a time of day, and weather condition information.

Example 43 includes the method of any one of Examples 40-42, wherein determining the variation comprises determining whether observed behavior is within current parameters of the behavioral model for the autonomous vehicle.

Example 44 includes the method of Example 43, wherein the variation is based on a Euclidean distance to the current behavioral model from the observations of surrounding vehicles.

Example 45 includes the method of any one of Examples 40-42, wherein determining the deviation comprises determining whether the deviation of behavior is within current parameters of the behavioral model for the autonomous vehicle.

Example 46 includes the method of Example 45, wherein the deviation is based on negative feedback transgressions that act as limits for the behavior.

Example 47 includes the method of any one of Examples 40-46, wherein the variation and deviation are based on information in the environment model associated with dynamic obstacles.

Example 48 includes an apparatus comprising memory and processing circuitry coupled to the memory to perform one or more of Examples 40-47.

Example 49 includes a system comprising means for performing one or more of Examples 40-47.

Example 50 includes a product comprising one or more tangible computer-readable non-transitory storage media comprising computer-executable instructions operable to, when executed by at least one computer processor, enable the at least one computer processor to implement operations of the Examples 40-47.

Example 51 includes a method comprising: participating in a first consensus negotiation with a first plurality of vehicles, wherein behavioral models or parameters thereof of at least a portion of the first plurality of vehicles are exchanged in the first consensus negotiation, and participating in the first consensus negotiation comprises receiving each of the behavioral models exchanged and determining validity of each of the behavioral models in the first consensus negotiation; participating in a second consensus negotiation with a second plurality of vehicles, wherein behavioral models of at least a portion of the second plurality of vehicles are exchanged in the second consensus negotiation, and participating in the second consensus negotiation comprises receiving each of the behavioral models exchanged and determining validity of each of the behavioral models in the second consensus negotiation; and generating a consensus behavioral model from the first and second consensus negotiations.

Example 52 includes the method of Example 51, further comprising distributing the consensus behavioral model to a third plurality of vehicles.

Example 53 includes the method of Example 52, wherein the consensus behavioral model is distributed in a third consensus negotiation.

Example 54 includes the method of any one of Examples 51-53, wherein the first and second consensus negotiations are based on a byzantine fault tolerance consensus algorithm.

Example 55 includes the method of any one of Examples 51-54, wherein the behavioral models comprise neural network-based models.

Example 56 includes the method of any one of Examples 51-55, wherein at least one of the first or second plurality of vehicles comprises a non-autonomous vehicle with a human driver.

Example 57 includes the method of Example 56, further comprising determining a behavioral model corresponding to the non-autonomous vehicle.

Example 58 includes the method of Example 57, further comprising generating sensor data at one or more local sensors to observe a plurality of behaviors of one or more non-autonomous vehicles, wherein the behavioral model corresponding to the non-autonomous vehicle is based on the sensor data.

Example 59 includes the method of Example 58, wherein the behavioral model corresponding to the non-autonomous vehicle is further based on the consensus behavioral model.

Example 60 includes the method of any one of Examples 51-59, wherein the method if performed using a stationary computing node corresponding to a particular road segment, and the stationary computing node is positioned proximate to the particular road segment.

Example 61 includes the method of Example 60, wherein the consensus behavioral model attempts to describe ideal driving behavior on the particular road segment.

Example 62 includes a system comprising means to perform the method of any one of Examples 51-61.

Example 63 includes the system of Example 62, wherein the means comprise a computer-readable medium to store instructions, wherein the instructions, when executed by a machine, causes the machine to perform at least a portion of the method of any one of Examples 51-61.

Example 64 includes a method comprising: receiving sensor data from a plurality of sensors coupled to an autonomous vehicle; detecting an irregular behavior performed by a particular vehicle other than the autonomous vehicle based on the sensor data; generating an identifier for the particular vehicle; and initiating a dynamic behavior policy of the autonomous vehicle in response to detecting the irregular behavior being performed by the particular vehicle a number of times greater than a threshold number.

Example 65 includes the method of Example 64, wherein detecting the irregular behavior performed by the particular vehicle comprises comparing an observed behavior performed by the particular vehicle with a safety model of the autonomous vehicle; and determining, based on the comparison, that the observed behavior violates the safety model of the autonomous vehicle.

Example 66 includes the method of Example 64, wherein detecting the irregular behavior performed by the particular vehicle comprises comparing an observed behavior performed by the particular vehicle with observed behaviors performed by other vehicles; and determining, based on the comparison, that the observed behavior performed by the particular vehicle deviates from the observed behaviors performed by the other vehicles.

Example 67 includes the method of Example 64, wherein detecting the irregular behavior performed by the particular vehicle comprises comparing an observed behavior performed by the particular vehicle with observed behaviors performed by other vehicles; and determining, based on the comparison, that the observed behaviors performed by the other vehicles are performed in reaction to the observed behavior performed by the particular vehicle.

Example 68 includes the method of any one of Examples 64-67, wherein detecting the irregular behavior is based on audio and visual contextual information in the sensor data.

Example 69 includes the method of any one of Examples 64-68, wherein generating an identifier for the particular vehicle comprises obtaining values for respective features of the particular vehicle; and applying a cryptographic hash on a combination of the values to obtain the identifier.

Example 69 includes the method of Example 68, wherein the values are obtained by extracting representative features from a deep learning model used by the autonomous vehicle to recognize other vehicles.

Example 70 includes the method of any one of Examples 64-69, further comprising tracking a frequency of detection of the irregular behavior by other vehicles.

Example 71 includes an apparatus comprising memory and processing circuitry coupled to the memory to perform one or more of the methods of Examples 64-70.

Example 72 includes a system comprising means for performing one or more of the methods of Examples 64-70.

Example 73 includes a product comprising one or more tangible computer-readable non-transitory storage media comprising computer-executable instructions operable to, when executed by at least one computer processor, enable the at least one computer processor to implement operations of one or more of the methods of Examples 64-70.

Example 74 includes a method comprising receiving irregular behavior tracking data from a plurality of autonomous vehicles, the irregular behavior tracking data comprising entries that include a vehicle identifier, an associated irregular behavior observed as being performed by a vehicle associated with the vehicle identifier, and contextual data indicating a context in which the irregular behavior was detected by the autonomous vehicles; identifying one or more sequences of irregular behaviors performed by one or more vehicles; identifying a contextual behavior pattern based on the identified sequences and the irregular behavior tracking data; and modifying a behavior policy for one or more autonomous vehicles based on the identified contextual behavior pattern.

Example 75 includes the method of Example 74, where identifying a contextual behavioral pattern comprises generating a contextual graph comprising a first set of nodes indicating identified sequences and a second set of nodes indicating contextual data, wherein edges of the contextual graph indicate a frequency of associations between the nodes; and using the contextual graph to identify the contextual behavior pattern.

Example 76 includes the method of Example 74, wherein modifying the behavior policy for the one or more autonomous vehicles is based on detecting that the one or more autonomous vehicles are within a particular context associated with the identified contextual behavior pattern.

Example 77 includes the method of any one of Examples 74-76, wherein the contextual data comprises one or more of trajectory information for the vehicles performing the irregular behaviors, vehicle attributes for the vehicles performing the irregular behaviors, driver attributes for the vehicles performing the irregular behaviors, a geographic location of the vehicles performing the irregular behaviors, weather conditions around the vehicles performing the irregular behaviors, and traffic information indicating traffic conditions around the vehicles performing the irregular behaviors.

Example 78 includes the method of any one of Examples 74-77, wherein the one or more sequences of irregular behaviors are identified based on Longest Common Subsequences (LCS).

Example 79 includes an apparatus comprising memory and processing circuitry coupled to the memory to perform one or more of the methods of Examples 74-78.

Example 80 includes a system comprising means for performing one or more of the methods of Examples 74-78.

Example 81 includes a product comprising one or more tangible computer-readable non-transitory storage media comprising computer-executable instructions operable to, when executed by at least one computer processor, enable the at least one computer processor to implement operations of one or more of the methods of Examples 74-78.

Example 82 includes a method comprising: receiving, from a vehicle behavior model, a classification of a first change in motion for a vehicle; receiving, from a regression model, a prediction of a likelihood of the first change in motion for the vehicle occurring during a given time interval; comparing the classification from the vehicle behavior model to the prediction from the regression model; determining that the first change in motion for the vehicle is a fault based, at least in part, on the comparing; and sending a first control signal to affect the first change in motion for the vehicle based on determining that the first change in motion for the vehicle is a fault.

Example 83 includes the method of Example 82, further comprising receiving, at the vehicle behavior model, a first control event that indicates the first change in motion for the vehicle; and generating the classification of the first change in motion based, at least in part, on the first control event and data from one or more sensors in the vehicle.

Example 84 includes the method of Example 82, further comprising receiving, at the regression model, a first control event; obtaining one or more variables indicative of current conditions; and generating the prediction based, at least in part, on the first control event and the one or more variables indicative of the current conditions.

Example 85 includes the method of Example 84, wherein the current conditions include at least one environmental condition.

Example 86 includes the method of any one of Examples 84-85, wherein the current conditions include at least one vehicle condition.

Example 87 includes the method of any one of Examples 84-86, wherein at least one of the one or more variables are obtained from one or more remote sources.

Example 88 includes the method of any one of Examples 83-87, wherein the first control event is associated with a braking actuator, a steering actuator, or a throttle actuator.

Example 89 includes the method of any ones of Example 82-88, wherein the vehicle behavior model is a Hidden Markov Model (HMM) algorithm.

Example 90 includes the method of any one of Examples 82-89, wherein the regression model is an expectation maximization (EM) algorithm.

Example 91 includes the method of any one of Examples 82-90, wherein the fault is one of a malicious attack on a computing system of the vehicle or a failure in the computing system of the vehicle.

Example 92 includes an apparatus comprising memory; and processing circuitry coupled to the memory to perform one or more of the methods of any one of Examples 82-91.

Example 93 includes a system comprising means for performing one or more of the methods of Examples 82-91.

Example 94 includes at least one machine readable medium comprising instructions, wherein the instructions when executed realize an apparatus or implement a method as in any one of Examples 82-93.

Example 95 includes a system, comprising memory; a processor coupled to the memory; a safety module; and a score module to determine an autonomy level score of a vehicle based at least in part on the health of sensors of the vehicle.

Example 96 includes the system of Example 95, further comprising an automation level indicator to display the autonomy level score.

Example 97 includes the system of any one or more of Examples 95-96, wherein the at least one input comprises data related to one or more sensors.

Example 98 includes the system of any one or more of Examples 95-97, wherein the at least one input comprises data related to weather conditions.

Example 99 includes the system of any one or more of Examples 95-98, wherein the at least one input comprises data related to computational power available to the vehicle.

Example 100 includes the system of any one or more of Examples 95-99, wherein the at least one input comprises data related to a vehicle customization.

Example 101 includes the system of any one or more of Examples 95-100, wherein the at least one input comprises data related to a user experience.

Example 102 includes a method comprising receiving a plurality of inputs related to a vehicle; weighting the plurality of inputs; combining the plurality of weighted inputs; and using the combined weighted inputs to determine an autonomous level score for the vehicle.

Example 103 includes the method of Example 102, further comprising displaying the autonomous level score on an automation level indicator.

Example 104 includes the method of any one or more of Examples 95-102, further comprising updating the information pertaining to characteristics of the driver.

Example 105 includes a system comprising means to perform any one or more of Examples 102-104.

Example 106 includes the system of Example 105, wherein the means comprises at least one machine readable medium comprising instructions, wherein the instructions when executed implement any method of any one or more of Examples 102-104.

Example 107 includes a method, comprising determining whether the dimensions of a vehicle have been modified; obtaining new vehicle dimensions; producing a new vehicle model based on the new vehicle dimensions; and adjusting one or more algorithms of an autonomous vehicle stack based on the new vehicle model.

Example 108 includes the method of Example 107, wherein determining whether the dimensions of a vehicle have been modified comprises using a sensor to determine that a hitch has been engaged.

Example 109 includes the method of any one or more of Examples 107-108, wherein obtaining new vehicle dimensions comprises conducting an ultrasonic scan.

Example 110 includes the method of any one or more of Examples 107-108, wherein obtaining new vehicle dimensions comprises scanning the vehicle during a walkthrough.

Example 111 includes the method of Example 110, wherein the scanning during the walkthrough comprises using a smart phone.

Example 112 includes the method of any one or more of Examples 107-111, further comprising prompting a driver for the new vehicle dimensions when the vehicle dimensions have changed.

Example 113 includes the method of any one or more of Examples 107-112, further comprising determining an autonomous level of the vehicle after the dimensions of the vehicle have been modified.

Example 114 includes the method of any one or more of Examples 107-113, further comprising using sensors to validate the new vehicle dimensions.

Example 115 includes a system comprising means to perform any one or more of Examples 107-114.

Example 116 includes the system of Example 115, wherein the means comprises at least one machine readable medium comprising instructions, wherein the instructions when executed implement a method of any one or more of Examples 107-114.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1.-27. (canceled)

28. An apparatus comprising:
at least one interface to receive a signal identifying a second vehicle in proximity of a first vehicle; and
processing circuitry to:
obtain a behavioral model associated with the second vehicle, wherein the behavioral model defines driving behavior of the second vehicle;
use the behavioral model to predict actions of the second vehicle; and
determine a path plan for the first vehicle based on the predicted actions of the second vehicle.

29. The apparatus of claim 28, the processing circuitry to determine trustworthiness of the behavioral model associated with the second vehicle prior to using the behavioral model to predict actions of the second vehicle.

30. The apparatus of claim 29, wherein determining trustworthiness of the behavioral model comprises verifying a format of the behavioral model.

31. The apparatus of claim 28, wherein determining trustworthiness of the behavioral model comprises verifying accuracy of the behavioral model.

32. The apparatus of claim 31, wherein verifying accuracy of the behavioral model comprises:
storing inputs provided to at least one machine learning model and corresponding outputs of the at least one machine learning model; and
providing the inputs to the behavioral model and comparing outputs of the behavioral model to the outputs of the at least one machine learning model.

33. The apparatus of claim 31, wherein verifying accuracy of the behavioral model comprises:
determining expected behavior of the second vehicle according to the behavioral model based on inputs corresponding to observed conditions;
observing behavior of the second vehicle corresponding to the observed conditions; and comparing the observed behavior with the expected behavior.

34. The apparatus of claim 28, wherein the behavior model associated with the second vehicle corresponds to at least one machine learning model used by the second vehicle to determine autonomous driving behavior of the second vehicle.

35. The apparatus of claim 28, wherein the processing circuitry is to communicate with the second vehicle to obtain the behavioral model, wherein communicating with the second vehicle comprises establishing a secure communication session between the first vehicle and the second vehicle, and receiving the behavioral model via communications within the secure communication session.

36. The apparatus of claim 35, wherein establishing the secure communication session comprises exchanging tokens between the first and second vehicles, and each token comprises a respective identifier of a corresponding vehicle, a respective public key, and a shared secret value.

37. The apparatus of claim 28, wherein the signal comprises a beacon to indicate an identity and position of the second vehicle.

38. The apparatus of claim 28, further comprising a transmitter to broadcast a signal to other vehicles in the proximity of the first vehicle to identify the first vehicle to the other vehicles.

39. The apparatus of claim 28, wherein the processing circuitry is to initiate communication of a second behavioral model to the second vehicle in an exchange of behavior models including the behavioral model, the second behavioral model defining driving behavior of the first vehicle.

40. The apparatus of claim 28, wherein the processing circuitry is to determine whether the behavioral model associated with the second vehicle is in a behavioral model database of the first vehicle, wherein the behavioral model associated with the second vehicle is obtained based on a determination that the behavioral model associated with the second vehicle is not yet in the behavioral model database.

41. The apparatus of claim 28, wherein the second vehicle is capable of operating in a human driving mode and the behavior model associated with the second vehicle models characteristics of at least one human driver of the second vehicle during operation of the second vehicle in the human driving mode.

42. The apparatus of claim 28, wherein the behavioral model associated with the second vehicle comprises one of a set of behavioral models for the second vehicle, and the set of behavioral models comprises a plurality of scenario-specific behavioral models.

43. The apparatus of claim 42, the processing circuitry to:
determine a particular scenario based at least in part on sensor data generated by the first vehicle;
determine that a particular behavioral model in the set of behavioral models corresponds to the particular scenario; and
use the particular behavioral model to predict actions of the second vehicle based on determining that the particular behavioral model corresponds to the particular scenario.

44. A vehicle comprising:
a plurality of sensors to generate sensor data;
a control system to physically control movement of the vehicle;
at least one interface to receive a signal identifying a second vehicle in proximity of the vehicle; and
processing circuitry to:
obtain a behavioral model associated with the second vehicle, wherein the behavioral model defines driving behavior of the second vehicle;
use the behavioral model to predict actions of the second vehicle;
determine a path plan for the vehicle based on the predicted actions of the second vehicle and the sensor data; and
communicate with the control system to move the vehicle in accordance with the path plan.

45. The vehicle of claim 44, the processing circuitry to determine trustworthiness of the behavioral model associated with the second vehicle prior to using the behavioral model to predict actions of the second vehicle.

46. The vehicle of claim 45, wherein determining trustworthiness of the behavioral model comprises verifying accuracy of the behavioral model.

47. The vehicle of claim 44, wherein the behavior model corresponds to at least one machine learning model used by the second vehicle to determine autonomous driving behavior of the second vehicle.

48. The vehicle of claim 44, wherein the behavioral model associated with the second vehicle comprises one of a set of behavioral models for the second vehicle, and the set of behavioral models comprises a plurality of scenario-specific behavioral models.

49. A computer-readable medium to store instructions, wherein the instructions, when executed by a machine, cause the machine to:
receive a signal identifying a second vehicle in proximity of a first vehicle;
obtain a behavioral model associated with the second vehicle, wherein the behavioral model defines driving behavior of the second vehicle;
use the behavioral model to predict actions of the second vehicle; and
determine a path plan for the first vehicle based on the predicted actions of the second vehicle.

50. A method comprising:
receiving a signal identifying a second vehicle in proximity of a first vehicle;
obtaining a behavioral model associated with the second vehicle, wherein the behavioral model defines driving behavior of the second vehicle;
using the behavioral model to predict actions of the second vehicle; and
determining a path plan for the first vehicle based on the predicted actions of the second vehicle.
